(19) United States
(12) Patent Application Publication
(10) Pub. No.: US 2020/0334696 A1
(43) Pub. Date: Oct. 22, 2020

(54) SALES AND TRAFFIC DATA ANALYSIS

(71) Applicant: WeWork Companies LLC, New York, NY (US)

(72) Inventors: Asna Ansari, San Francisco, CA (US); Michael A. Minar, Palo Alto, CA (US); David Strauss, San Francisco, CA (US); Michael Maurice Weithers, San Francisco, CA (US); Alexander Michel Reichert, San Francisco, CA (US)

(21) Appl. No.: 16/836,719

(22) Filed: Mar. 31, 2020

Related U.S. Application Data
(63) Continuation of application No. 15/204,922, filed on Jul. 7, 2016, now abandoned.
(60) Provisional application No. 62/190,206, filed on Jul. 8, 2015.
(60) Provisional application No. 62/191,270, filed on Jul. 10, 2015.
(60) Provisional application No. 62/206,226, filed on Aug. 17, 2015.
(60) Provisional application No. 62/222,046, filed on Sep. 22, 2015.

(51) Int. Cl. G06Q 30/02; H04L 29/08

(52) U.S. Cl. CPC G06Q 30/0201; H04L 67/18

(57) ABSTRACT

Sales and traffic data analysis is disclosed. Traffic data associated with the presence of a set of devices at a location is received. External sales data is obtained. The received traffic data and the obtained external sales data are processed. Output is provided based at least in part on the processing of the received traffic data and the obtained external sales data.

### CROSS REFERENCE TO OTHER APPLICATIONS

This application claims priority to U.S. Provisional Patent Application No. 62/190,206 entitled SALES AND TRAFFIC DATA ANALYSIS filed Jul. 8, 2015 which is incorporated herein by reference for all purposes.

This application claims priority to U.S. Provisional Patent Application No. 62/191,270 entitled SALES AND TRAFFIC DATA ANALYSIS filed Jul. 10, 2015 which is incorporated herein by reference for all purposes.

This application claims priority to U.S. Provisional Patent Application No. 62/206,226 entitled SENSOR NETWORK HIERARCHIES filed Aug. 17, 2015 which is incorporated herein by reference for all purposes.

This application claims priority to U.S. Provisional Patent Application No. 62/222,046 entitled SENSOR NETWORK HIERARCHIES filed Sep. 22, 2015 which is incorporated herein by reference for all purposes.

### BACKGROUND OF THE INVENTION

Technology is increasingly being used to track individuals as they visit retail shops and other locations. As one example, door counting devices can be used by a retail store to track the number of visitors to a particular store (e.g., entering through a particular door or set of doors) each day. As another example, in-store cameras can be used to monitor the movements of visitors (e.g., observing whether they turn right or left after entering the store). A variety of drawbacks to using such technologies exist. One drawback is cost: monitoring technology can be expensive to install, maintain, and/or run. A second drawback is that such technology is limited in the insight it can provide. For example, door counts do not distinguish between employees (who might enter and leave the building repeatedly during the course of the day) and shoppers. A third drawback is that such technology can be overly invasive. For example, shoppers may object to being constantly surveilled by cameras—particularly when the cameras are used for reasons other than providing security (e.g., assessing reactions to marketing displays).

### BRIEF DESCRIPTION OF THE DRAWINGS

Various embodiments of the invention are disclosed in the following detailed description and the accompanying drawings.

FIG. 1A illustrates an example of an environment in which sensors collect data from mobile electronic devices and the collected data is processed.

FIG. 1B depicts a graphical representation of example strengths and durations and how classifications can be made.

FIG. 2 illustrates an embodiment of a traffic insight platform.

FIG. 3 illustrates a variety of example zoning rules and settings.

FIG. 4A illustrates an example of a zoning metric table.

FIG. 4B illustrates an example of a zoning metric table.

FIG. 4C illustrates an example of a zoning metric table.

FIG. 5 illustrates an embodiment of a process for determining qualified devices using zone information.

FIGS. 6-8 show interfaces depicting zoning information for a national retailer at a particular location in Boston.

FIGS. 9-15 show interfaces depicting zoning information for an airport.

FIGS. 16A and 16B show interfaces depicting zoning information for a hotel.

FIGS. 17-20 show examples of interfaces for creating an event.

FIGS. 21-22 show examples of event summary page interfaces.

FIG. 23 shows an example of an interface depicting loyalty information.

FIG. 24 shows an example of an interface in which a comparison between two periods' re-engagement is displayed.

FIG. 25 shows an example of an interface in which options for including visitor loyalty data in a dashboard view is displayed.

FIG. 26 illustrates an embodiment of a process for assessing visitor composition.

FIG. 27-30 depict an example implementation of an events pipeline wrapper script.

FIG. 31 depicts sample data from an event frequency table.

FIG. 32 illustrates an embodiment of a process for determining co-visits by visitors.

FIG. 33 illustrates an embodiment of a process for determining re-visitation by visitors.

FIG. 34 illustrates an embodiment of a process for assessing visitor frequency during an event.

FIG. 35 illustrates an embodiment of an interface for importing data.

FIG. 36 illustrates an example embodiment of a CSV template.

FIG. 37 illustrates an example embodiment of a customizable dashboard that reflects a combination of sales and traffic information.

FIG. 38 illustrates an example embodiment of a dashboard interface for comparing locations.

FIG. 39 illustrates an example embodiment of a custom report.

FIG. 40 illustrates an example embodiment of a dashboard

FIG. 41 illustrates an example embodiment of an interface for selecting widgets.

FIG. 42 illustrates an example embodiment of an interface for selecting widgets.

FIG. 43 illustrates an example embodiment of a traffic insights platform.

FIG. 44 illustrates an example embodiment of a traffic insights platform.

FIG. 45 illustrates an example embodiment of an interface for arranging a dashboard.

FIG. 46 illustrates an example embodiment of an interface for importing data.

FIG. 47 illustrates an example embodiment of an interface for importing reports.

FIGS. 48-57 illustrates example embodiments of interfaces for importing data.

FIG. 58 illustrates an example embodiment of a data flow. Shown in this example is the collection of data from sensors. The collected data is then sent to a data pipeline. The output of the data pipeline is sent to a data storage. The data stored in the data storage can be used in a variety of manners, such as for attribution or for display in a dashboard (e.g., via an API).

FIG. 59 depicts an example embodiment of raw data collected from sensors.

FIG. 60 illustrates an example embodiment of collected data including metadata on clients, sensors, locations, as well as user preferences.

FIG. 61 illustrates an example embodiment of summary data produced by a data pipeline. Shown in this example is a summary of hourly/daily device behavior, as well as inference of device type.

FIG. 62 illustrates an example embodiment of classification. As shown in this example, inference of device type as well as machine learning can be performed.

FIG. 63 illustrates an example embodiment of computing metrics using a data pipeline.

FIG. 64 illustrates an example embodiment of a plot of metrics.

FIG. 65 illustrates an example embodiment of inferring device behavior within multi-zone locations using a zoning pipeline.

FIG. 66 illustrates an example embodiment of additional metrics including revenue attribution and URSB.

FIG. 67 illustrates an example embodiment a system for data ingestion. In some embodiments, the data ingestion system of FIG. 67 is used to implement ingestors 206-210.

FIG. 68 illustrates an example embodiment of a pipeline.

FIG. 69 illustrates an example embodiment of realtime additions.

FIG. 70 illustrates an example embodiment of partner integration.

FIG. 71 illustrates an example embodiment of a follow the sun architecture.

FIG. 72 depicts additional information. The additional information includes information relating to storage, data formats, fragmentation, accumulation of raw data, core pipelines, and cadence.

FIG. 73 illustrates an example embodiment of streaming-forward and microservices.

FIG. 74 illustrates an example embodiment of Kafka usage.

FIG. 75 illustrates an example embodiment of a realtime infrastructure.

FIGS. 76-79 illustrate components of an example architecture.

FIG. 80 depicts a process for re running a process.

FIG. 81 illustrates an example embodiment of a system for data ingestion.

FIG. 82 depicts example features of data ingestion.

FIG. 83 depicts an example embodiment of a Scala/Akka/Spray framework.

FIG. 84 illustrates an example embodiment of a trained in and out filter for an example store.

FIG. 85 illustrates an example embodiment of: correlations with sales revenue for external traffic counts.

FIG. 86 illustrates an example embodiment of correlations with sales revenue for traffic counts.

FIG. 87 illustrates an example embodiment of correlations with sales revenue for the composite metric, number of visitor minutes.

FIG. 88 illustrates an example of a mean update value for visit recency.

FIG. 89 illustrates an example of a mean update value for visit recency.

FIG. 90 illustrates an example graph showing growth of known devices along age, gender, and income dimensions as a percentage of total devices that visited stores in the Bay Area.

FIG. 91 illustrates an example of a graph showing growth of known devices along age, gender, and income dimensions when including US census data along with a device's store visit record.

FIG. 92 illustrates an example chart showing growth of known devices along age, gender, and income dimensions as a percentage of total devices that visited stores in the Bay Area.

FIG. 93 illustrates an example plot showing growth of known devices along age, gender, and income dimensions as a percentage of total devices that visited stores in the Bay Area.

FIG. 94 is a flow diagram illustrating an embodiment of a process for utilizing sales and traffic data.

FIG. 95 is a flow diagram illustrating an embodiment of a process for determining bounce rate.

FIG. 96 illustrates an example embodiment of a chain-wide hierarchy detailing a Retailer with Region, District and Stores.

FIG. 97 illustrates an example embodiment of a chain-wide hierarchy detailing a Retailer, zone, region, district, physical location, then zones, and within the zones hardware (APs).

FIG. 98 illustrates an example embodiment of a mapping of clients to stores to access points.

FIG. 99 illustrates an example embodiment of a schematic diagram detailing the flow of data from sensors through a Data Analysis Pipeline.

FIGS. 100-106 illustrate example embodiments of interfaces for uploading hierarchies.

FIG. 107 illustrates an example embodiment of a user interface showing West Region Performance Details.

FIG. 108 illustrates an example embodiment of Chain-Wide Performance Details.

FIG. 109 illustrates an example embodiment of ChainWide Performance Details.

FIG. 110 illustrates an example of chainwide performance with Map and Tabular Data detailing top and bottom performers.

FIG. 111 illustrates an example embodiment of a weekly KPI Report Email detailing regional performance of chain, Top and Bottom Regional Performers, Top and Bottom Store Performers.

FIG. 112 illustrates an example embodiment of ChainWide Performance Details.

FIG. 113 illustrates an example embodiment of ChainWide Performance Details.

FIG. 114 illustrate an example embodiment of ChainWide Performance Details.

FIG. 115 illustrates an example embodiment of an interface for comparing Location Details.

FIGS. 116A-116B illustrate example embodiments of Chainwide Performance Maps.

FIG. 117 illustrates an example embodiment of a process for utilizing sensor network hierarchies.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Individuals increasingly carry mobile electronic devices (e.g., mobile phones, laptops, tablets, etc.) virtually all of the time as they go about their daily lives. Using techniques described herein, a variety of sensors can be used to detect the presence of such devices (e.g., devices with WiFi, cellular, and/or Bluetooth capabilities) based on the capabilities of the sensors. And, insights about the individuals carrying those devices can be gained.

Throughout the Specification, the primary example of a “sensor” is a WiFi access point, and the primary example of a mobile electronic device is a cellular phone with WiFi enabled (though not necessarily associated with the “observing” WiFi access point). It is to be understood that the techniques described herein can be used in conjunction with a variety of kinds of sensors/devices, and the techniques described herein adapted as applicable. For example, in addition to WiFi access points, Radio Frequency (RF) receivers that detect RF signals produced by cellular phones, and Bluetooth receivers that detect signals produced by Bluetooth capable devices can be used in accordance with techniques described herein. Further, a single device can have multiple kinds of signals detected and used in accordance with techniques described herein. For example, a cellular phone may be substantially simultaneously detected by one or more sensors through a WiFi connection, a cellular connection, and/or a Bluetooth connection, amd/or other wireless technology present on a commodity cellular phone. Data collected by the sensors can be used in a variety of ways, and a variety of insights can be gained (e.g., about the individuals carrying the devices). As will be described in more detail below, the data can be collected in efficient and privacy preserving ways.

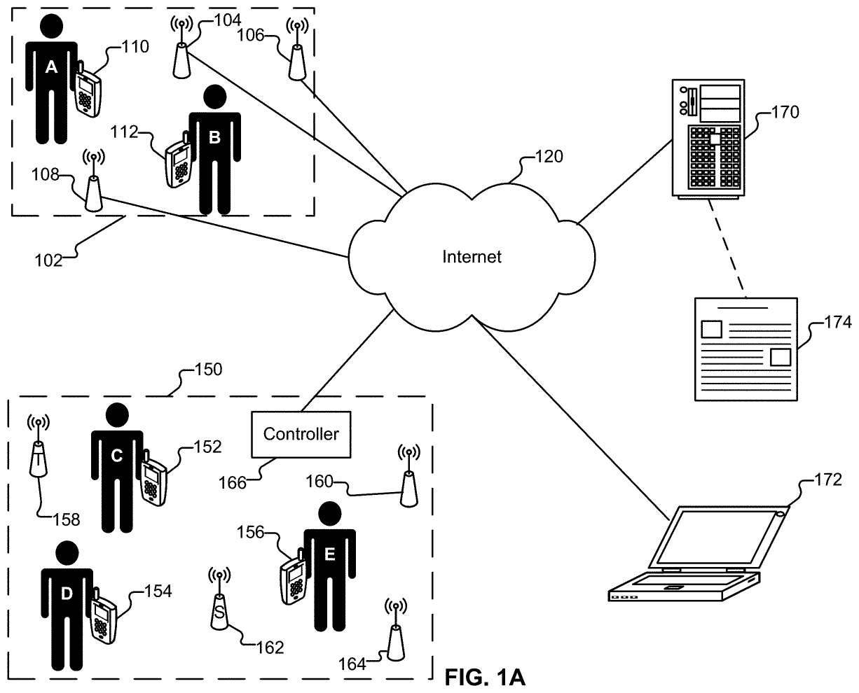

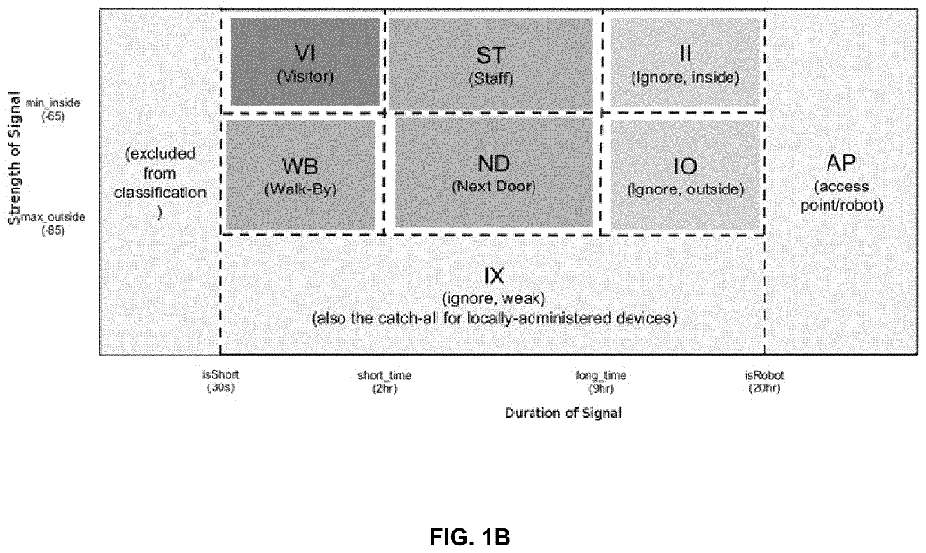

FIG. 1A illustrates an example of an environment in which sensors collect data from mobile electronic devices and the collected data is processed. In the example shown, Alice and Bob are present in a retail space 102. In particular, Alice and Bob are both shoppers shopping at a brick-and-mortar clothing store (hereinafter “ACME Clothing”). Included in retail space 102 are a set of sensors (104-108). Sensors 104-108 are WiFi access points (e.g., offering WiFi service to customers and/or providing service to point-of-sales and other store infrastructure). Sensors 104-108 each detect wireless signals from mobile electronic devices. In the example shown in FIG. 1A, Alice and Bob each carry a mobile device (e.g., cellular phones 110 and 112, respectively).

Also included in the environment shown in FIG. 1A is an airport space 150. Charlie and Dave are passengers in airport space 150, and Eve is an employee at a bookstand. Charlie, Dave, and Eve each carry respective mobile devices 152-156. Sensors, including sensors 158-164 are present in airport space 150.

The sensors depicted in FIG. 1A (i.e., sensors 104-108 and 158-164) are commodity WiFi access points. Other sensors can also be used in conjunction with techniques described herein as applicable. As will be described in more detail below, the sensors included in spaces 102 and 150 can be grouped into zones (an arbitrary collection of sensors). For example, suppose retail space 102 is a two story building, with sensors 108 and 110 on the first floor, and sensor 106 on the second floor. Sensors 108 and 110 can be grouped into a “First Floor” zone, and Sensor 106 can be the sole sensor placed in a “Second Floor” zone.

Floors are one example of zoning, and tend to work well in retail environments (e.g., due to WiFi resolution of approximately 10 meters). Other segmentations can also be used for zoning (including in retail environments), depending on factors such as wall placement, as applicable. As another example, airport space 150 might have several zones, corresponding to areas such as “Ticketing,” “A Gates,” “B Gates,” “Pre-Security Shops,” “A Gate Security,” “Taxis,” etc. Further, the zones can be arranged in a hierarchy. Using airport space 150 as an example, two hierarchical zones could be: Airport-Terminal 1—A Gates and Airport-Terminal 2—Pre-Security Shops.

As will be described in more detail below, signal strength and signal duration can be used to classify devices observed by a sensor. FIG. 1B depicts a graphical representation of example strengths and durations and how classifications can be made. Signal strength can be used as an indicator of whether an observed device is within the geographic confines of a sensor's zone. In some embodiments, if the device is determined to be within the geographic boundaries of the sensor's zone, it is classified as a visitor. If the signal is weak enough that it is determined to be outside the boundaries of the sensor's zone, it is determined to be a walk-by. If a zone has more than one sensor, multiple sensor readings can be used to determine if a device is a visitor or a walk-by. Certain devices can also be determined to be access points or other devices that do not belong to visitors or walk-bys, as illustrated in FIG. 1B. By measuring the length of time that the device is seen, for example, a determination can be made (e.g., probabilistically) whether a device belongs to staff, happens to be an access point inside the zone, and/or is otherwise a device type that should be ignored (e.g., a printer or point-of-sales terminal).

Onboarding

In the following discussion, suppose a representative of ACME Clothing would like to gain insight about shopper traffic in the store. Examples of information ACME Clothing would like to learn include how many shoppers visit the second floor of the store in a given day, how much total time shoppers spend in the store, and how much time they spend on the respective floors of the store. Using techniques described herein, ACME Clothing can leverage commodity WiFi access points to learn the answers to those and other questions. In particular, in various embodiments, ACME Clothing can leverage the access points that it previously installed (e.g., to provide WiFi to shoppers and/or staff/sales infrastructure) without having to purchase new hardware.

In various embodiments, ACME Clothing begins using the services of traffic insight platform 170 as follows. First, a representative of ACME Clothing (e.g., via computer 172) creates an account on platform 170 on behalf of ACME Clothing (e.g., via a web interface 174 to platform 170). ACME Clothing is assigned an identifier on platform 170 and a variety of tables (described in more detail below) are initialized on behalf of ACME Clothing.

A first table (e.g., a MySQL table), referred to herein as an “asset table,” stores information about ACME Clothing and its sensors. The asset table can be stored in a variety of resources made available by platform 170, such as relational database system (RDS) 242. To populate the table, the ACME representative (hereinafter referred to as Rachel) is prompted to provide information about the access points present in space 102, such as their Media Access Control (MAC) addresses, and, as applicable, vendor/model number information. Rachel is also asked to optionally provide grouping information (e.g., as applicable, to indicate that sensors 108 and 110 are in a “First Floor” group and 112 is in a “Second Floor group). The access point information can be provided in a variety of ways. As one example, Rachel can be asked to complete a web form soliciting such information (e.g., served by interface 174). Rachel can also be asked to upload a spreadsheet or other file/data structure to platform 170 that includes the required information. The spreadsheet (or portions thereof) can be created by Rachel (or another representative of ACME Clothing) or, as applicable, can also be created by networking hardware or other third party tools. Additional (optional) information can also be included in the asset table (or otherwise associated with ACME Clothing's account). For example, a street address of the store location, city/state information for the location, time-zone information for the location, and/or latitude/longitude information can be included, along with end-user-friendly descriptions (e.g., providing more information about the zones, such as that the “Zone 1” portion of ACME includes shoes and accessories, and that “Zone 2” includes outerwear).

The zoning hierarchy framework is flexible and can easily be modified by Rachel, as needed. For example, after an initial set up ACME Clothing's zones, Rachel can split a given zone into pieces, or combine zones together (reassigning sensors to the revised zones as applicable, adding new sensors, etc.). The asset table on platform 170 will be updated in response to Rachel's modifications.

In some embodiments, Rachel is asked to provide MAC addresses (or other identifiers) of known non-visitor devices. For example, Rachel can provide the identifiers of various computing equipment present in space 102 (e.g., printers, copiers, point of sales terminals, etc.) to ensure that they are not inadvertently treated by platform 170 as belonging to visitors. As another example, Rachel can provide the identifiers of staff-owned mobile computing devices (and designate them as belonging to staff, and/or designate them as to be ignored, as applicable). As will be described in more detail below, Rachel need not supply such MAC addresses, and platform 170 can programmatically identify devices that are probabilistically unlikely to belong to visitors and exclude them from analysis as applicable.

In the example of FIG. 1A, ACME Clothing is a single location business. Techniques describes herein can also be used in conjunction with multi-location businesses. In such a scenario, additional hierarchical information can be provided during onboarding. As one example, a retail store with 50 locations could organize its access points into geographical or other regions (e.g., with West Coast—California—Store 123—First Floor—AA:12:34:56:78:FF and West Coast—Nevada—Store 456—Second Floor—BB:12:34:56:67:FF being two examples of information supplied to platform 170 about two sensors). In some cases, a parent company may own stores of multiple brands. For example, Beta Holding Company may own both “Beta Electronics Retail” and “Delta Electronics Depot.” The assets table for Beta Holding Company can accordingly include the respective brand names in the hierarchy of access points if desired (e.g., “Beta Holding Company—Beta Electronics Retail—California—Store 567. . . ” and “Beta Holding Company—Delta Electronics Depot—Texas—Store 121 . . . ”).

Ingesting Sensor Data

Rachel is provided (e.g., via interface 174) with instructions for configuring sensors 104-108 to provide platform 170 with data that they collect. Typically, the collected data will include the MAC addresses and signal strength indicators of mobile devices observed by the sensors, as well as applicable timestamps (e.g., time/duration of detection), and the MAC address of the sensor that observed the mobile device. For some integrations, the information is sent in JSON using an existing Application Programming Interface (API) (e.g., by directing the hardware to send reporting data to a particular reporting URL, such as http://ingest.euclidmetrics.com/ACMEClothing or hardware vendor tailored URLs, such as http://cisco.ingest.euclidmetrics.com or hp.ingest.euclidmetrics.com, as applicable, where the data is provided in different formats by different hardware vendors). Accordingly, the configuration instructions provided to Rachel may vary based on which particular hardware (e.g., which manufacturer/vendor of commodity access point) is in use in retail space 102. For example, in some cases, the sensors may report data directly to platform 170 (e.g., as occurs with sensors 104-108). In other cases, the sensors may report data to a controller which in turn provides the data to platform 170 (e.g., as occurs with sensors 158-164 reporting to controller 166).

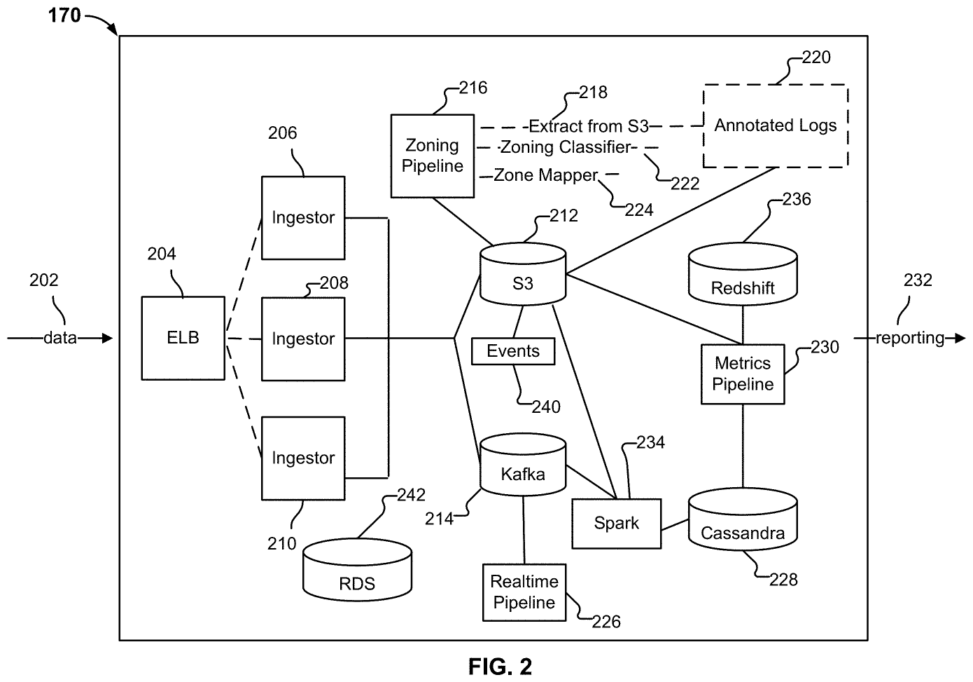

In the example environment shown in FIG. 1A, and in FIG. 2, platform 170 is implemented using cloud computing resources, such as Amazon Web Services (AWS) Google Cloud, or Microsoft's Azure. Resources described herein (or portions thereof) can also be provided by dedicated hardware (e.g., operated by an entity on behalf of itself, such as a governmental entity). Whenever platform 170 is described as performing a task, a single component, a subset of components, or all components of platform 170 may cooperate to perform the task. Similarly, whenever a component of platform 170 is described as performing a task, a subcomponent may perform the task and/or the component may perform the task in conjunction with other components. Various logical components and/or features of platform 170 may be omitted and the techniques described herein adapted accordingly. Similarly, additional logical components/features can be added to appliance 170 as applicable.

As shoppers, such as Alice and Bob, walk around in retail space 102, data about the presence of their devices (110 and 112) is observed by sensors (e.g., sensors 104-108) and reported to platform 170. For example, the MAC addresses of devices 110/112, and their observed signal strengths are reported by the observing sensors. The ingestion of that data will now be described, in conjunction with FIG. 2.

FIG. 2 illustrates an embodiment of a traffic insight platform, such as platform 170. Platform 170 receives data 202 (via one or more APIs) into an AWS elastic cloud load balancer (204), which splits the ingestion infrastructure across multiple EC2 instances (e.g., ingestors 206-210). The ingestors create objects out of the received data, which are ultimately written (e.g., as JSON) to disk (e.g., as hourly writes to S3) 212 and a real time messaging bus (e.g., Apache Kafka).

The ingestors are built to handle concurrent data ingestion (e.g., using Scala-based spray and Akka). As mentioned above, data provided by customers such as ACME Clothing typically arrives as JSON, though the formatting of individual payloads may vary between customers of platform 170. As applicable, ingestors 206-210 can rewrite the received data into a canonical format (if the data is not already provided in that format). For example, in various embodiments, ingestors 206-210 include a set of parsers specific to each customer and tailored to the sensor hardwarde manufacturer(s) used by that customer (e.g., Cisco, Meraki, Xirrus, etc.). The parsers parse the data provided by customers and normalize the data in accordance with a canonical format. In various embodiments, additional processing is performed by the ingestors. In particular, the received MAC addresses of mobile devices are hashed (e.g., for privacy reasons) and, in some embodiments, compared against a list of opted-out MAC addresses. Additional transformations can also be performed. For example, in addition to hashing the MAC address, a daily seed can be used (e.g., a daily seed used for all hashing operations for a 24-hour period), so that two different hashes will be generated for the same device if it is seen on two different days. If data is received for a MAC that has opted-out, the data is dropped (e.g., not processed further). One way that users can opt-out of having their data processed by platform 170 is to register the MAC addresses of their mobile devices with platform 170 (e.g., using a web or other interface made available by platform 107 and/or a third party).

As a given ingestor processes the data it has received, it writes to a local text log. Two example log lines written by an ingestor instance (e.g., ingestor 206) and in JSON are as follows:

Apr. 8, 2015 4:00:00 PM org.apache.jsp.index_jsp_jspService

INFO:{“sn”:“40:18:B1:38:7A:40”,“pf”:1,“ht”:[{“sl”:−89,“ot”:1396972150,“s2”:46122,“is”:667,“sm”:“88329B”,“so”:−89,“sc”:−89,“il”:0,“sh”:−86,“ct”:1396972151,“si”:“b533 c82bfeef4232”,“ih”:624,“ap”: 0,“cn”:6,“ss”:−526,“cf”:5180,“i3”:243039545,“s3”:−4044994,“i2”:391057}],“tp”:“ht”,“sq”:846077,“vs”:3}

Apr. 8, 2015 4:00:00 PM org.apache.jsp.index_jsp_jspService

INFO:{“sn”:“40:18:B1:39:32:C0”,“pf”:1,“ht”:[{“s1”:−68,“ot”:1396972136,“s2”:54162,“is”:1285,“sm”:“68A86D”,“so”:−53,“sc”:−61,“il”:20,“sh”:−52,“ct”:1396972138,“si”:“2e5e1d2807e5d3ad”,“ih”:604,“ap”:0,“cn”:15,“ss”:−898,“cf”:2437,“i3”:226673720,“s3”:−3290416,“i2”:420062}],“tp”:“ht”,“sq”:830438,“vs”:3}

In the above example log lines, “sn” is a serial number (or) MAC of the sensor that observed a mobile device (i.e., that has transmitted the reporting data to platform 107, whether directly or through a controller). The “pf” is an identifier of the customer sending the data. The “ht” is an array of detected devices, and includes the following:

s1: minimum signal strength

ot: timestamp of first frame (unix time in seconds)

s2: sum of the signal strength squared (to calculate variance)

is: sum of intervals (in seconds)

sm: station organizationally unique identifier or manufacturer identifier

so: first signal strength detected

sc: last signal strength detected

il: minimum interval (in seconds)

sh: maximum signal strength

ct: timestamp of last frame (unix time in seconds)

si: station identifier/detected device identifier, hashed

ih: maximum interval (in seconds)

ap: a flag indicating whether the reporting sensor is an access point or not

cn: count of number of frames summarized in this message for this device

ss: summation of signal strength (a negative number)

cf: frequency last frame received on

i3: sum of interval cubed

s3: sum of signal strength cubed (to calculate skew)

i2: sum of interval squared

The “tp” value indicates the type of message (where “ht” is a hit—a device being seen by the sensor, and “hl” is a health message—a ping the sensor sends during periods of inactivity). The “sq” value is a sequence number—a running count of messages from the sensor (and, in some embodiments, resets to zero if the sensor reboots). The “vs” value is a version number for the sensor message.

Once an hour, a script (e.g., executing on ingestor 206) gzips the local ingestor log and pushes it to an S3 bucket. The other ingestors (e.g., ingestor 208 and 210) similarly provide gzipped hourly logs to the S3 bucket, where they will be operated on collectively. The logs stored in S3 are loaded (e.g., by a job executing on the S3 bucket) into MySQL and Redshift, which is in turn used by metrics pipeline 230.

Further, as the ingestors are writing their local logs, threads on each of the ingestors (e.g., Kafka readers) tail the logs and provide the log data to a Kafka bus for realtime analysis (described in more detail below) on an EC2 instance.

Zoning Pipeline

A variety of jobs execute on platform 170. Zoning-related jobs are represented in FIG. 2 as “zoning pipeline” 216. Various portions of the zoning pipeline are written in scripting languages (e.g., as python scripts) or written using S3 tools, etc., as applicable. The zoning pipeline is collectively executed by a cluster of EC2 instances working in parallel (e.g., using a Map Reduce framework) and runs as a batch job (e.g., runs once a day). Other pipelines described herein (e.g., realtime pipeline 226 and metrics pipeline 230) are similarly collections of scripts collectively executed by a cluster of EC2 instances.

Extract from S3

Each day (or another unit of time, as applicable, in alternate embodiments), the following occurs on platform 170. In a first stage, “Extract from S3” (218) the zoning pipeline reads the logs (provided by ingestors 206-210) stored in an S3 bucket the previous day. A “metadata join” script executes, which annotates the log lines with additional (e.g., human friendly) metadata. As one example, during the execution of the metadata join, the MAC address of a reporting sensor (included in the log data) is looked up (e.g., in an asset table) and information such as the human friendly name of the owner of the sensor (e.g., “ACME Clothing”), the human friendly location (e.g., “SF Store” or “Store 123, the hierarchy path (as applicable), etc. are annotated into the log lines. Minute-level aggregation is also performed, using the first seen, last seen, and max signal strength values for a given minute for a given device at a given sensor to collapse multiple lines (if present for a device-sensor combination) into a single line. So, for example, if sensor 108 has made six reports (in a one minute time interval) that it has seen device 122, during minute level aggregation, the six lines reported by sensor 108 are aggregated into a single line, using the strongest maximum signal strength value.

The output of the “Extract from S3” process (annotated log lines, aggregated at the minute level) is written to a new S3 bucket for additional processing. As used hereinafter, the newly written logs (i.e., the output of “Extract from S3”) is a daily set of “annotated logs.”

### Zoning Classification

The next stage of the zoning pipeline makes a probabilistic determination of whether a given mobile electronic device for which data has been received (e.g., by platform 170 from retail space 102) belongs to a shopper (or, in other contexts, such as airport space 150, other kinds of visitors, such as passengers) or represents a device that should (potentially) be excluded from additional processing (e.g., one belonging to a store employee, a point-of-sale terminal, etc.). The filtering determination (e.g., “is visitor” or not) is made using a variety of features/parameters, described in more detail below. The determination is described herein as being made by a “zoning classifier” (222) which is a piece of zoning pipeline 216 (i.e., is implemented using a variety of scripts collectively executing on a cluster of EC2 instances, as with the rest of the zoning pipeline).

During processing of the most recently received daily log data (i.e., the most recently processed annotated logs), zoning classifier 222 groups that daily log data by device MAC. For example, all of Alice's device 110 log entries are grouped together, and all of Bob's device 112 log entries are grouped together. The grouped entries are sorted by timestamp (e.g., with Alice's device 110's first time stamp appearing first, and then its second time stamp appearing next, etc.). In various embodiments, a decision tree of rules is used to filter devices. In some embodiments, at each level, the tree branches, and non-visitor devices are filtered out. One example of a filtering rule is the Boolean, “too short.” This Boolean can be appended to any device seen for less than thirty seconds, for example. The “too short” Boolean is indicative of a walk-by—someone who didn't linger long enough to be considered a visitor. A second example of a filtering rule is the Boolean, “too long,” which is indicative of a “robot” device (i.e., not a personal device carried by a human). This Boolean can be appended to any device (e.g., a cash machine, printer, point of sale terminal, etc.) that is seen for more than twenty hours in a given day, for example.

More complex filtering rules can also be employed. As one example, suppose Eve (an employee at a bookstand in airport space 150) has a personal cellular phone 156. On a given day (e.g., where Eve works a four hour shift), Eve's device 156 might appear to be similar to a passenger's device (e.g., seen in various locations within the airport over a four hour period of time). However, by examining a moving ten-day window of annotated log data, Eve's device can be filtered from consideration of belonging to a customer. Accordingly, in various embodiments, zoning classifier 222 reads the last ten days (or another appropriate length of time) of annotated logs into RAM, and provides further annotations (e.g., as features) appended to each row of the annotated logs stored in RAM. As one example, a feature of “how many days seen” can be determined by examining the last ten day of annotated log data, and a value (e.g. “2” days or “3” days, etc.) associated with a given device, as applicable, and persisted in memory. Further, if the number of days exceeds a threshold (three days or more), an additional feature “exhibits employee-like behavior” can be associated with Eve's device. Another feature, “seen yesterday” can similarly be determined used to differentiate visitors from employees.

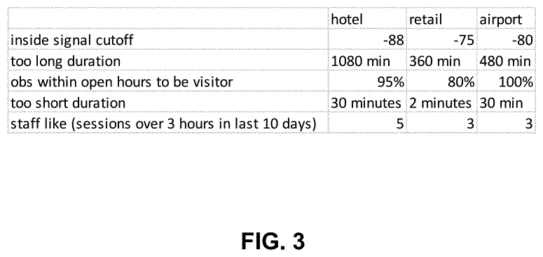

Example rules and settings for a variety of kinds of customers are shown in FIG. 3. Rules (and threshold values, also referred to herein as parameters) can be customized based on customer type/customer needs (e.g., via interface 174), and form a “zoning” model for each location. As one example, one filtering rule that can be used is “seen within hours of operation” (the hours of which will vary based on customer, and can be defined as a parameter, e.g., by an employee like Rachel). Similarly, while a single retail example is shown in FIG. 3, different retail environments can specify different parameters/thresholds for those features as applicable. For example, parameters applicable to a boutique clothing store on Rodeo Drive (with too short=30 seconds or repeat visits in ten days >2 being indicative of an employee device) may be different from those applicable to a grocery store in Topeka (with too short=120 seconds or repeat visitors in ten days >4 being indicative of an employee device). Some features may have binary parameters indicative of whether or not a device is a visitor or not. For example, if a device is flagged as being observed “too long,” a zoning model can use that information to conclude that the device is not a visitor. Other features may have varying weights assigned to them, and the determination of whether a device is a visitor or not may be made dependant on the combination of features observed (and the weights assigned). For example, a high number of repeat visits to a coffee shop, while indicative of an employee device, could also plausibly be a loyal customer device. Accordingly, a zoning model for the coffee shop may weight repeat visits as being less probative of whether a device belongs to a customer or not. In various embodiments, platform 170 makes available a variety of default zoning models (e.g.: hotel, indoor shopping mall, outdoor shopping mall, etc.) which can be customized as applicable (e.g., by a user of computer 172 via interface 174).

An example of a device which could survive a filtering decision tree is one that is seen more than 30 seconds, seen fewer than five hours, has a received signal strength indicator (RSSI) of at least 50, and is not seen more than twice in the last ten days. Such a device is probabilistically likely to be a visitor. Devices which are not filtered out are labeled with a Boolean flag of “is visitor” and processing on the data for those devices continues. In various embodiments, the annotated log data for the day being operated on (i.e., for which metrics, described in more detail below, are calculated) is referred to as a “qualified log” once employee/printer/etc. devices have been removed and only those devices probabilistically corresponding to visitors remain. The next stage of classification is to determine “sessions” using the qualified log lines.

As used herein, a “pre-session” is a set of qualified log lines (for a given mobile electronic device) that split on a gap of 30 or minutes. A pre-session is an intermediate output of the zoning classifier. Suppose Alice's device 110 is observed (e.g., by sensor 108) for fifteen minutes, starting at 13:01 on Monday. The annotated log contains fifteen entries for Alice (due to the minute-level aggregation described above). The zoning classifier generates a pre-session for Alice, which groups these fifteen entries together. Suppose Bob's device 112 is observed (e.g., by sensor 108) for two minutes, then is not observed for an hour, and then is seen again for an additional ten minutes on Monday. The zoning classifier will generate two pre-sessions for Bob because there is a one hour gap (i.e., more than 30 minute gap) between times that Bob's device 112 was observed. The first pre-session covers the two minute period, and the second pre-session covers the ten minute period. As yet another example, if Charlie's device 152 is observed for four consecutive hours on a Wednesday, Charlie will have a single pre-session covering the four-hour block of annotated logs pertinent to his device's presence being detected in airport space 150.

In some cases, a pre-session may include data from only a single sensor. As one example, suppose Alice is on the second floor of retail space 102 (which only includes a single access point, sensor 106). Alice's pre-session might accordingly only include observations made by sensor 106. In other cases, a pre-session may include data from multiple sensors. As one example, suppose Charlie (a passenger) arrives at airport space 150, checks in for his flight (in the Ticketing area), purchases a magazine at a pre-security shop, proceeds through security, and then walks to his gate (e.g., gate A15). Charlie is present in airport space 150 for four hours, and his device 152 is observed by several sensors during his time in airport space 150. As mentioned above, Charlie's pre-session is (in this example) four hours long. In some cases, a single sensor may have observed Charlie during a given minute. For example, when Charlie first arrives at airport space 150, his device 152 is observed by a sensor (158) located in the Ticketing area for a few minutes. Once he is checked in, and he walks toward the pre-security shopping area, his device 152 is observed by both the Ticketing area sensor (158) and a sensor (162) located in the pre-security shopping area for a few minutes. Suppose, for example, twenty minutes into Charlie's presence in airport space 150, device 152 is observed by both sensor 158 (strongly) and sensor 162 (weakly). As Charlie gets closer to the stores, the signal strength reported with respect to his device will become weaker with respect to sensor 158 and stronger with respect to sensor 162. In various embodiments, the classifier examines each minute of a pre-session, and, where multiple entries are present (i.e., a given device was observed by multiple sensors), the classifier selects as representative the sensor which reported the strongest signal strength with respect to the device. A variety of values can be used to determine which sensor reported the strongest signal strength for a given interval. As one example, the max signal strength value (“sh”) can be used. In various embodiments, this reduction in log data being considered is performed earlier (e.g., during minute level aggregation), or is omitted, as applicable.

Next, a zone mapper 224 (another script or set of scripts operating as part of zoning pipeline 216) annotates each line of each pre-session and appends the zone associated with the observing sensor (or sensor which had the strongest signal strength, as applicable). Returning to the example of Charlie walking around inside airport space 150, the following is a simplified listing of a portion of log data associated with Charlie's device 152. In particular, the simplified data shows a timestamp and an observing sensor:

09:50-AP4

10:00-AP4

10:01-AP4

10:02-AP2

10:03-AP1

10:04-AP3

10:05-AP2

10:15-AP2

Suppose AP1, AP2, and AP3 are each sensors present in the “A Gates” section of airport space 150, and AP4 is a sensor present in the security checkpoint area. The zone mapper annotates Charlie's log data as follows:

09:50-AP4-Security

10:00-AP4-Security

10:01-AP4-Security

10:02-AP2-A-Gates

10:03-AP1-A-Gates

10:04-AP3-A-Gates

10:05-AP2-A-Gates

10:15-AP2-A-Gates

The Zone mapper then collapses contiguous minutes in which the device was seen in the same zone into a single object (referred to herein as a “session”), which can then be stored and/or used for further analysis as described in more detail below. A device level “session,” labeled by a zone, is the output of the classification process. In various embodiments, the session object includes all (or portions of) the annotations made by the various stages of the zoning pipeline. In the example of Charlie, the excerpts above indicate that he spent twelve minutes in the security area (from 9:50-10:01) and fourteen minutes in the A-Gates area (10:02-10:15). Two sessions for Charlie will be stored (e.g., in a MySQL database /S3or other appropriate storage): one corresponding to his twelve minutes in security, and one corresponding to his fourteen minutes in security, along with additional data, as applicable.

Realtime Pipeline

Returning to FIG. 2, as previously mentioned, as ingestors 206-210 write their local logs, threads on each of the ingestors (e.g., Kafka readers) tail the logs and provide the log data to a Kafka bus for realtime analysis on an EC2 instance. As a data source, S3 is inexpensive and reasonably fast. Kafka is more expensive, but significantly faster.

Realtime pipeline 226 operates in a similar manner to zoning pipeline 216 except that it works on a smaller time scale (and thus with less data). For example, instead of operating on ten days of historical data, in various embodiments, the realtime pipeline is configured to examine an hour of historical data. And, where the zoning pipeline executes as a daily batch operation, the realtime pipeline batch operation occurs every five minutes. And, instead of writing results to S3, the realtime pipeline writes to Cassandra (228) tables, which are optimized for parallel reads and writes. The realtime pipeline 226 also accumulates the qualified log data. In some embodiments, a list of banned devices is held in memory, where the devices included on that list are selected based on being seen “too long.” Such devices (e.g., noisy devices pinging every two seconds for 20 hours) might be responsible for 60-80% of traffic, and excluding them will make the realtime processing more efficient.

As will be described in more detail below, metrics generated with respect to zoning pipeline data will typically be consumed via reports (e.g., served via interface 174 to an administrator, such as one using computer 172). Metrics generated with respect to realtime pipeline data are, in various embodiments, displayed on television screens (e.g., within airport space 150) or otherwise made publicly available (e.g., published to a website), as indicators of wait times, and refresh frequently (e.g., once a minute). In some embodiments, realtime data can be used to trigger email or other messages. For example, suppose a given checkpoint at a particular time of day typically has a wait time of approximately five minutes (and a total number of five to ten people waiting in line). If the current wait time is twenty minutes and/or there are fifty people in line (e.g., as determined by realtime pipeline 226), platform 170 can output a report (e.g., send an email, an SMS, or other message) to a designated recipient or set of recipients, allowing for the potential remediation of the congestion.

Realtime analysis using the techniques described herein is particularly useful for understanding wait times (e.g., in security, in taxi lines, etc.) and processes such as hotel check-in/check-out. An example use of analysis performed using the zoning techniques described herein is determining how visitors move through a space. For example, historical analysis can be used to determine where to place items/workers/etc. based on flow.

Zoning/Realtime Metrics

Platform 170 includes a metrics pipeline (230) that generates metrics from the output of the zoning pipeline (and/or realtime pipeline as applicable). Various metrics are calculated on a recurring basis (e.g., number of visitors per zone per hour) and stored (e.g., in RedShift store 236). In various embodiments, platform 170 uses a lambda architecture for the metrics pipeline (and other pipelines, as applicable). One example implementation of metrics pipeline 230 is a Spark cluster (running in Apache Mesos). In the case of realtime metrics generation (e.g., updating current security line and/or taxi line wait times), analysis is performed using a Spark Streaming application (234), which stores results in Cassandra (228) for publishing.

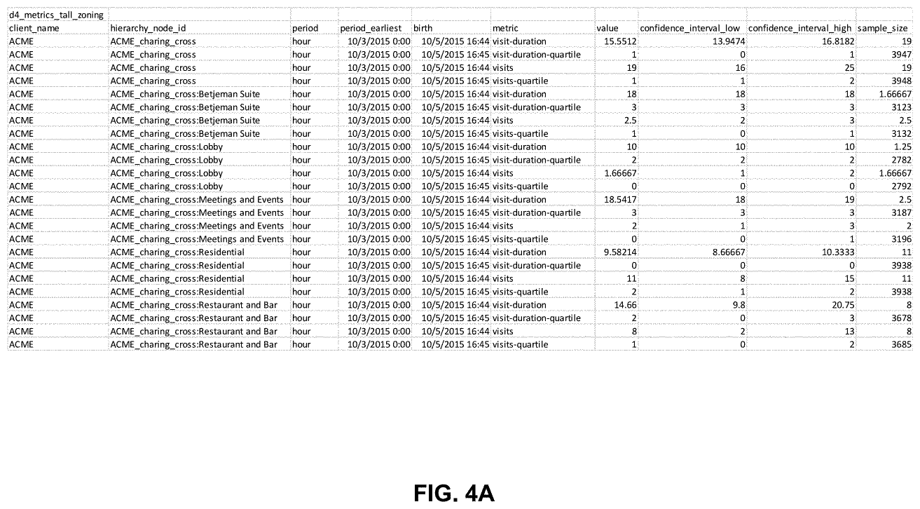

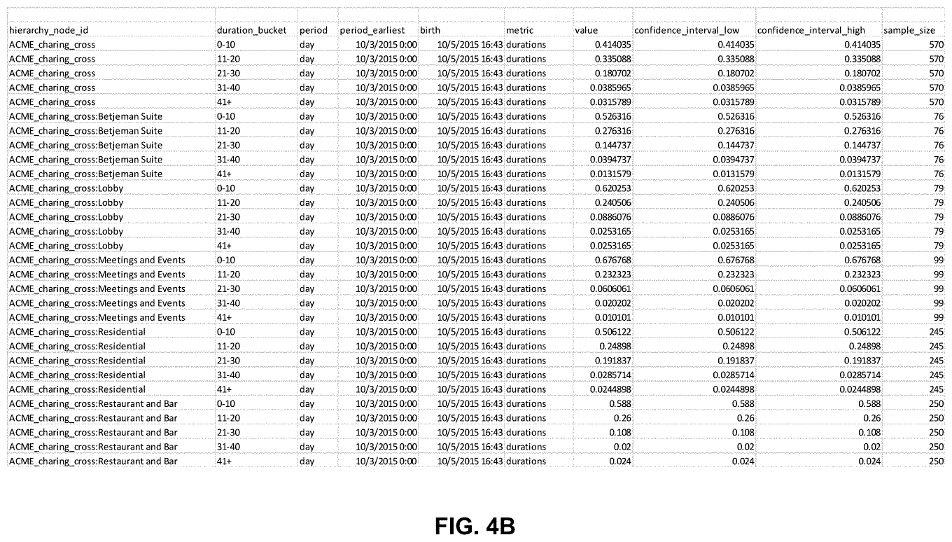

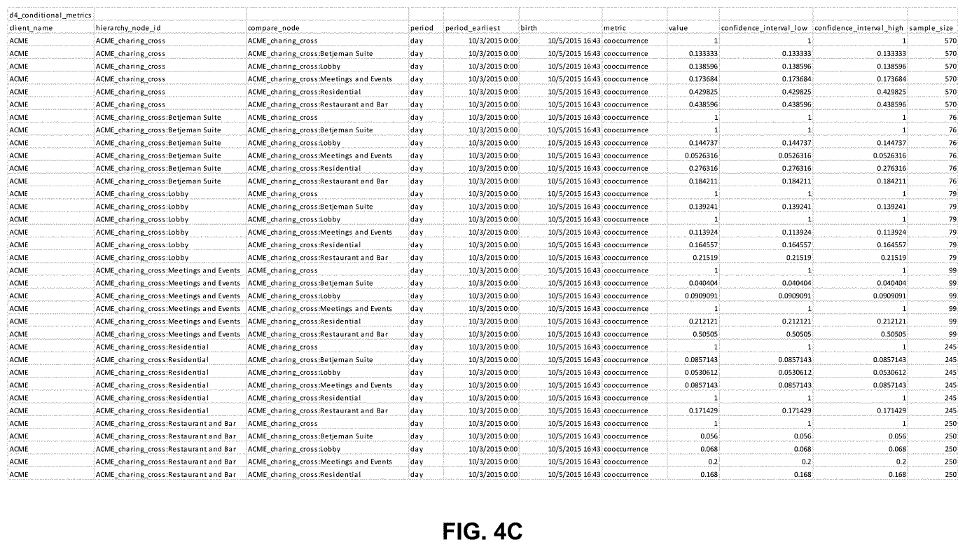

Summaries used to generate reports 232 (made available to end users via one or more APIs provided by platform 170) are stored in MySQL. Such stored metrics will include a time period, a zone, and a metric name value. Sample zoning metric tables are shown in FIGS. 4A-4C. In particular, Table 4A holds metrics about visits and durations in the daily/hourly/15-minute level. Table 4B holds a histogram of duration times: within a given time period in a given location, how many visitors were around for 0-10, 11-20, 21-30, 31-40, and more than 41 minutes. Table 4C holds conditional metrics looking at the device level: a pairwise examination of different zones—of the people seen in one zone, what percentage of them were also seen at another zone. Additional metrics can also be determined and are described in more detail below.

Reporting data 232 is made available to representatives of customers of platform 170 (e.g., Rachel) via interface 174. As another example, reporting data 232 is made available to airport space 150 visitors (e.g., via television monitors, mobile applications, and/or website widgets), reflecting information such as current wait times.

For metrics calculated on an hourly basis, any sessions that do not include that time period are ignored during analysis. For example, to determine a visit count at 2 am (i.e., of those visitors present in a location at any time between 2 am and 3 am, in which zones were they located?), only those sessions including a 2 am prefixed timestamp are examined, and a count is made for each represented zone (e.g., two visitors at Ticketing, six visitors at security, etc.).

One example of a metric that can be determined by metrics pipeline 230 is “what is the current average wait time for an individual in line for security at airport space 150?” One way to evaluate the metric is for metrics pipeline 230 to examine results of the most recently completed realtime pipeline job execution (stored in memory) for recently completed sessions where visitors were in the security zone, and determine the average length of the sessions. Metrics for other time periods (e.g., “what was the average wait at 8:00 am”) can be determined by taking the list of sessions and re-keying it by a different time period. Additional examples of metrics that can be calculated in this manner (keying on a zone, a time period, and a metric) include “how many visitors were seen each hour in the food court?” and “what was the average amount of time visitors spent in the A-gates on Tuesday?” Percentiles can also be determined using the data of platform. For example, “what was the 75^{th} percentile amount of time a visitor spent in the security zone on Tuesday?” or “what was the 99^{th} percentile?”

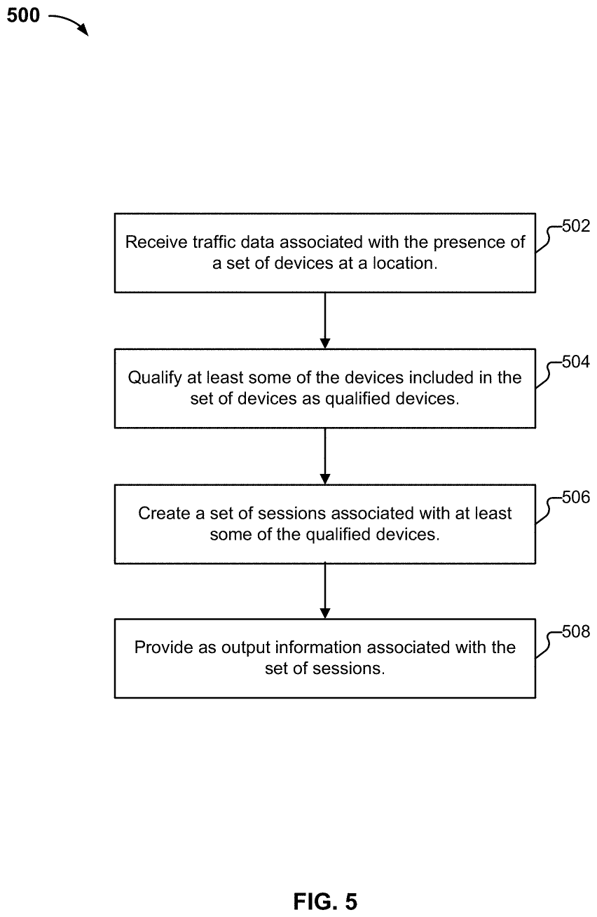

FIG. 5 illustrates an embodiment of a process for determining qualified devices using zone information. In various embodiments, process 500 is performed by platform 170. The process begins at 502 when traffic data associated with the presence of a set of devices at a location is received. As one example, such traffic data is received at 502 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 502 of the process may be repeated several times (e.g., with data about the observation of device 112 also being received at 502, whether from sensor 108, or another sensor, and/or from a controller). At 504, at least some of the devices included in the set of devices are qualified as qualified devices. As one example, at 504 zoning pipeline 216 evaluates data associated with the devices (e.g., by applying a decision tree of rules to log lines associated with the devices and obtained from storage 212). As another example, at 504 realtime pipeline 226 evaluates data associated with the devices (e.g., by comparing the devices against a list of banned devices). In both the cases of zoning pipeline 216 and realtime pipeline 226, at 504, those devices that are not disqualified (i.e., survive the decision tree analysis, are not on the banned list, or otherwise are not disqualified) are designated as qualified devices. At 506, a set of sessions associated with at least some of the qualified devices is created. As one example, at 506, zoning pipeline 216 determines a device-zone-duration 3-tuple for a qualified device using received traffic data or a representation thereof, an example of a session. An example of such a 3-tuple is: device 110, seen from 10:00 to 10:14, in ACME Clothing—First Floor. As another example, at 506, realtime pipeline 226 determines a device-zone-duration 3-tuple for a qualified device using received traffic data or a representation thereof. An example of such a 3-tuple is: device 152, seen from 12:45 to 12:59, in Airport-Terminal 1-A Gates. Finally, at 508, information associated with the set of sessions is provided as output. One example of such output being provided at 508 includes metrics pipeline 230 providing metrics to either/both of Redshift 236 and Cassandra 228 (in conjunction with either the zoning pipeline or realtime pipeline, or both, as applicable). Another example of such output being provided at 508 includes the rendering or other provision of metrics to a user in an interface, such as via interface 174 or a television screen located in airport space 150 (in communication with platform 170). The following section provides additional information regarding a variety of interfaces usable in conjunction with techniques described herein.

Zoning/Realtime Interfaces

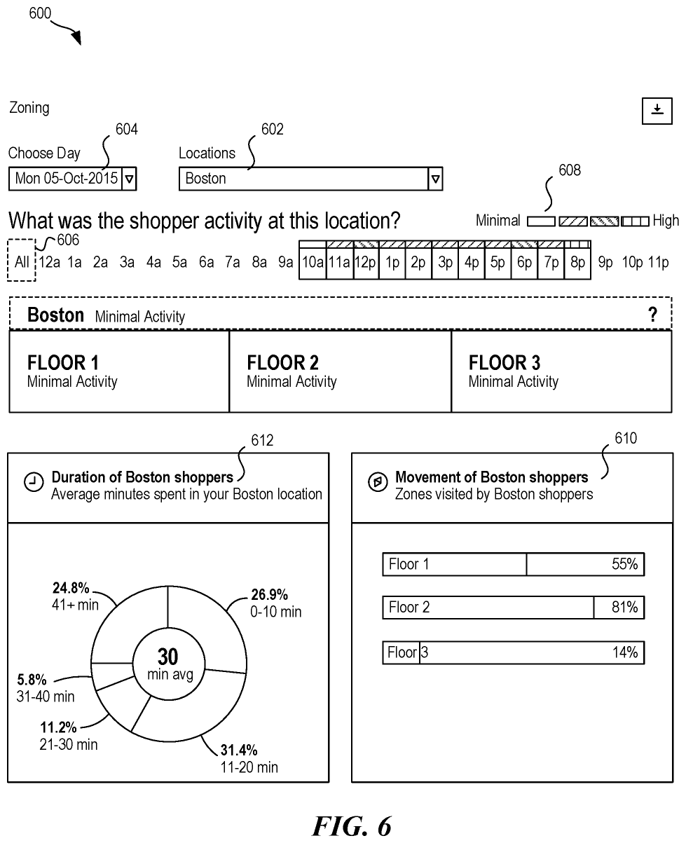

FIG. 6 shows an interface depicting zoning information for a national retailer at a particular location in Boston. Interface 600 is an example of data that can be presented to a user (e.g., a customer representative like Rachel) via interface 174. By clicking region 602, the user can select a particular location in the chain. By clicking region 604, the user can choose what time range of data to view (e.g. a particular day). By clicking region 606, the user can choose whether to see the data across an entire day, or by hour. As shown in FIG. 6, the entire days' worth of data is being displayed. As shown in region 608, in order to provide a relative estimate for how busy a particular zone is at a certain time (without counts), a quartile index of Minimal, Low, Medium, High activity is used. Region 610 quantifies the percent of cross visitation within a certain location. When the store as a whole is selected (as is the case in this view) the user sees what percentage of all shoppers visited the different zones within a location. When a certain zone is selected, the chart will show what percentage of shoppers that visited the selected zone also visited a different zone. Region 612 shows the breakdown of duration across all zones within a location. When the user selects a particular zone this chart updates with zone specific information.

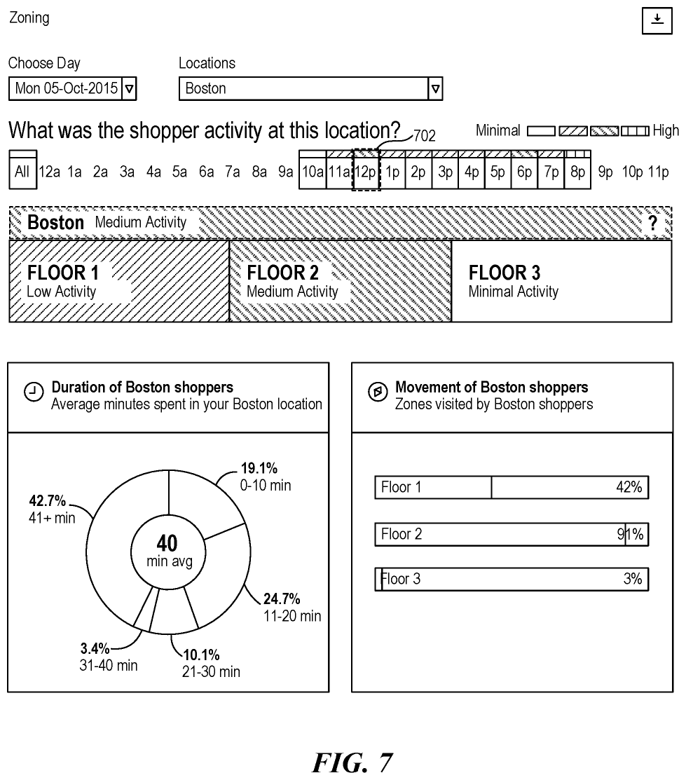

FIG. 7 shows an interface depicting zoning information for a national retailer at a particular location in Boston. When an hour is selected (702), all data below updates.

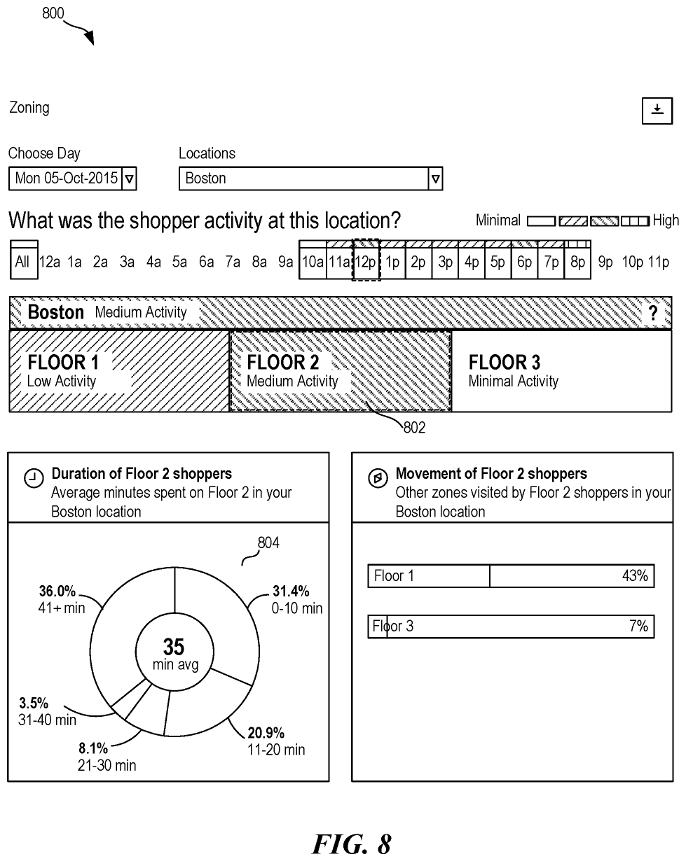

FIG. 8 shows an interface depicting zoning information for a national retailer at a particular location in Boston. When a zone is selected (802), all data below updates. The level of activity is calculated, in some embodiments, by comparing the amount of traffic in a zone to a historical average (e.g., not relative to other zones). As shown in region 804, a viewer of interface 800 can learn the duration breakdown of the visitors to a particular floor.

Suppose the average visitor to floor one of a store (which offers housewares) stays fifteen minutes, and an additional 25% of visitors to floor one stay between 21 and 30 minutes. Further suppose that of those store visitors that visit the second floor, they stay on the floor a much shorter time on average (e.g., stay an average of six minutes on the second floor). If “big purchase” items (e.g., furniture) are located on the second floor, the comparatively short amount of time spent on the second floor indicates that visitors are not buying furniture.

As another example, a representative of a grocery store could use a set of interfaces similar to those shown in FIGS. 6-8 to determine how visitors interact with different regions (defined using zones) in the store. For example, suppose the grocery store is split into a dairy zone (at the back of the store), a middle zone (in the center of the store, where high value items are placed), and two zones (to the left and right of the middle zone, respectively) where inexpensive items are placed. Interfaces provided by platform 170 can show how visitors interact with those zones. For example, the grocery store may be laid out the way it currently is on the assumption that most shoppers need dairy items and will take the shortest path to the dairy (i.e., go through the center of the store), passing by the high value items and placing some of those high value items into their carts. Using techniques described herein, the store layout can be assessed, e.g., with embodiments of the interfaces shown in FIGS. 6-8 indicating the concurrence between visitors to the dairy section and each of the three other sections of the store, the amount of time they spend in each region, etc.

A representative of the national retailer can also use interfaces such as those shown in FIGS. 6-8 to inform staffing and other decisions. For example, suppose that Monday visitor traffic to the Boston location typically sees the bulk of visitors staying on the first floor, with significantly fewer visitors visiting the second and third floors. Instead of staffing all three floors equally throughout the week, additional staff can be placed on the first floor on Mondays, with fewer staff being placed on the second and third floors on those days.

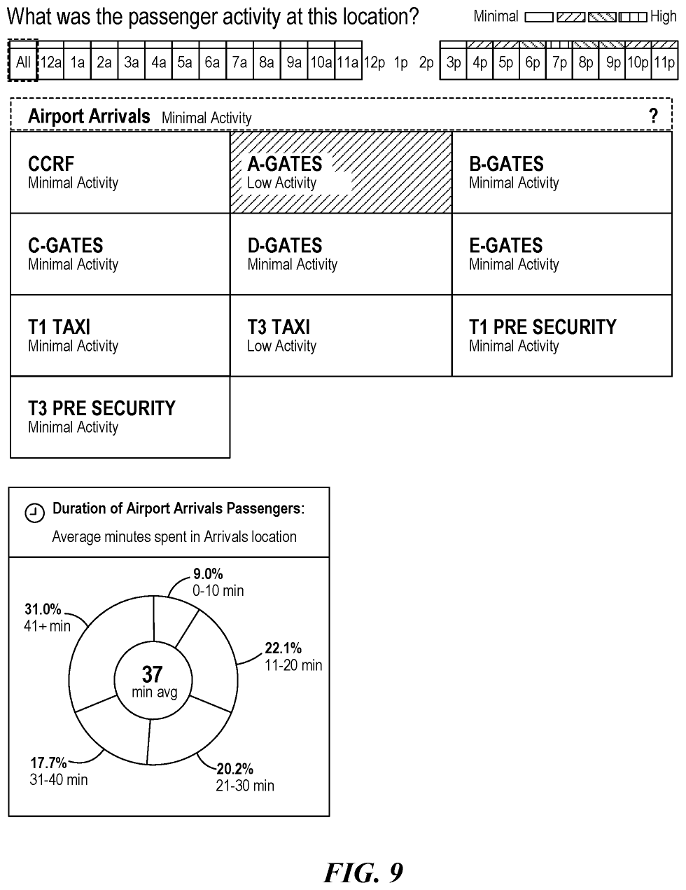

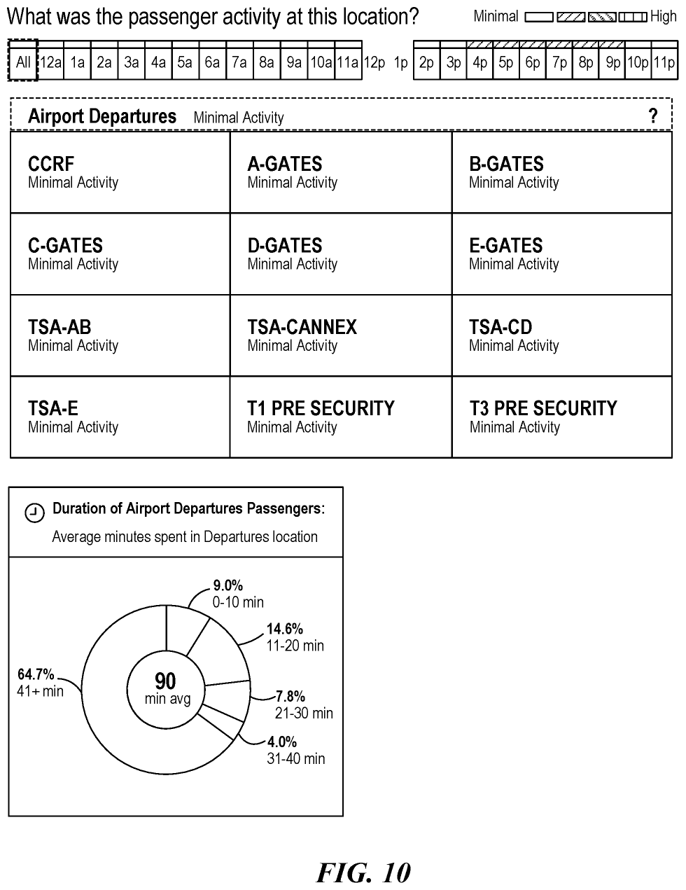

FIG. 9 shows an interface depicting zoning information for an airport. Similar to zoning for retail spaces, zoning for airport spaces can be leveraged to view activity and duration by hour in different zones of the airport. Airport zoning includes arriving and departing zones. Platform 170 can identify what devices are arriving at the airport and what devices are departing by zone. For example, on the arrivals side, passengers typically progress from gates, passed security and/or ticketing, to baggage claim. The numbers of those individuals visiting the taxi zone vs. the limo zone vs. the rental car zone can be determined using techniques described herein. Determinations can also be made about what percentage of arriving passengers stop to shop, stop for lunch, etc., in accordance with techniques described herein, and, how long those activities take arriving passengers, on average. A departures example is depicted in FIG. 10.

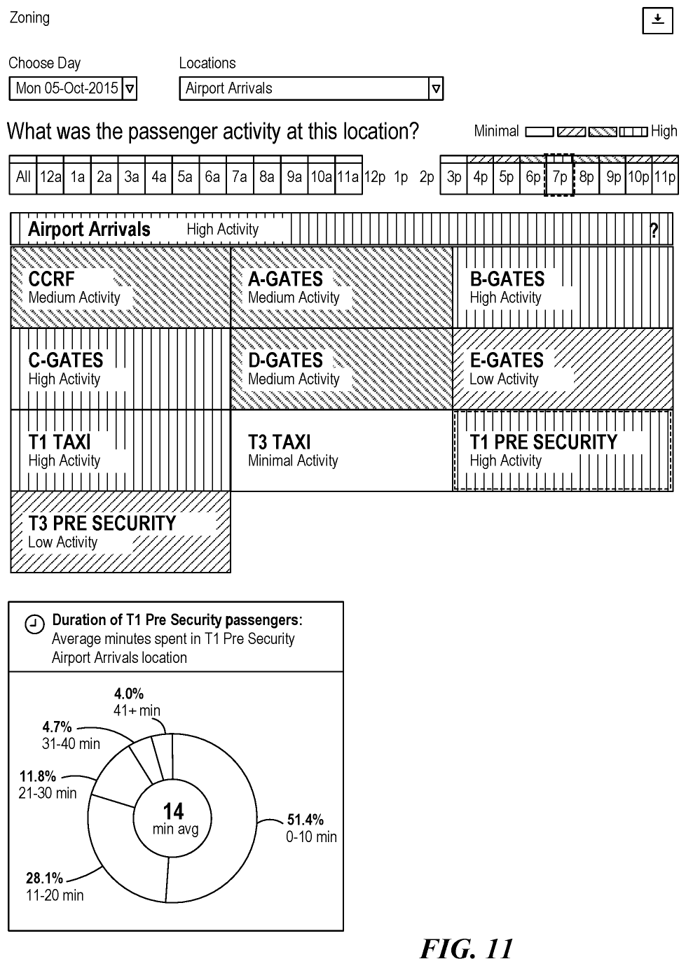

As seen in FIG. 11, activity and duration for zoning for airports, like zoning for retail, can be viewed on an hourly basis.

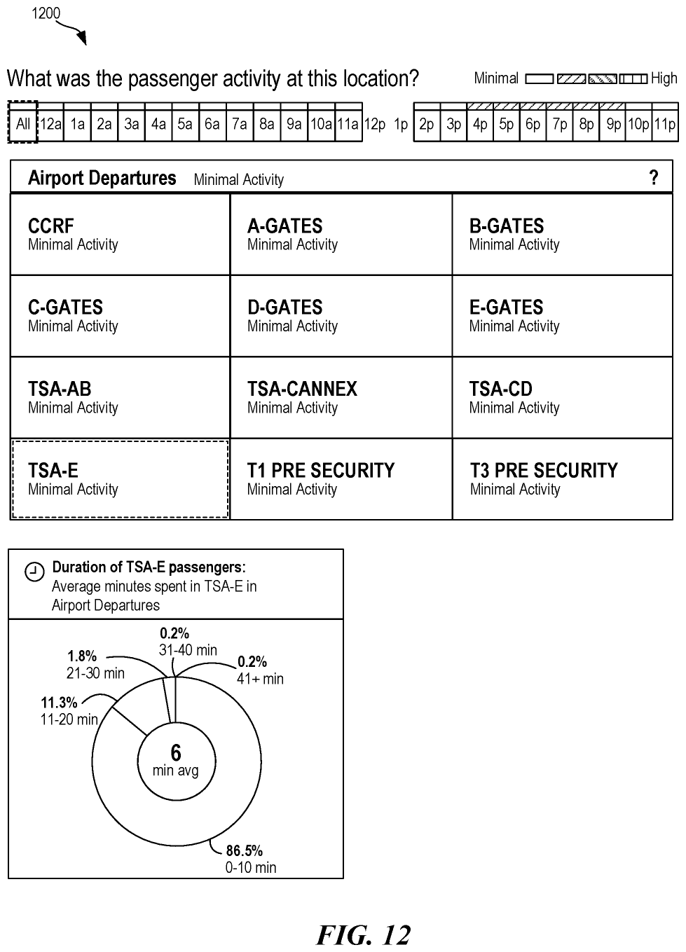

As seen in FIG. 12, security areas can be used as zones and, the activity and duration of security lines measured. The impact of the duration of time passengers spend in security lines on those passengers visiting other areas of the airport can be evaluated using techniques described herein and interfaces such as interface 1200. For example, if there is a very high spike in security wait times, passengers will probably be late for their flights, will have less time to shop/eat, and will be going straight to the gates. And, when security lines are shorter, more co-visits through the shopping/eating zones will occur. Using techniques described herein, the impact of security lines can be quantified and visualized, allowing for more informed decisions to be made (e.g., about staffing).

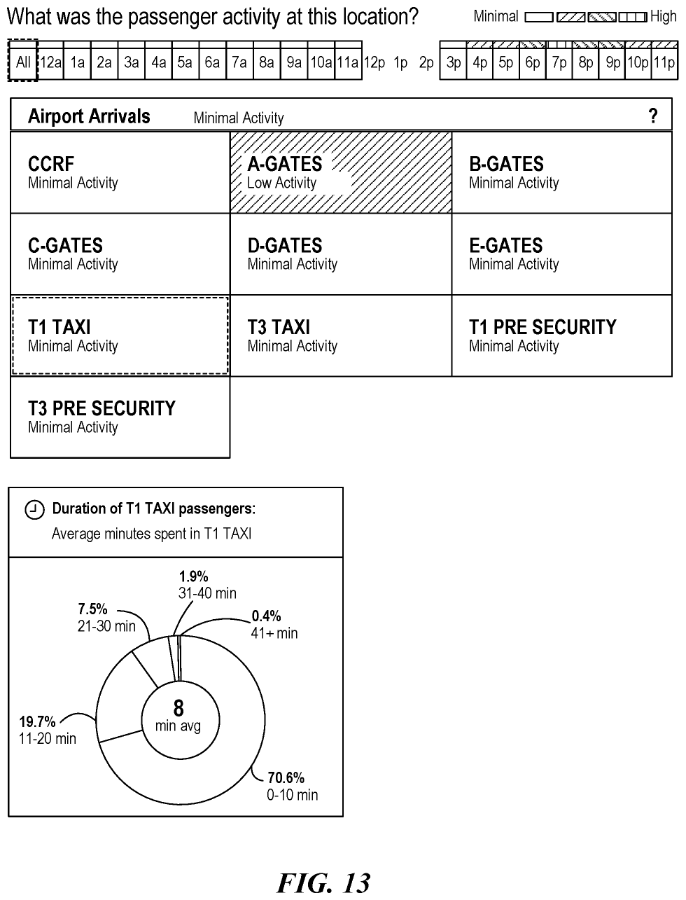

Taxi lines can also be analyzed (see FIG. 13).

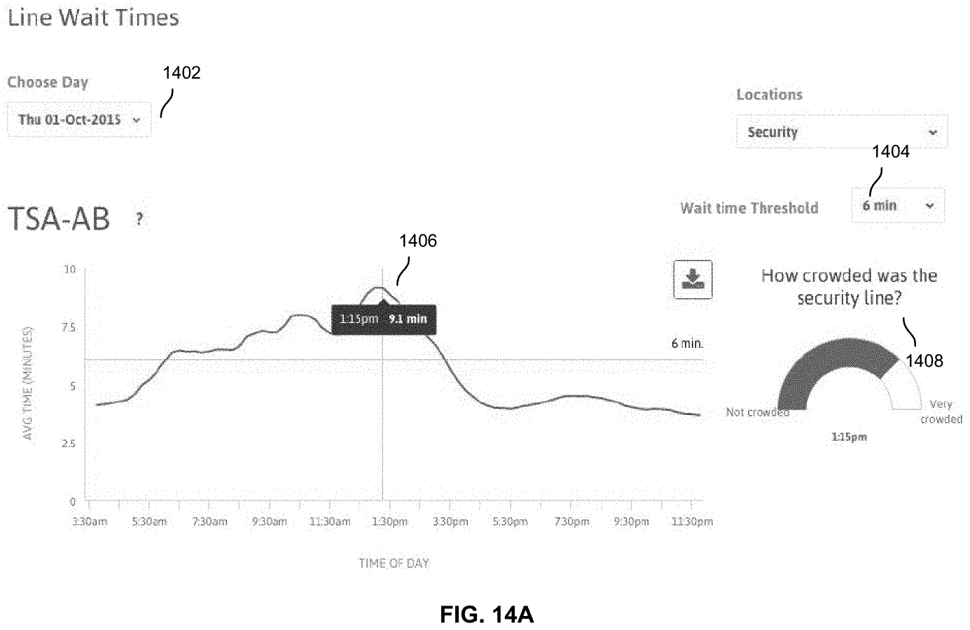

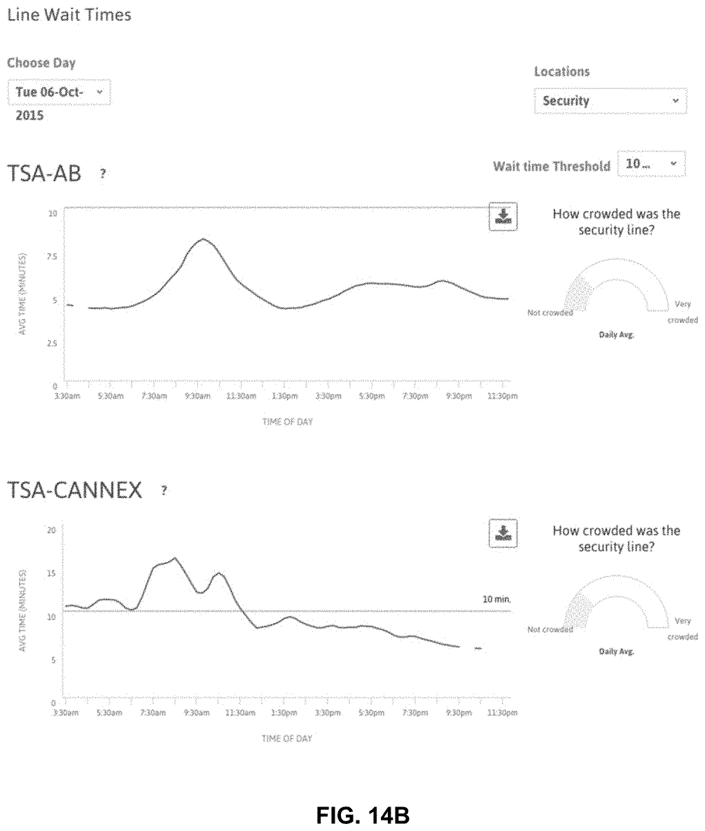

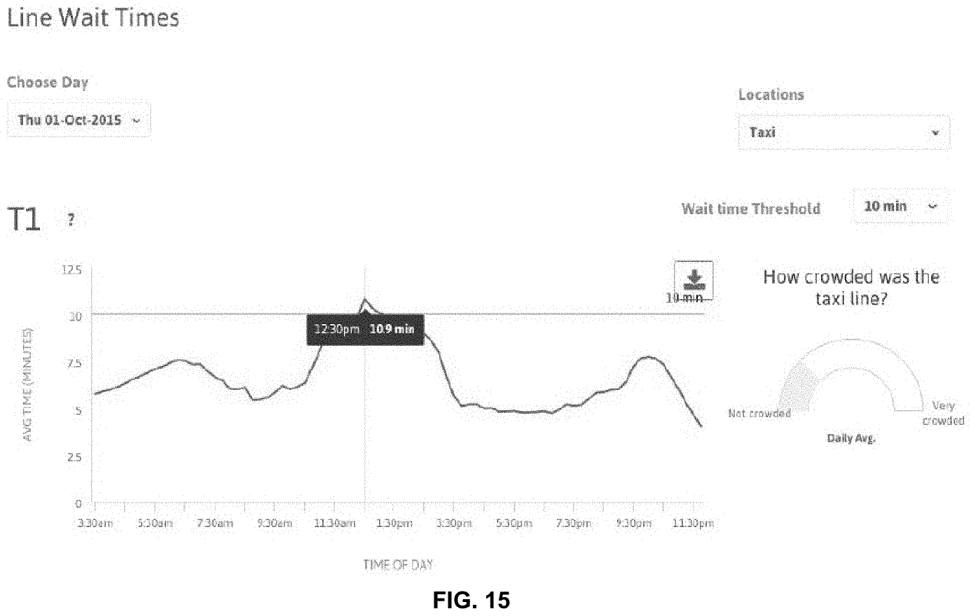

FIG. 14A shows an interface for viewing line wait times at airports. In region 1402, users can choose what time range of duration/activity data to view for different zones. In region 1404, users can set different thresholds to quickly identify if the wait times for a fifteen minute period breached the selected threshold. In region 1406, duration is reported in fifteen minute increments. In region 1408, a depiction of crowding per zone is shown. FIG. 14B shows an additional security line interface. Taxi line wait information can similarly be seen in the interface shown in FIG. 15.

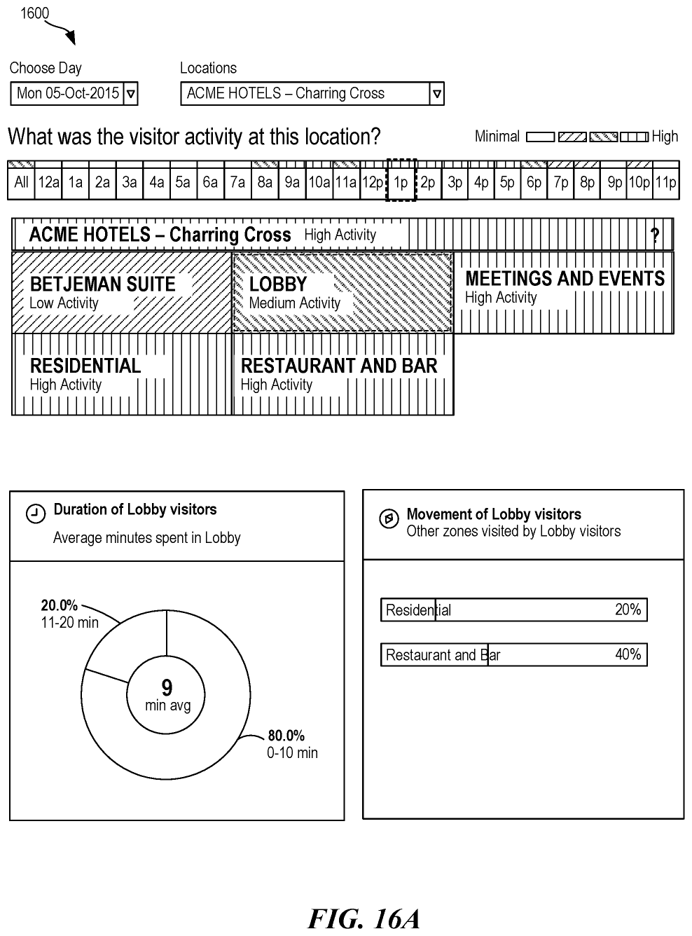

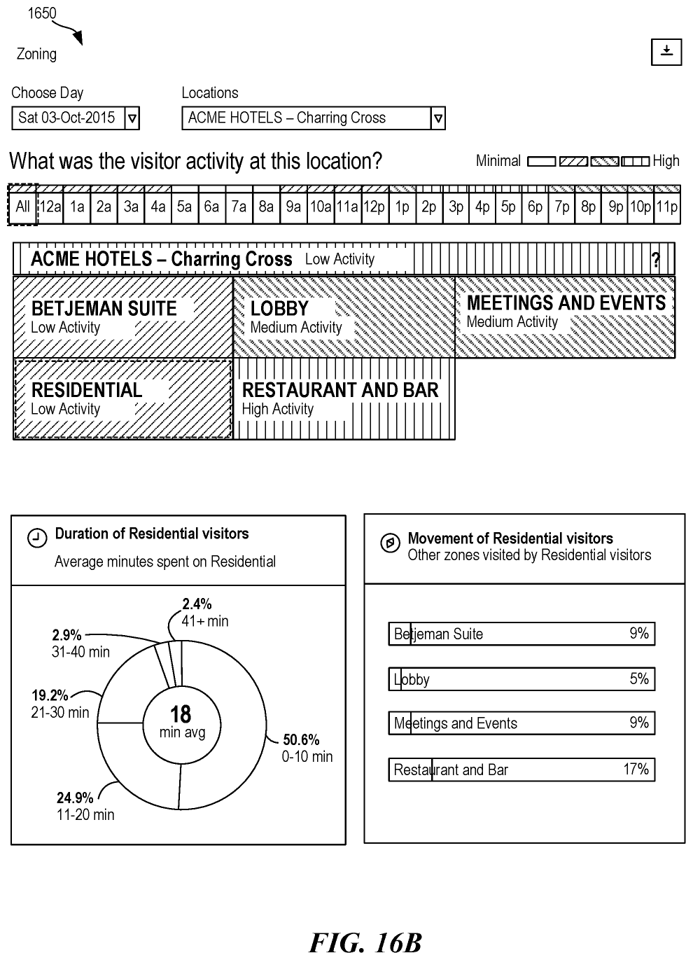

FIG. 16A shows an interface depicting zoning information for a hotel. The activity, duration, and cross visits on an hourly basis is shown in FIG. 16A for all zones in the selected hotel. FIG. 16B shows an additional hotel interface. Using techniques described herein and interfaces such as interfaces 1600 and 1650, a representative of the hotel can determine which parts of the hotel are busy and when. Further, insight such as which portion of hotel restaurant visitors are not guests of the hotel can be determined (e.g., by looking at the co-visits between the restaurant and areas of the hotel that only a guest would typically visit (e.g., the check-in area or guest rooms). As mentioned above, in some embodiments, a representative of a customer of platform 170 (e.g., an administrator acting on behalf of a hotel) configures platform 170 with a list of known employee device IDs so that they can be excluded from analysis performed by platform 170. In the context of a hotel, registering employee devices can be particularly helpful, where hotel guests and hotel employees may have significantly more similar movements/duration patterns than those between shoppers and retail clerks.

Additional Information Regarding Metrics

As explained above, platform 170 periodically (e.g., on hourly and daily intervals) computes various metrics with respect to visitor data. In some embodiments, the metrics are stored in a relational database system (RDS 242) table called “d4 metrics tall.” The metrics can also/instead be stored in other locations, such as Redshift 236. The records are used to compute metrics across various time periods per customer, zone, and device. A description of column names in “d4_metrics_tall” is provided below.

| Column Name | Use |
|---|---|
| client name | Stores the customer name |
| hierarchy_node_id | Stores the “zone” name |
| Period | Specifies if this metric is from an hourly or |
| | daily raw log processing |
| period_earliest | The start time of the period. |
| Birth | The processing time of the period, or when |
| | the batch processing was run |
| Metric | The type of metric being calculated from the |
| | raw logs (see below) |
| Value | The calculated value of the metric |
| confidence_interval_low | Used to specify the certainty of the calculated |
| and | value of the metric |
| confidence_interval_high | |
| sample_size | The amount of data processed to calculate the |
| | value of the metric |

The following is a list of example metrics that can be computed by platform 170.

| Metric name | Description |
|---|---|
| bounce-rate | The percentage of visitors who enter the store and |
| | then leave within 2 minutes |
| capture-rate | The percentage of devices that meet the criteria for |
| | a visitor |
| engagement-rate | The percentage of visitors who enter the store and |
| | remain for at least 20 minutes |
| first-tier-dur | Visits fitting within the first tier duration |
| second-tier-dur | Visits fitting within the second tier duration |
| third-tier-dur | Visits fitting within the third tier duration |
| fourth-tier-dur | Visits fitting within the fourth tier duration |
| lapsed-30-ratio | The percentage of visitors who count as lapsed |
| recent-30-ratio | The percentage of visitors counting as recent |
| repeat-ratio | The percentage of repeat visits |
| total-opportunity | The total number of visitors during the period, used |
| | to calculate other metrics |
| visit-duration | The duration of a specific visit |
| Visits | The total number of visits during a period |
| Walkbys | The percentage of recorded devices that are |
| | classified as walk-bys |

Hourly Metrics: Every hour, platform 170 calculates metrics for each zone and customer across all data collected for the previous hour. One example hourly report is the hourly report by sensor (FIRES), which collates the customer, zone, sensor, and timestamp at which each device is seen.

Daily Metrics: Each 24-hour period, HRBS reports are aggregated into a daily summary by span (DSBS). This report keys metrics on a combination of customer, zone, and device. For each key, the report will collect several timestamps. These include the last time a device was seen as a visitor, the last time a device was seen as a walk-by, the maximum device signal strength over the entire 24-hour period, the sum of the signal, the sum of the signal squared, the sum of the signal cubed, the event count, the inner and outer duration in seconds, and the device type. The device type includes but is not limited to visitor, walk-by, and access point.

Daily metrics are also calculated across all devices seen during that day. Using previously calculated metrics, platform 170 will then calculate a number of other statistics.

Daily metrics also include statistics covering the duration of visits. Visit length is split into distinct tiers. For example, tier 1 could be less than 5 minutes, tier 1 could be 5 to 15 minutes, and so forth. The daily metrics include which percentage of visitors fit into each tier of visit duration.

In various embodiments, aggregated daily metrics (e.g., the DSBS), are stored in RDS 242 in a table called “daily summary by span”. A description of various fields used as a key in “daily summary by span” is provided below. Other fields in the table are used to record specific metrics and time information for specific devices in customers and zones.

| Field | Description |
|---|---|
| the_date_local | The date the record covers |
| span_name | Name of the customer |
| zone_name | Name of the zone |
| device_id | The unique ID for the measured device |
| manufacturer_id | The unique ID used to identify the manufacturer |
| | of the device |

Platform 170 also calculates long-term metrics and presents them in reports. Among these long-term reports is a 30-day report, which includes the percentage of visiting devices which have been seen in a zone more than once in the last 30 days, and, in some embodiments, the percentage of lapsed visiting devices. Lapsed devices are those which have not visited a specific zone in 30 or more days. These percentages are calculated per zone and included in a report that is prepared for each customer.

Historical data is also stored and can be queried (e.g., by historical data parsing script, function, or other appropriate element). In various embodiments, a query of historical data is performed against Redshift 236. Results are cached in S3 (212) and read by Scala code in Spark (234). Examples of metrics that can be calculated using these resources include:
First time a device was seen in a customer's zones (across all historical data)
Last time the device was seen as a visitor
Last time the device was seen as a walk-by
Maximum signal strength over the entire reporting period
Number of sensor observations recorded during the entire reporting period for this device
Total duration of the device's visits to the zone during the reporting period Events

In various embodiments, platform 170 provides customers with the ability to designate a discrete time period as an operational event, allowing for analytics to be performed in the context of the event. An event can be an arbitrary designation of a date range (e.g., “March 2016” and can also correspond to promotional or other events (e.g., “Spring Clearance”). The following are examples of scenarios in which events might be created within platform 170:
An analytics manager from a fast casual restaurant can enter the dates and expected revenue from a recent promotion to understand if offers/menu items drew the expected results. The analytics manager might share the information with marketing colleagues to influence future campaigns, in addition to the necessary leadership as part of a reporting exercise.
A regional operations manager at a mid-sized specialty retailer can use an event to understand the effectiveness of a training program on his team's ability to engage customers. For example, suppose the manager has noticed a declining engagement rate month-on-month. The manager can use eventing to understand if the new educational program drew his expected engagement result and further had an impact on sales in his stores during a particular period.
A marketing campaign manager from a national bank chain is responsible for driving new visitor traffic into the new bank-cafe hybrid locations. The locations serve coffee and tea but not food. The manager can use eventing to compare the performance of different food vendors. For example, the manager could run a campaign with a waffle company one week and then a scone vendor a few weeks later. Using eventing, the manager can leverage AB testing to select the better long-term food partner in encouraging storefront conversion and new visitor traffic.

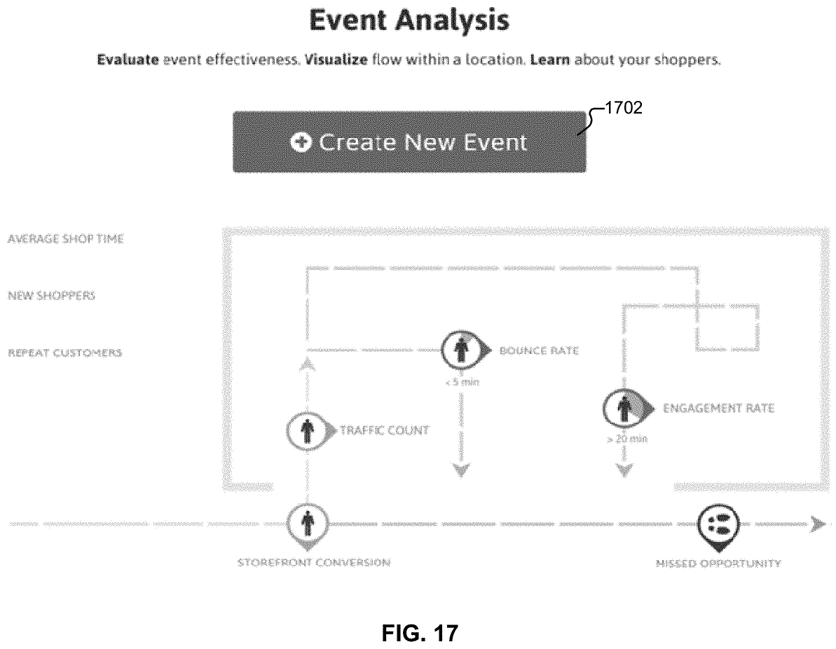

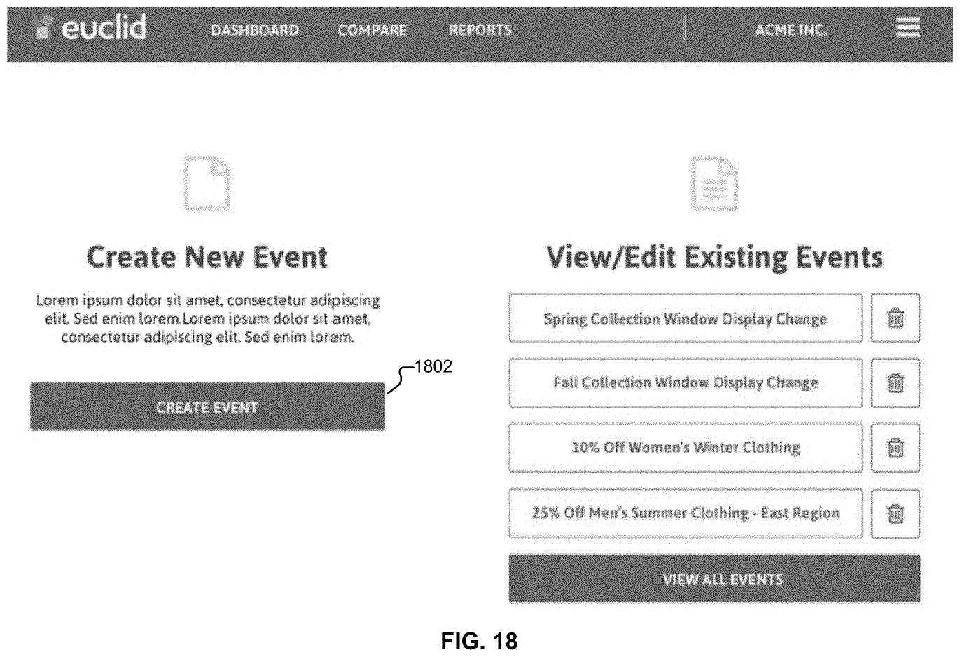

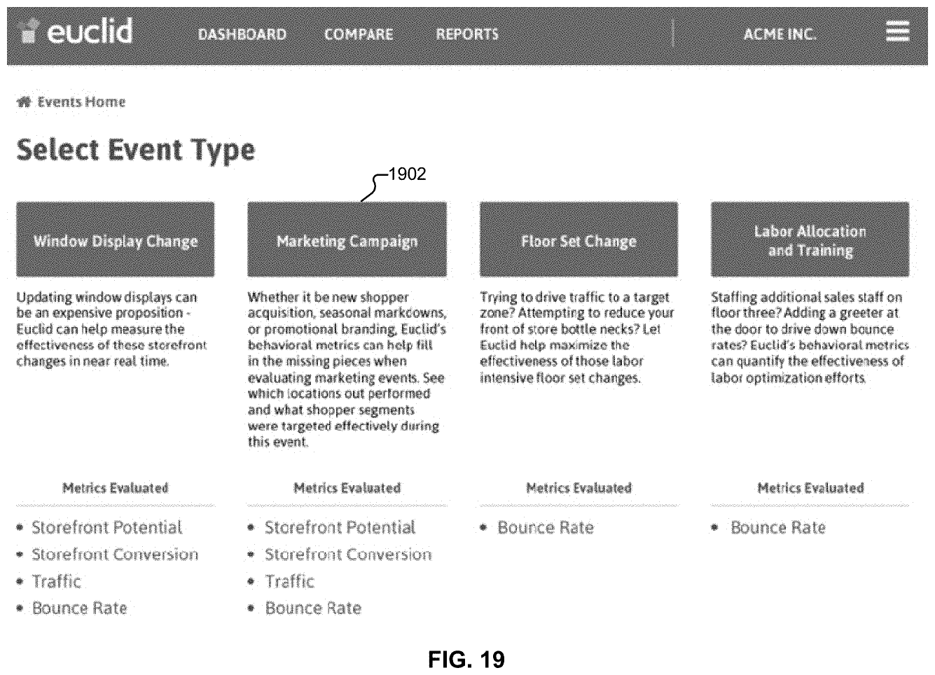

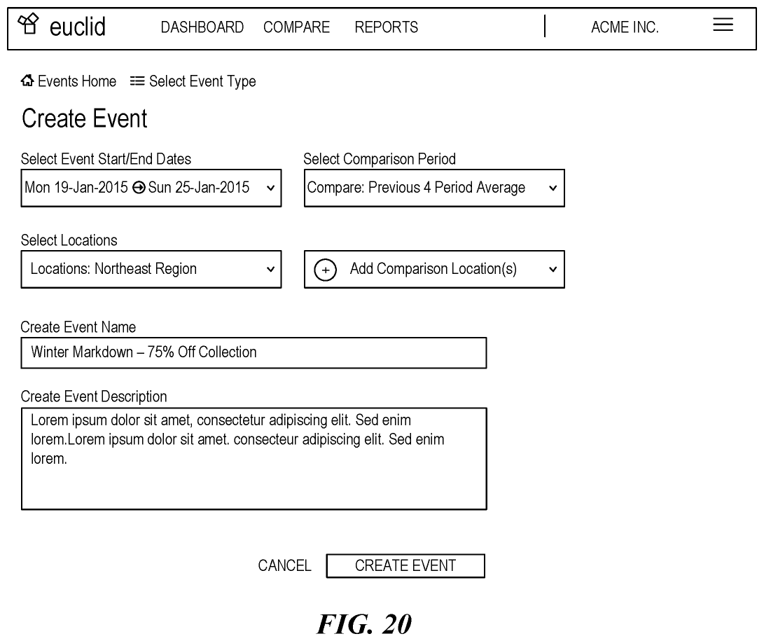

In the following example, suppose Rachel has been tasked with creating an event and evaluating visitor traffic associated with the event. A sample interface for creating an event is shown in FIG. 17 (and is an example of an interface that can be provided by platform 170, e.g., via interface 174). An alternate interface for initiating the creation of an event is shown in FIG. 18. To create a new event, Rachel clicks on region 1702 (or region 1802, as applicable). After doing so, Alice is presented with the interface shown in FIG. 19, where she is asked to pick a type of event. Suppose Alice picks “Marketing Campaign” by selecting region 1902. She is presented with the interface shown in FIG. 20 in response and prompted to supply various information with respect to event creation. Note that an event can be created retroactively. For example, Alice can create a “Winter Markdown” event for ACME on platform 170 even after the date range specified for the event has ended, allowing for retroactive analysis of data pertinent during the specified date range.

In particular, in the interface shown in FIG. 20, Alice is prompted to create an event by adding an event name, event description, location (whether an individual location or hierarchy level), date range for the event, and (optionally) expected sales for the event.

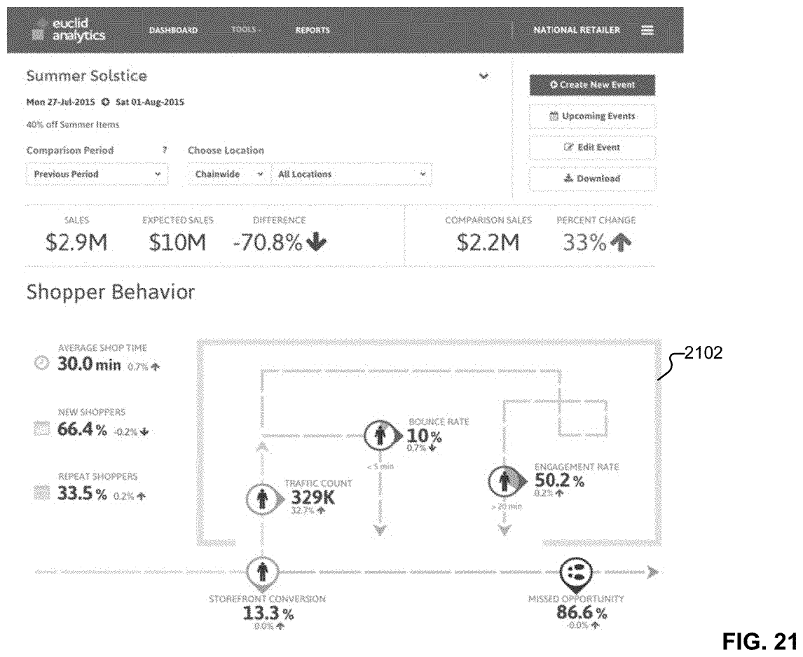

Once the event is created (and has commenced), Alice can view the performance of the event in a summary page interface, an embodiment of which is shown in FIG. 21. From the summary page interface, Alice can select specific locations, update the comparison period, edit the event, create a new event, and view upcoming events.

The summary page interface includes a metrics box 2102. In the example shown in FIG. 21, “storefront conversion” indicates how effective a location was at getting visitors into the location. “Traffic count” is count of visitors. “Bounce rate” indicates the number of visitors who left within five minutes.

Visitor Profile

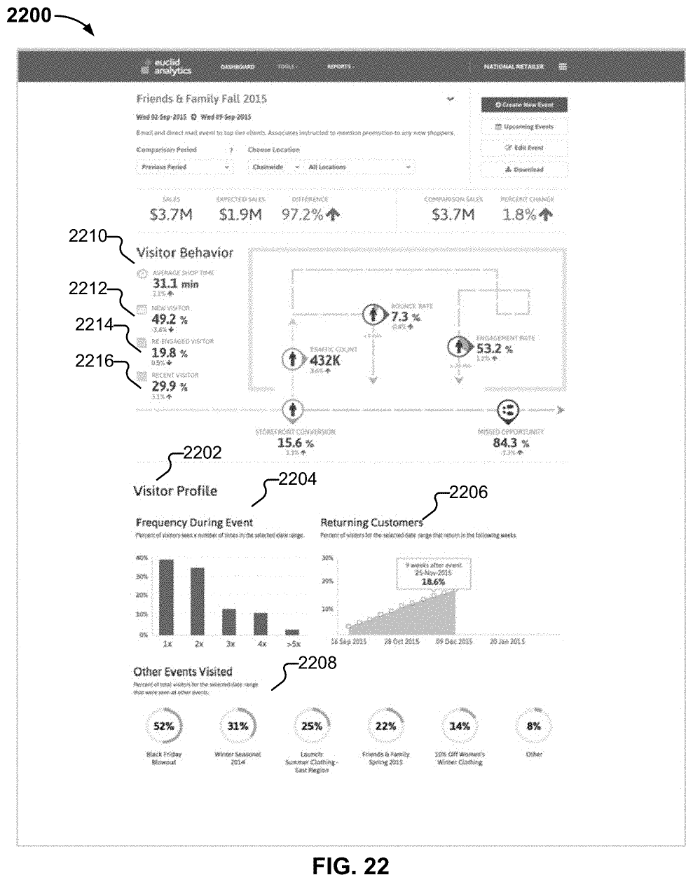

An alternate embodiment of a summary page interface is shown in FIG. 22. The summary page shown in FIG. 22 includes a visitor profile section 2202. The visitor profile provides Alice with an understanding of the type of customers entering a location during an event. In particular, the summary includes three kinds of evaluations: Frequency During Event (2204), Returning Visitors (2206), and Other Events Visited (2208). Each section provides a different view into the loyalty profile of the event visitors.

The event frequency (2204) is the ratio of visitors who are recorded at an event across distinct segments of time. For example, an event lasting three days might have event frequencies measured in 1-day increments. An event frequency report in such a scenario would indicate that a certain number of visitors were recorded during only one total day of the event, a smaller number during two separate days of the event, and an even smaller number during all three days of the event. An event frequency report can also include the total sample size or number of devices recorded during the event. In various embodiments, event frequency reports are stored in S3 or another appropriate location, allowing multiple events to be compared using multiple event frequency reports. When an event frequency report is generated (e.g., from a database), it is given a birth timestamp, which is the time at which the report was originally created. An event frequency report can also specify the beginning and end times of the event. In the example shown in FIG. 22, Alice can hover over each bar in region 2204 to see actual frequency values. Frequency metrics can also be determined outside of specific events, as applicable. For example, a fast food restaurant may choose to set an arbitrary time period (e.g., a week or a month) and measure on a recurring basis (e.g., with a histogram similar to that depicted in 2204) the number of visits made by customers in that time period.

The return rate (also referred to herein as “revisitation”) of visitors after an event has concluded is depicted in region 2206. In various embodiments, event revisitation data is kept in a table in RDS 242 called “d4_event_revisitation.” A returning visitors report can be run at any time after the conclusion of an event, and reports on the percentage of visitors seen during an event who have been recorded in a customer's zones for the first time since the end of the event. Percentages are reported over 24-hour periods. The maximum timespan covered by the report is determined by the lesser of two values: (1) the length of time at which 100% of visitors seen during the event have been recorded in a customer's zones since the conclusion of the event, and (2) a configurable time period that defaults to six months. Alice can hover over each point in the graph shown in region 2206 to see actual values.

Depicted in region 2208 is an indication of other events visited by visitors to the instant event (e.g., at the instant location). The report includes the percentage of visitors who were present during each event in the report compared to the total number of distinct visitors to all events in the report. One way to determine metrics on which devices have been to which (multiple) events is to tag records associated with devices the event identifiers. Another way to determine “other events visited” metrics (e.g., as shown in region 2208) is as follows. Each event at a given location has associated with it event metadata. A given event has a start date and an end date. All of the devices observed within the start/end date of a first event can then be checked to determine whether they were also observed within the start/end date of each of the other events (e.g., a comparison against the dates of the second event, a comparison against the dates of the third event, etc.). The results are ranked and the events with the highest amount of overlapping observed devices are presented in region 2208.

The following are examples of scenarios in which data in the visitor profile is used by a representative of a customer of platform 170:
The analytics manager from the fast casual restaurant can use the visitor profile to understand if a recent menu promotion encouraged repeat visits during the allotted time that the promotion ran. With that information, the manager can start to compare events and opt to plan future promotions based on the stickiness of past ones.
Suppose the regional operations manager at the mid-sized specialty retailer has rolled out a new training to his staff in which they create closer relationships with customers and sometimes seek their contact information for follow-up. The manager can use the visitor profile to see if this tactic is effective at encouraging an increase in repeat visitors over time, signaling that loyalty is being nurtured by his staff.
Suppose a marketing campaign manager for a national pet food/supplies chain has been urging management to pull back from doing discount-driven promotions, as she suspects that such promotions do not attract valuable customers for the chain. The manager could test two promotions: one that is discount-driven (e.g., 20% off all pet bedding) and one that is not (e.g., “check out our new indestructible chew toys”). With the discount-driven promotion, she will be able to tell if the overlap with other events confirms her suspicion about a customer segment that only visits during discounts. Furthermore, she might be able to tell which promotion encourages more repeat visits after the conclusion of the event.

Visitor Loyalty Behavior

Also included in interface 2200 is region 2210, which indicates visitor loyalty behavior. In particular, region 2210 reports on the percentage of customers who are new (2212), re-engaged (2214) or recent (2216). In addition to the current breakdown of visitor types (49.2% new; 19.8% re-engaged; 29.9% recent), a comparison between the current breakdown and a previous time period (e.g., a previous event) is included (i.e., −3.6%; −0.5%; 3.2%).

A new visitor is one who has not been seen previously (e.g., at the reporting location, or at any location, as applicable). A visitor will remain classified as new until he returns to a previously visited location. A re-engaged visitor is one who has visited the same location at least twice, and whose last visit to that location was more than 30 days ago. In various embodiments, 30 days is used as a default threshold value. The value is customizable. For example, certain types of businesses (e.g., oil change facilities) may choose to use a longer duration (e.g. 60 or 90 days) to better align with their natural customer cycle, whereas other businesses (e.g., coffee shops) may choose to use a shorter duration (e.g., 14 days). A recent visitor is one has visited the same location at least twice, and whose previous visit was within the last 30 days.

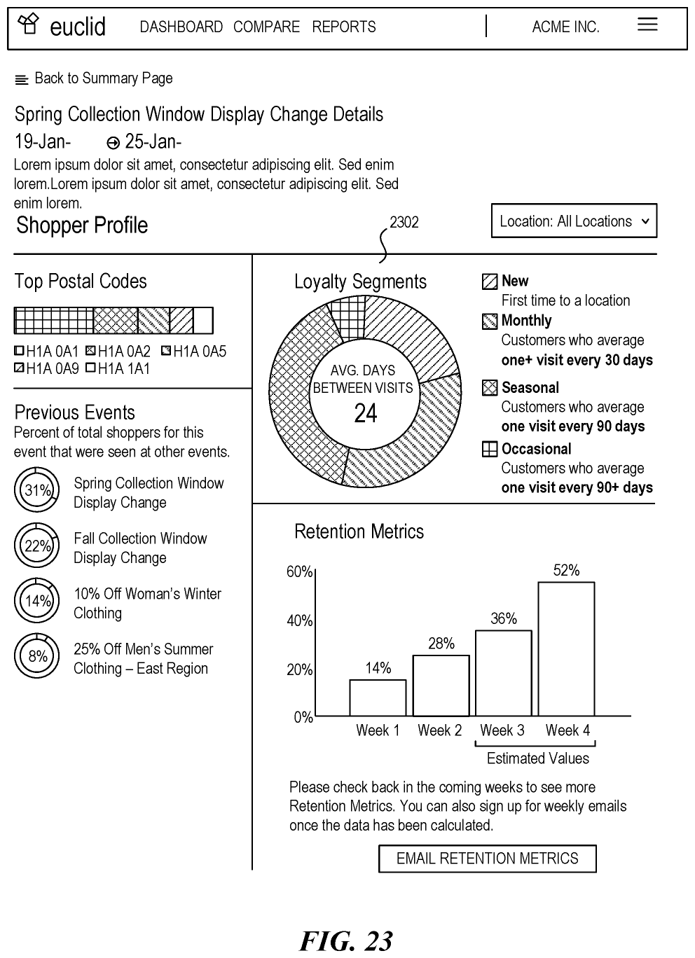

An alternate embodiment of an interface depicting loyalty information is shown in FIG. 23 (in region 2302).

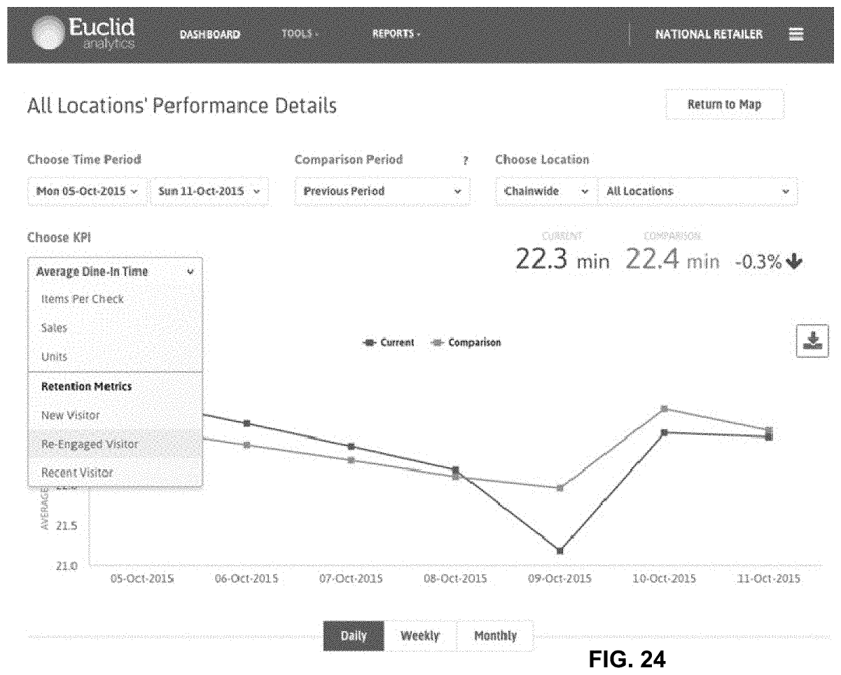

The following are examples of scenarios in which a user of platform 170 is interested in the ability to differentiate between kinds of visitor loyalty behavior:
Sean is responsible for regional merchandising for a national retail chain for teens. He currently plans for a large shipment every 30 days. Knowing that his more loyal customers visit that frequently, he configures the chain's account with platform 170 such that a “recent” shopper is one who visits every 30 days. Using the “re-engaged” metric, Sean will be able to see if a certain month's merchandise is more effective at bringing in customers who may be slipping away. Similarly, should he choose to push the merchandise with an in-store event or advertising, he may be able to observe whether the additional marketing spend increased the “re- engaged” metric with the end goal of moving “re-engaged” customers into the “recent” bucket.
Jenn manages marketing campaigns for a regional coffee and tea chain. She knows that her Fall menu typically drives increased traffic into the locations, particularly from non-regular customers. This year, she would like to see if she can bring those less loyal customers in before the seasonal items are introduced, and also see if she can keep them longer. One option she has is to start promotion early and track the success through the “re-engaged.” Once the Fall menu is formally introduced she can compare the subsequent “re-engaged” metric to the one observed after her early promotion kicks off. An example of performing a comparison between two periods' re-engaged metrics is shown in FIG. 24. Over the course of the Fall season, Jenn can also track the “new” visitor number closely (e.g., to ensure it has decreased steadily but not too much).

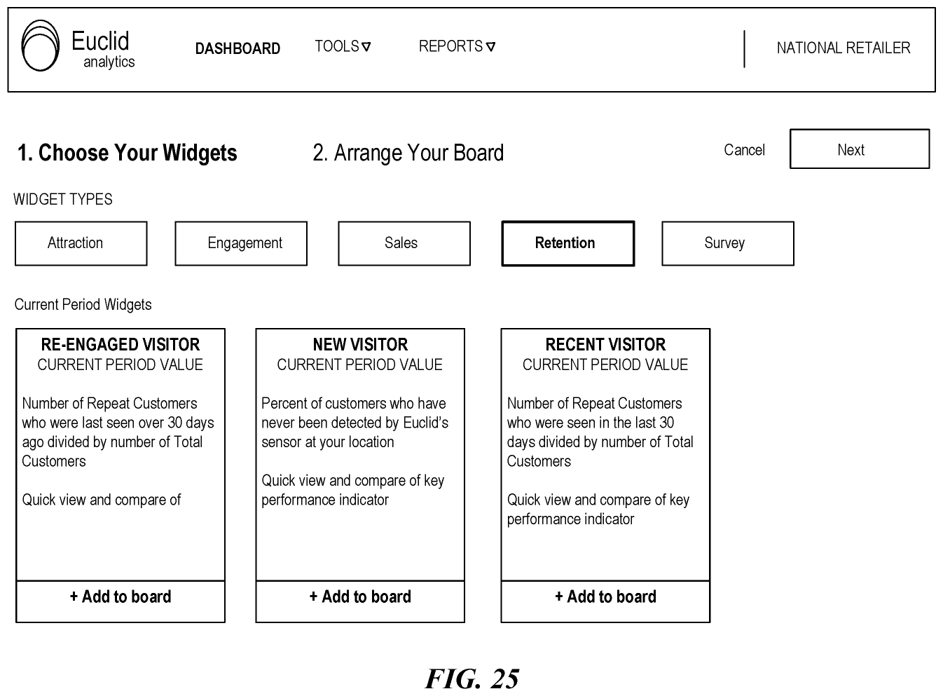

In various embodiments, the interface provided to a user of platform 170 is configurable by that user. For example, a user can indicate which widgets should be presented to the user in a dashboard view. In the interface shown in FIG. 25, the user is reviewing options for including visitor loyalty data in the dashboard view.

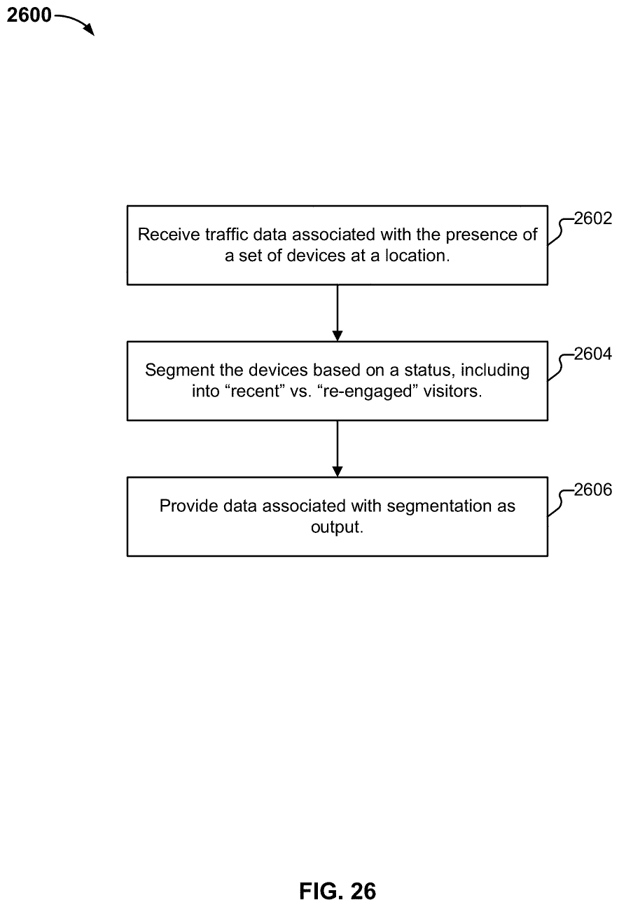

FIG. 26 illustrates an embodiment of a process for assessing visitor composition. In various embodiments, process 2600 is performed by platform 170. The process begins at 2602 when traffic data associated with the presence of a set of devices at a location is received. As one example, such traffic data is received at 2602 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 2602 of the process may be repeated several times (e.g., with data about the observation of device 112 also being received at 2602, whether from sensor 108, or another sensor, and/or from a controller). At 2604, the devices are segmented based on a status. Examples of device status include (for a given location) whether the device is “new,” “re-engaged,” or “recent.” In various embodiments, segmentation is performed by metrics pipeline 230 (described in more detail above) evaluating log data (e.g., in storage 212, RDS 242, Redshift 236, and/or Cassandra 228) as applicable and annotating the log data in accordance with rules such as those provided above (i.e., using the definitions of new/re-engaged/recent visitors). At 2606, data associated with the segmentation is provided as output. As one example, a breakdown of visitor composition is depicted (e.g., at 2606) in the interface shown in FIG. 22 in region 2210. As shown in FIG. 22, the view presented in interface 2200 is dynamic, and portion 2606 can be repeated (e.g., in response to user interactions with interface 2200).

Events Pipeline Wrapper

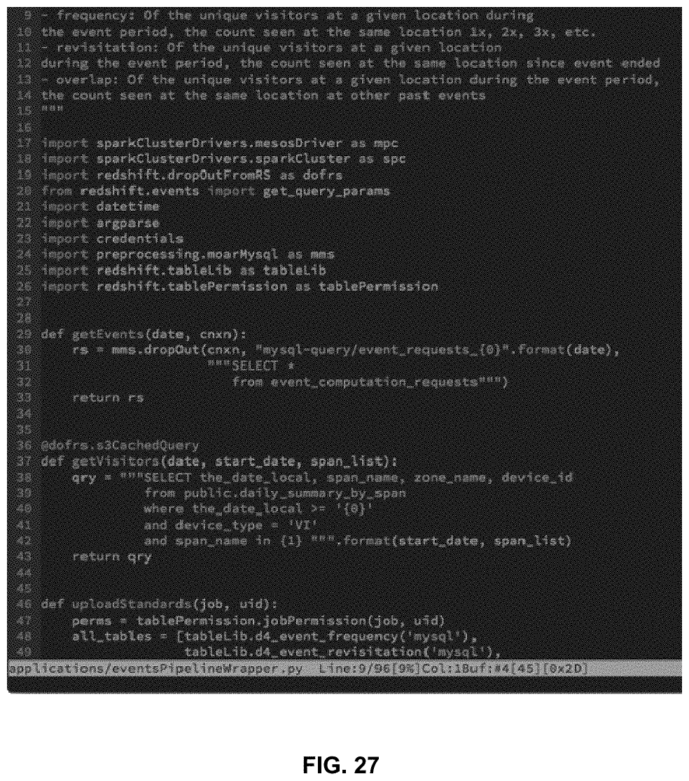

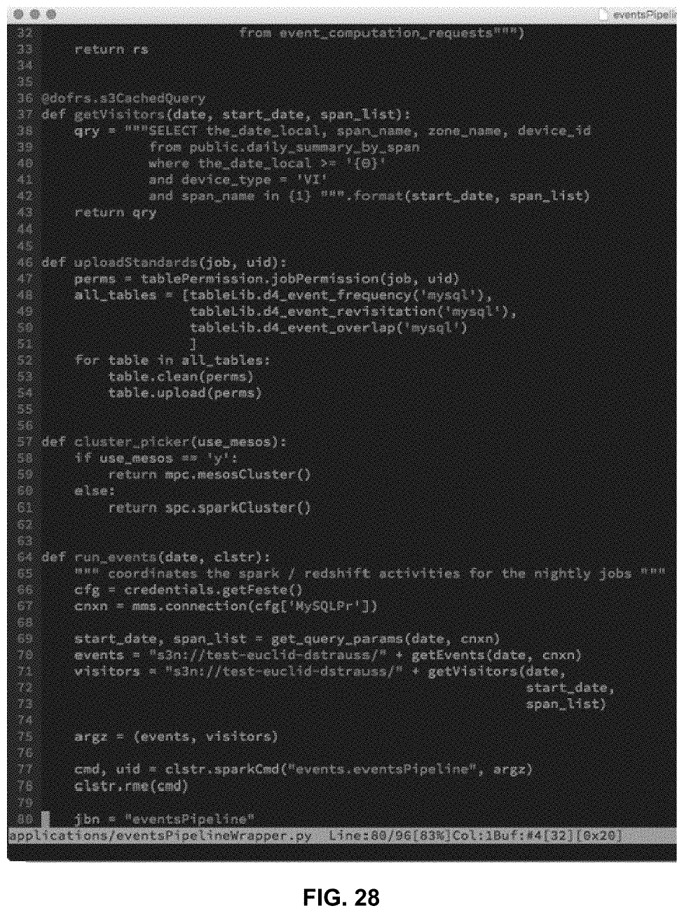

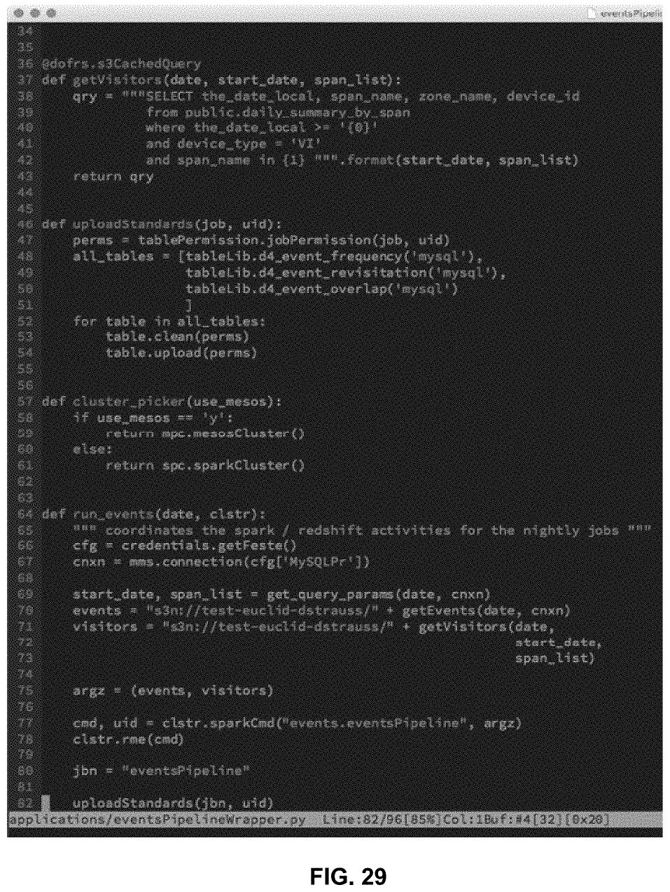

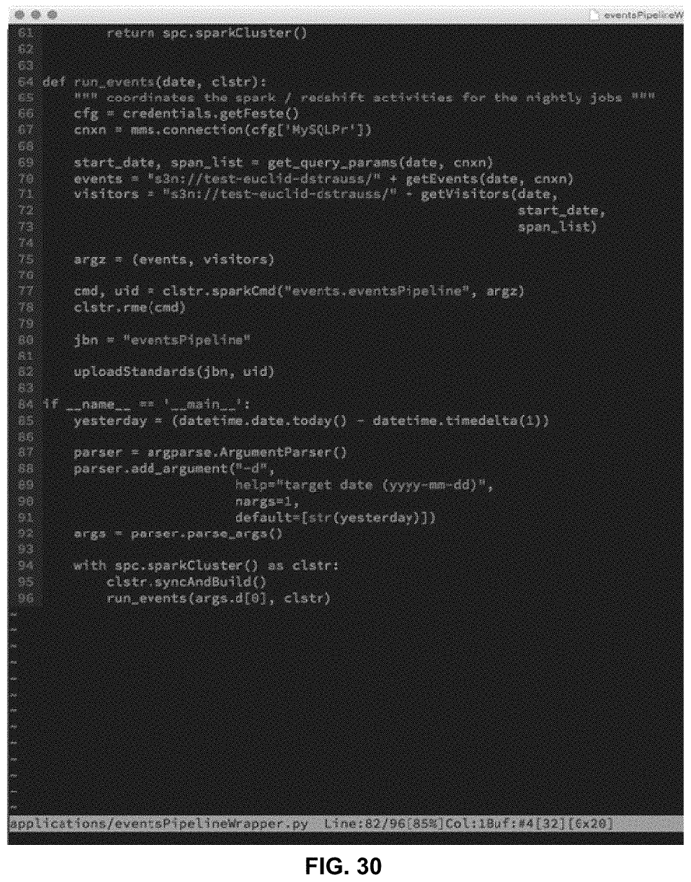

Events pipeline wrapper 240 (eventsPipelineWrapper.py) is a Python script that calculates events-based metrics in various embodiments. In particular, events pipeline wrapper 240 outputs the following: (1) event frequency; (2) revisitation; and (3) overlap. FIGS. 27-30 collectively depict an example implementation of an events pipeline wrapper script.

In various embodiments, an RDS table called “d4 event frequency” (keyed by customer, zone, an event identifier, and start/end times) is includes the following fields:

| Field | Description |
|---|---|
| client_name | The customer name |
| hierarchy_node_id | The zone name |
| start_date | The beginning of the event |
| end_date | The end of the event |
| Birth | The time at which the metric was calculated |
| Metric | The metric calculated (visitor-frequency) |
| frequency_level | The number of days for which visitor frequency |
| | was calculated |
| Value | The count of distinct visitors detected by the |
| | zone's sensors for the number of days in the |
| | “frequency_level” column |
| sample_size | The total number of visitors detected by the |
| | zone's sensors over the entire duration of the |
| | event. |

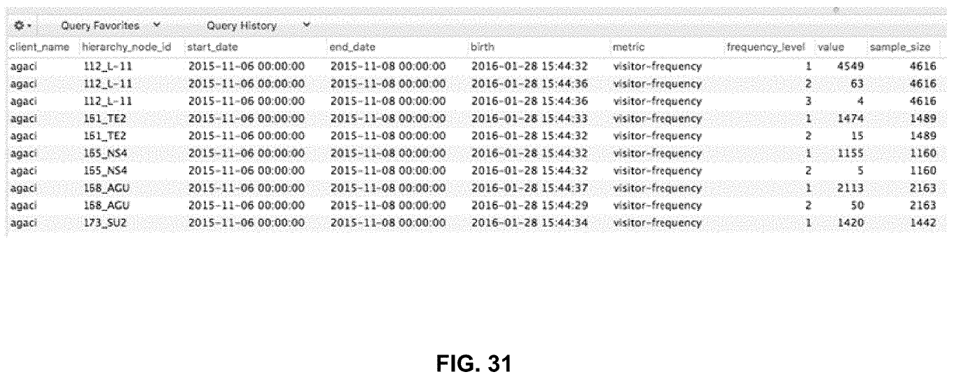

Sample data from the “d4_event_frequency” table is shown in FIG. 31. In the example of FIG. 31, a three day event was held. A total of 4616 unique devices were seen at sensor 112_L-11 during the three day event. Of those devices, 4549 visited once, 63 visited two of the three days, and 4 visited all three days. A total of 1489 unique devices were seen at sensor 161_TE2. Of those devices, 1474 visited once, 15 visited two of the three days, and no devices visited all three days.

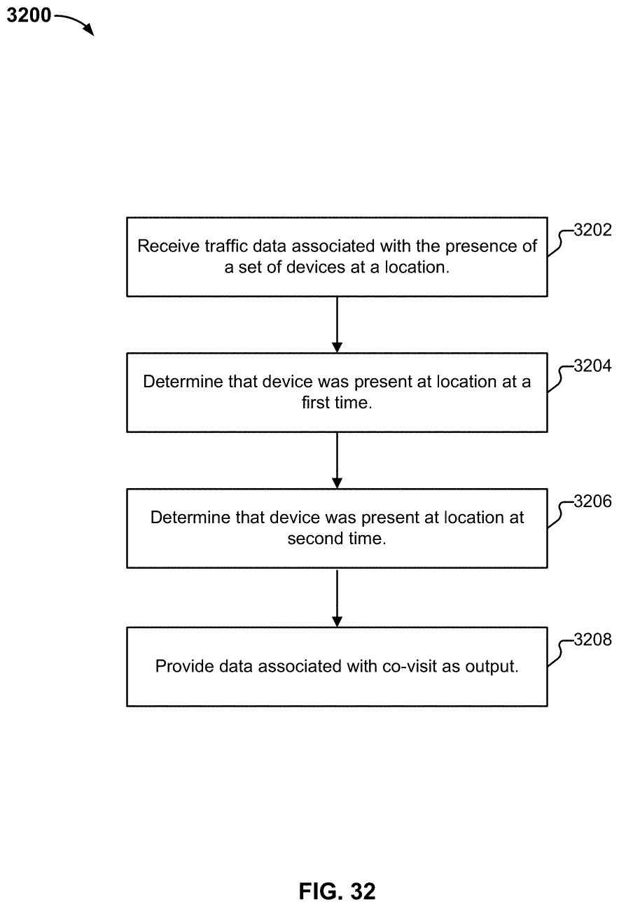

FIG. 32 illustrates an embodiment of a process for determining co-visits by visitors. In various embodiments, process 3200 is performed by platform 170. The process begins at 3202 when traffic data associated with the presence of a set of devices at a location is received. As one example, such traffic data is received at 3202 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3202 of the process may be repeated several times (e.g., with data about the observation of device 112 also being received at 3202, whether from sensor 108, or another sensor, and/or from a controller). At 3204, a determination is made that a first device was present at a first location at a first time (e.g., during an event). In various embodiments, the determination is made by events pipeline wrapper 240. At 3206, a determination is made that the device was also present at the first location at a second time (e.g., during a subsequent event). In various embodiments, the determination is also made by events pipeline wrapper 240. In various embodiments, portions 3204 and/or 3206 of process 3200 are performed by metrics pipeline 230 (described in more detail above) evaluating log data (e.g., in storage 212, RDS 242, Redshift 236, and/or Cassandra 228) as applicable and annotating the log data. Finally, at 3208, data associated with the co-visit (of the device to the first location on two different occasions) is provided as output. As one example, a breakdown of visitor co-visits is depicted (e.g., at 2608) in the interface shown in FIG. 22 in region 2202. Additional discussion of aspects of process 3200 are provided above (e.g., in conjunction with discussion of FIG. 22).

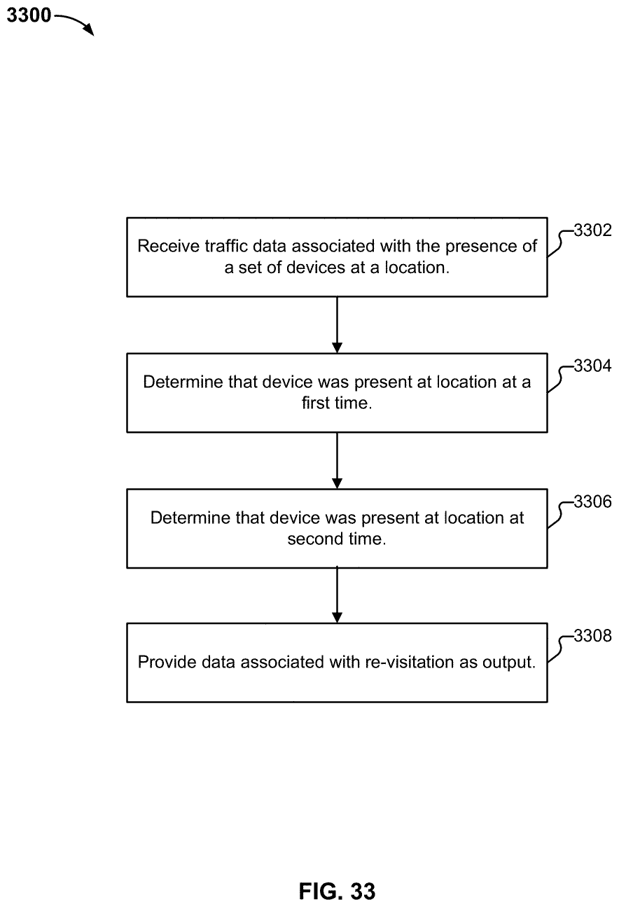

FIG. 33 illustrates an embodiment of a process for determining re-visitation by visitors. In various embodiments, process 3300 is performed by platform 170. The process begins at 3302 when traffic data associated with the presence of a set of devices at a location is received. As one example, such traffic data is received at 3302 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3302 of the process may be repeated several times (e.g., with data about the observation of device 112 also being received at 3302, whether from sensor 108, or another sensor, and/or from a controller). At 3304, a determination is made that a first device was present at a first location at a first time (e.g., during an event). In various embodiments, the determination is made by events pipeline wrapper 240. At 3306, a determination is made that the device was also present at the first location at a second time (e.g., at a time subsequent to the event). In various embodiments, the determination is also made by events pipeline wrapper 240. In various embodiments, portions 3304 and/or 3306 of process 3300 are performed by metrics pipeline 230 (described in more detail above) evaluating log data (e.g., in storage 212, RDS 242, Redshift 236, and/or Cassandra 228) as applicable and annotating the log data. Finally, at 3308, data associated with the re-visit (of the device to the first location at a subsequent time) is provided as output. As one example, a breakdown of the lengths of time it took for visitors to re-visit is depicted (e.g., at 2606) in the interface shown in FIG. 22 in region 2202. Additional discussion of aspects of process 3300 are provided above (e.g., in conjunction with discussion of FIG. 22).

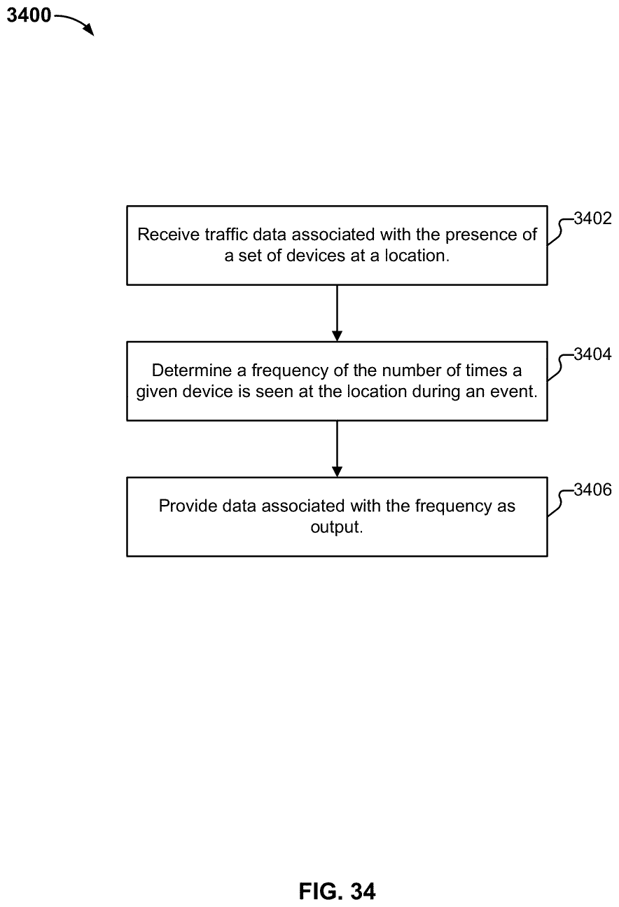

FIG. 34 illustrates an embodiment of a process for assessing visitor frequency during an event. In various embodiments, process 3400 is performed by platform 170. The process begins at 3402 when traffic data associated with the presence of a set of devices at a location is received. As one example, such traffic data is received at 3402 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3402 of the process may be repeated several times (e.g., with data about the observation of device 112 also being received at 3402, whether from sensor 108, or another sensor, and/or from a controller). At 3404, a determination is made of the frequency of the number of times that a given device was observed at the location. In various embodiments, the frequency analysis is performed by events pipeline wrapper 240. In various embodiments, the frequency analysis is performed by metrics pipeline 230 (described in more detail above) evaluating log data (e.g., in storage 212, RDS 242, Redshift 236, and/or Cassandra 228) as applicable and annotating the log data. At 3406, data associated with the frequency is provided as output. As one example, a breakdown of visitor frequency is depicted (e.g., at 3406) in the interface shown in FIG. 22 in region 2204. Additional discussion of aspects of process 3400 are provided above (e.g., in conjunction with discussion of FIG. 22).

Sales and Traffic Data Analysis

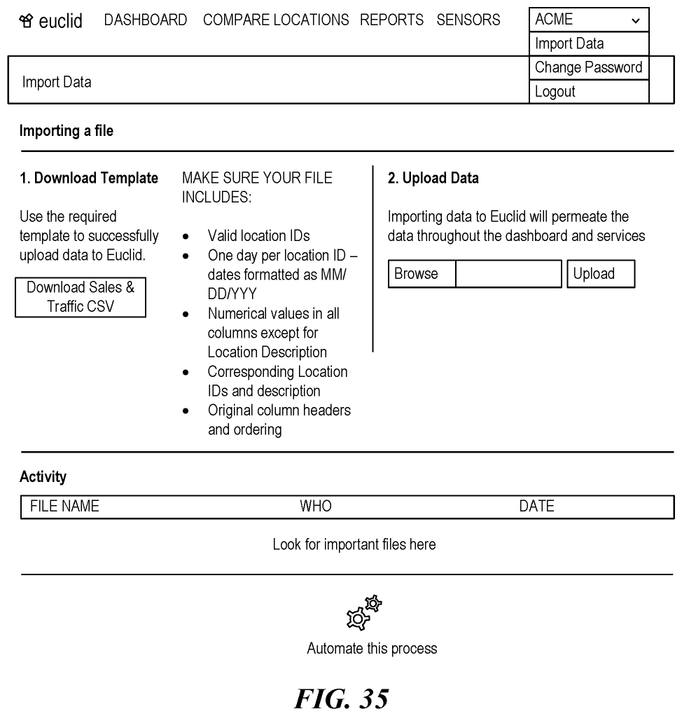

The services provided by traffic insight platform 170 can be used, for example, to assist brick and mortar retail become more intelligent and improve data-driven decisions for every location. Described herein is an Import Data feature (see FIG. 35 for an example), that improves the ability to obtain a clearer picture on sales performance and how customer behavior is influencing sales. Sales and traffic data can be imported to a dashboard, and custom dashboards and reports can also be created to monitor visitor activity and sales performance. In some embodiments, the sales and traffic data analysis described herein is supported/performed by platform 170. Using the techniques described below, the following example functionality is provided:
Obtaining a complete picture with traffic, visitor metrics and sales data in one integrated dashboard.
Finding trends and obtaining the most benefit from the fast and dynamic reporting tools described herein.
Ease of use by simply downloading a template and copying over existing data to monitor the essentials behind the performance of store(s).

Getting Started

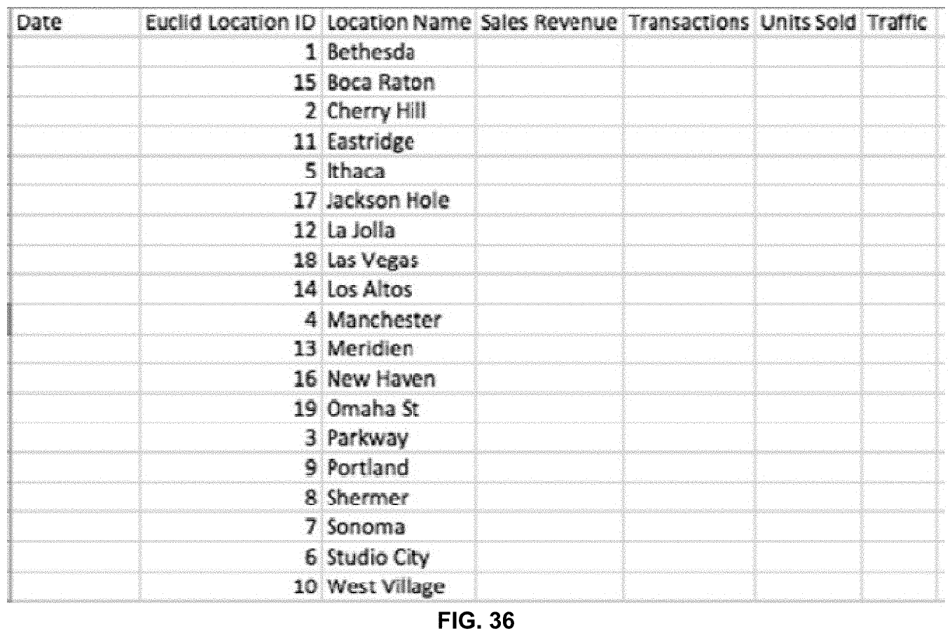

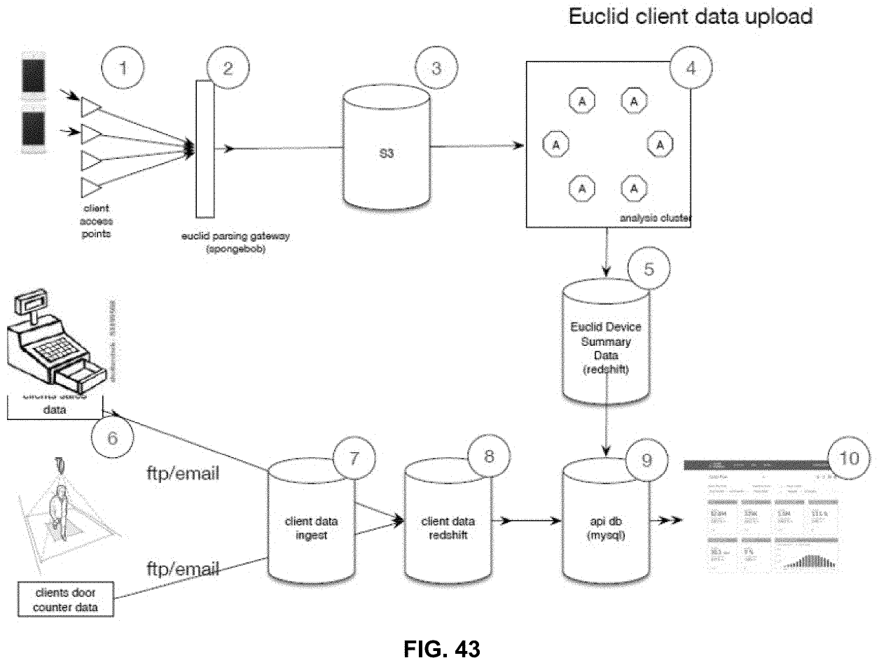

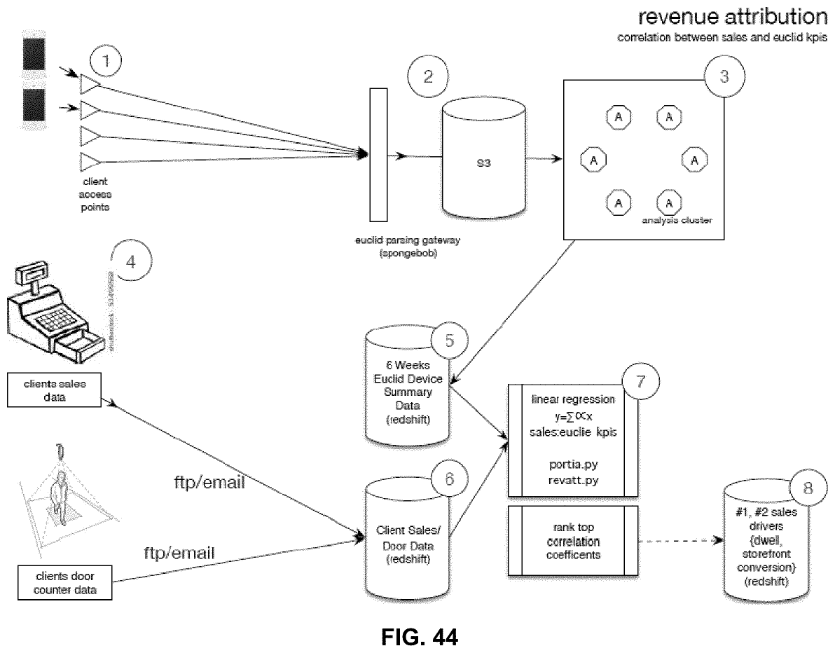

Using the techniques described herein, sales and traffic data can be viewed next to visitor activity for all locations in Customizable Dashboards and Custom Reports. In some embodiments, entities (e.g., business organizations) using the services of platform 170 can leverage flexible reporting by performing the following three steps:
Downloading a provided csv template (depicted in FIG. 36). Data can be ingested as comma separated values (CSV) file format or Microsoft Excel file format (XLS), as well as in other formats. For example, point of sales (POS), sales, and door counter data, can all be provided in varying formats, and custom parsers to ingest disparate data used by embodiments of platforms such as platform 170 and the platforms described in conjunction with FIGS. 43 and 44, as described herein, can be used, as applicable.
Copying over data from existing spreadsheets, such as:
   Sales Revenue
   Transactions
   Units Sold
   Traffic
Uploading and getting started by adding widgets to an organization's dashboards

By using the techniques described herein to view and evaluate sales and traffic data next to visitor activity, the following can be performed:
Connecting the dots or correlating on how well the organization's efforts to attract, engage and retain customers are influencing sales
Creating better sales forecasts with quick and easy views of location performance
Monitoring the outcomes and attribute ROI to marketing and operations initiatives

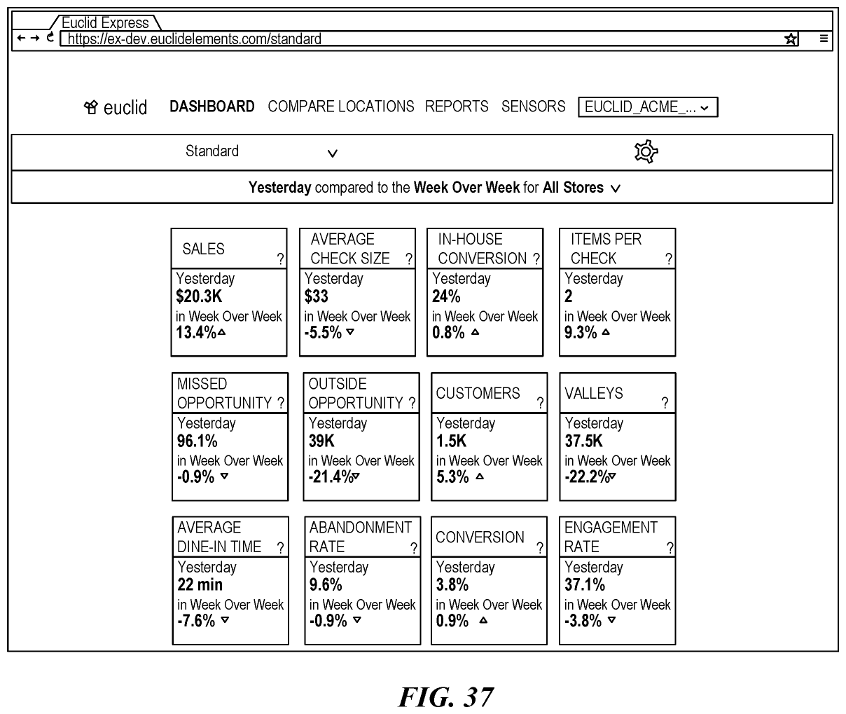

FIG. 37 shows a customizable dashboard that reflects a combination of sales and traffic information. Time series (e.g., total sales per day vs. time or traffic count (e.g., from door counters)) can be displayed in the dashboard widgets.

### EXAMPLES

### Example 1: Answering a Question About Sales Metrics

Yi, a forecasting analyst at ACME CLOTHING, has just received access to the services provided by platform 170 from Bob, an IT representative tasked with having platform 170's services implemented in the organization.
Yi finds the data captured and provided by platform 170 interesting and is looking for a way to couple the sales and traffic data that she looks at with the new information provided by platform 170 in order to make more informed forecasts for her stores. The Sales/Traffic data is an example of data that can be uploaded by a client. The information captured and provided by platform 170 includes, in various embodiments, key performance indicator (KPI) data, such as the following:
   i. avg shop time:=on average how much time a device spends in a location)
      1. duration:=For every device, an “outer” duration is calculated—i.e., the last timestamp seen (as visitor (referred to also as “VI”)) minus first timestamp seen (also as VI). These are aggregated over hours and days to give us the duration metric for every span-zone-date combination
   ii. storefront potential:=Number of people with Wi-Fi enabled smartphones detected outside & inside of an entity's store
   iii bounce rate:=Percentage of people with Wi-Fi enabled smartphones who spent less than X min (e.g., default 5 min) in a store
   iv. store front conversion:=Number of Shoppers who entered the store divided by Storefront Potential.

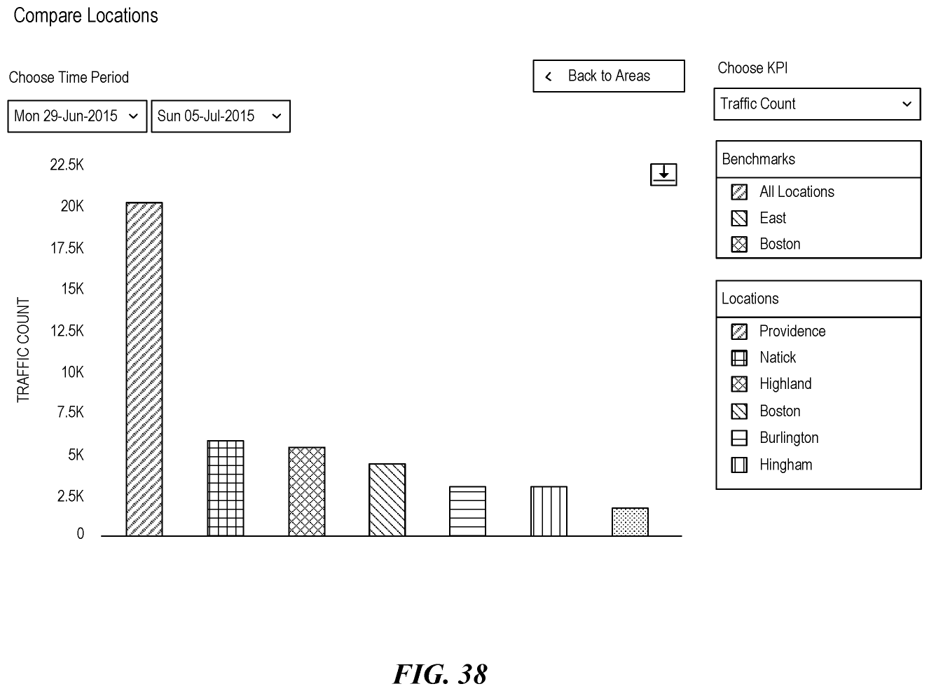

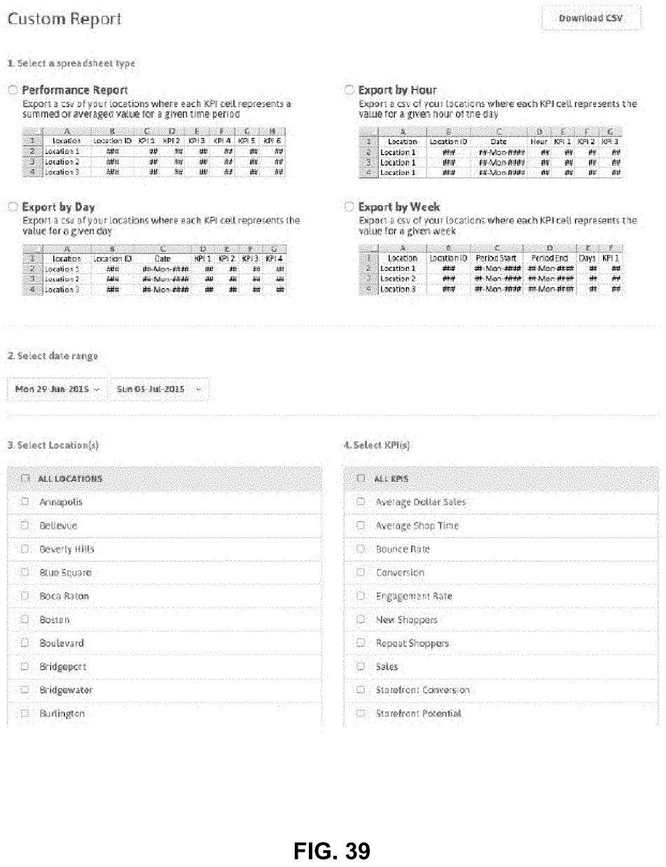

By reviewing these together, Yi can understand their relationship and have a deeper understanding of how user behavior as measured by KPIs is related to her sales data and/or traffic data.
Yi is looking at an excel spreadsheet of last week's sales numbers. She wants to understand more about the 3 bottom performing stores (sales vs. plan).
Yi looks up the duration for each individual store. In some embodiments, for every device seen, an “outer” duration is computed (i.e., the last timestamp seen (as VI) minus first timestamp seen (also as VI)). These are aggregated over hours and days to determine the duration metric for every span-zone-date combination.
Then, she sees an indicator that tells her to import sales, transactions, and traffic data from her stores to make comparisons with data obtained by platform 170 as well. For example, she can navigate to the My Dashboards page, and then the ‘Sales’ section and receive a message alerting her to click on a link to ‘Upload Sales Data’ which brings her to a new page.
Yi downloads the CSV template, populates it with her data (e.g., for the past month) and reuploads the CSV to Euclid.
Yi sees feedback that the template was successfully uploaded.
Yi learns she can add new sales or traffic widgets to her existing dashboard, or add a pre-configured dashboard relevant to her new data.
She also has the opportunity to see this sales data on the compare stores page and is able to download it in the custom reports. See FIGS. 38-39.

A user of embodiments of the platform described herein has the ability to customize their dashboard. They click the edit button, and then can choose to add and remove widgets.

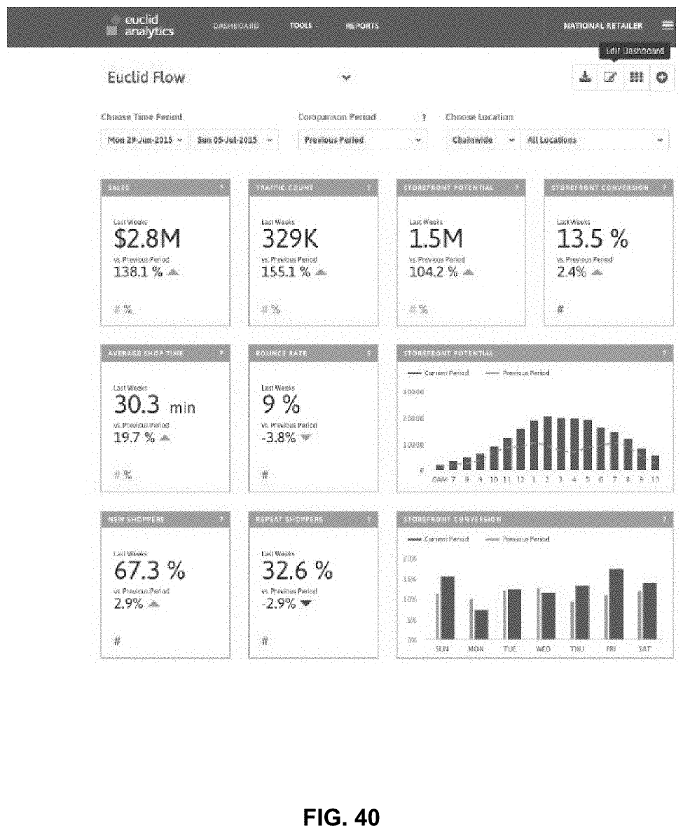

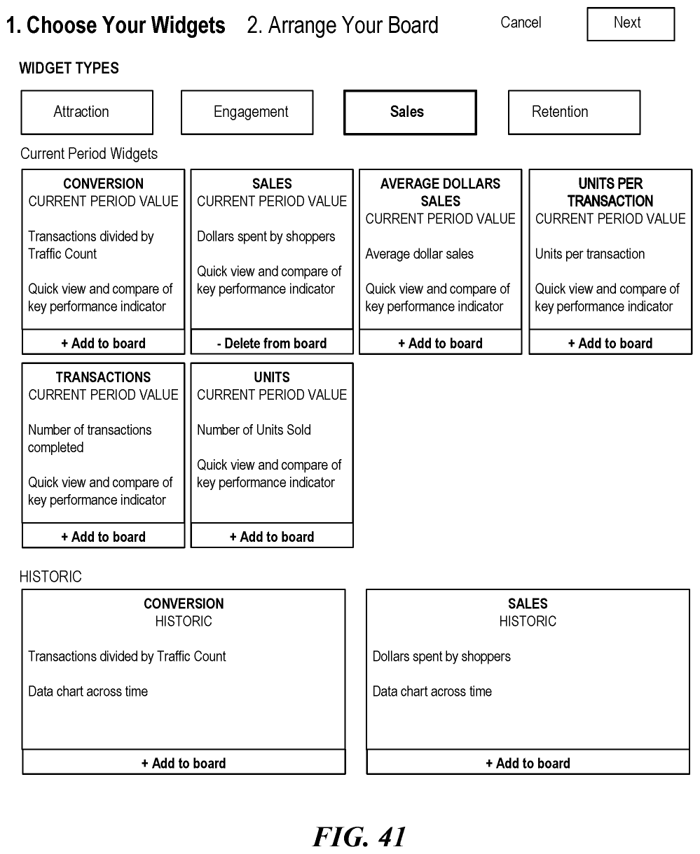

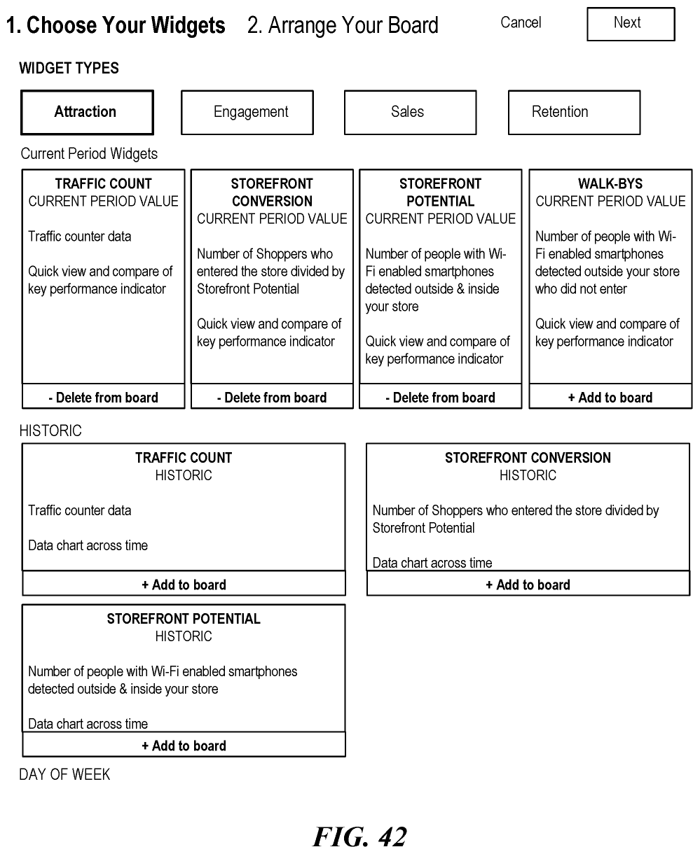

Once customer data (traffic count/sales data) has been uploaded by the customer and then ingested into databases associated with platform 170, the traffic count and sales widgets are made available to them (i.e. they are able to add them dashboard) See FIGS. 40-42.

Example Data Upload

Referring to FIGS. 43 and 44, which depict example embodiments of a platform such as platform 170:

1. Wireless Access Points in a client's environment passively receive wireless connection requests from mobile devices within range of the Access Points. The data is then provided to a platform such as platform 170, as described above, or the systems shown in FIGS. 43 and 44 (which provide alternate views or embodiments of platform 170). Data sent to platform 170 includes but is not limited to a timestamp, mac address of the access point, the mac address of the device, and signal strength.

2. Data Ingestion—The data is sent to a parser (e.g., parser included in an ingestor such as ingestors 206-210, as described above) that is specific to the client and to the hardware manufacturer {Cisco, Meraki, Xirrus, etc}. In some embodiments, the parser is configured to de-identify a mobile device's MAC address and normalize this data in accordance with a canonical format, as described above.

3. Normalized, de-identified data is stored in S3.

4. Example Analysis

From the normalized data, nightly jobs are performed that calculate various KPIs such as:
i. avg shop time:=on average how much time a device spends in a location)
   1. Duration:=For every device we calculate an “outer” duration—i.e. the last timestamp seen (as VI) minus first timestamp seen (also as VI). These are aggregated over hours and days to give us the duration metric for every span-zone-date combination
ii. store front potential:=Number of people with Wi-Fi enabled smartphones detected outside & inside your store
iii. bounce rate:=Percent of people with Wi-Fi enabled smartphones who spent less than X min (default 5 min) in your store
iv. store front conversion:=Number of Shoppers who entered the store divided by Storefront Potential
v. new shoppers:=Percentage of shoppers who have never been detected by Euclid's sensor at your location
vi. repeat shoppers:=Number of Repeat Shoppers divided by number of Total Shoppers

5. In some embodiments, results of the analysis are stored in RedShift (e.g., Redshift store 236 of platform 170), and summaries to be accessed via API or the Web are stored in MySQL (the API db)

6. Clients can supply data such as Sales/Location Data (e.g., sales and door counter data) via mechanisms such as ftp or email. Door Counter Data can also be supplied via ftp or email. Suggestions can be provided for formats for the data which is transferred via sftp or email, (e.g., CSV, XLS, etc.). As various types of data is consumed (e.g., POS, sales, and door counter data), disparate data formats are supported, and custom parsers can be written to ingest the data.

7. Data is First Ingested into MySQL (e.g., using ingestors 206-210 of FIG. 2)

8. Then into RedShift (e.g., using Redshift store 236 of FIG. 2)

9. Then into an API DATABASE

10. These time series (e.g. total sales per day vs time or traffic count (from door counters)) are then displayed in the dashboard widget

11. Once customer data (traffic count/sales data) has been uploaded by the customer and then ingested into databases, the traffic count and sales widgets are made available to the users of the services of a platform such as platform 170 (i.e. they are able to add them dashboard).

The following are four example ways of ingesting POS, door counter, payroll hour, and beacon data, usable in a variety of embodiments:

1. Load via FTP: An FTP server is used to make accounts for each client (of a platform such as platform 170) that wishes to upload via FTP. The platform clients send their RSA key to gain access to their user-restricted subdirectory where they can place files. A cronjob on the platform checks for new files hourly and copies them into the S3 bucket for customer/client uploads. A subsequent cronjob on a different server is used to check that S3 bucket for new files. It then looks each new file and checks the file path and name against regular expression patterns to determine if there is a load query for that file from that customer, and if so it runs the load query to insert or update the data into our MySQL database.

2. Load via email: An email account is provided by a platform such as platform 170 and the platforms shown in FIGS. 43 and 44. A script is run that scans any unread emails for attachments and downloads them onto S3 for customer uploads. This script also supports decrypting data for clients who want to send encrypted emails. Data from the emails is loaded from S3 to MySQL by the same script as mentioned in the FTP section.

3. REST APIs: Where supported (e.g., Square, Vend, and Lightspeed), API integrations with POS vendors are supported. Cronjobs are executed that pull from their REST API for all clients for which the platform has tokens, JSON responses are manipulated into CSVs, and loaded into MySQL. In some embodiments, obtaining of data via REST APIs is run on a cron schedule.

4. Dashboard: Clients can upload their metrics via a dashboard interface. For example, an Excel template can be provided for download. Customer representatives can then can paste their data in in a pre-specified format and upload that file. If the file uploaded is formatted validly, then the file will be immediately uploaded to MySQL, and instantly available for view in the dashboard.

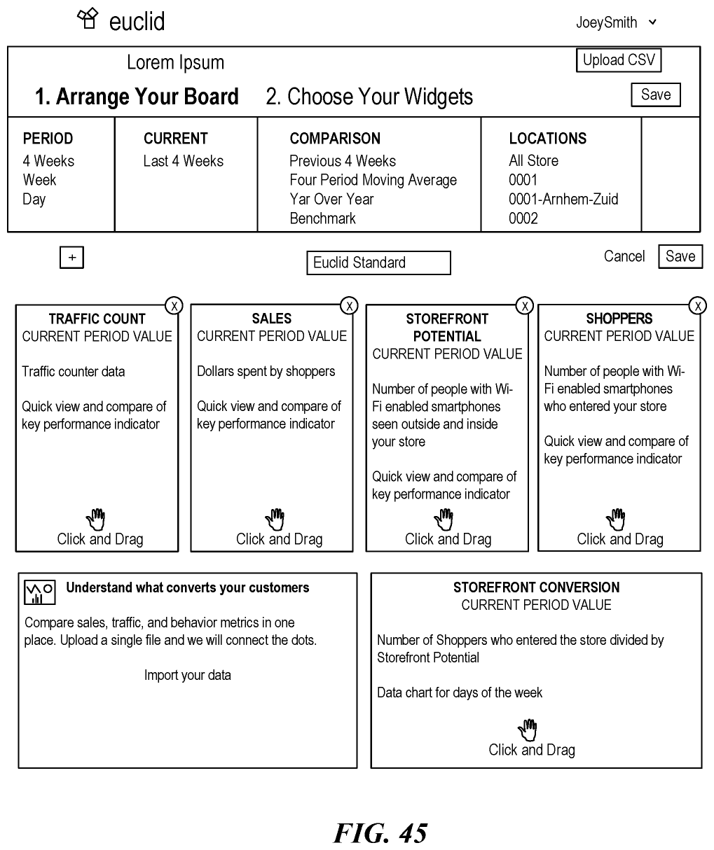

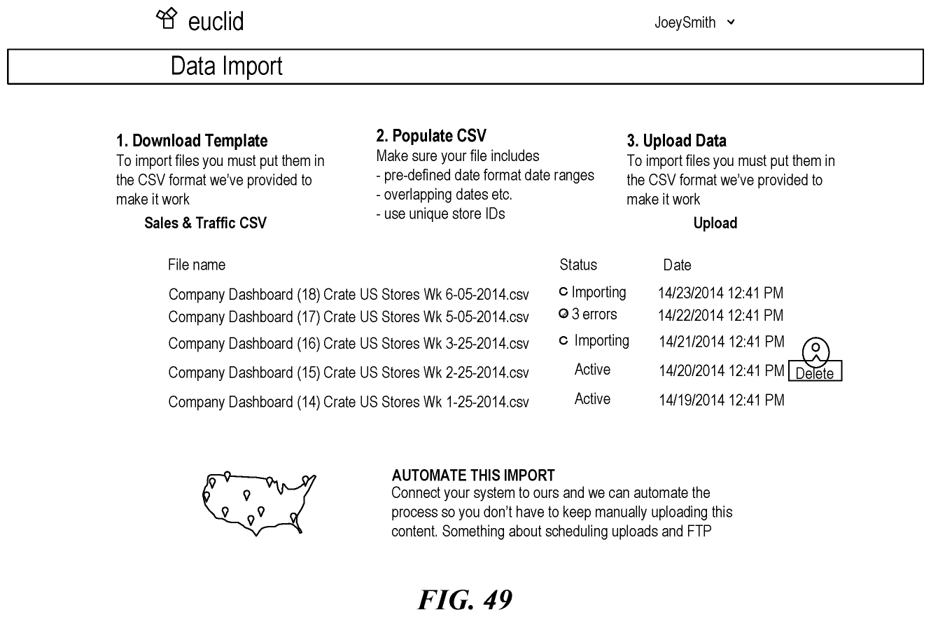

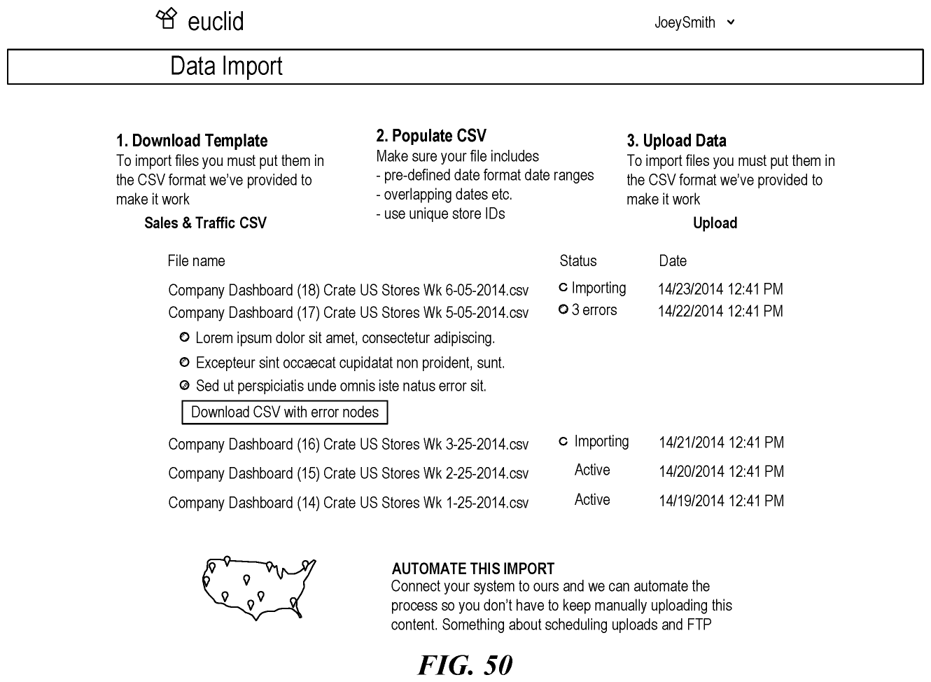

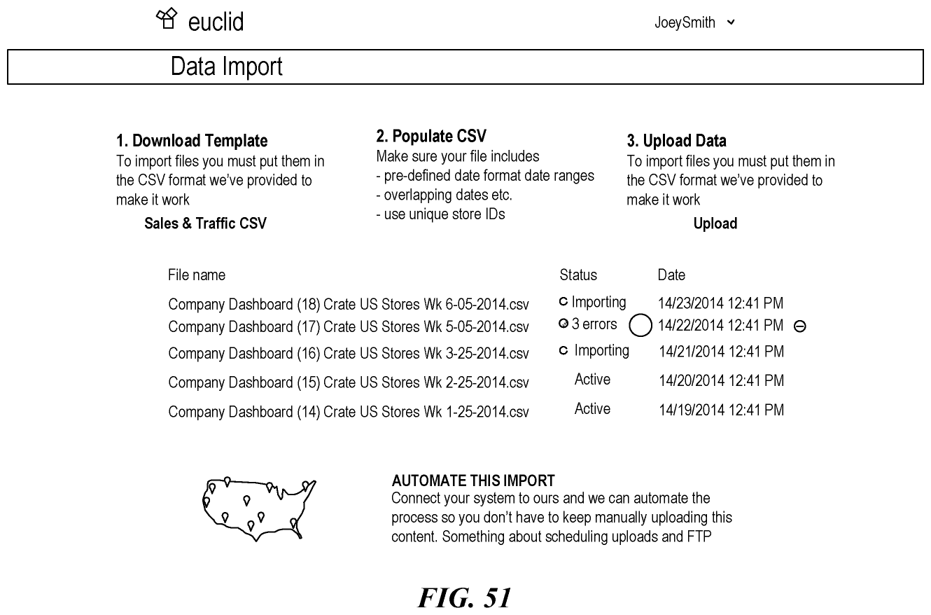

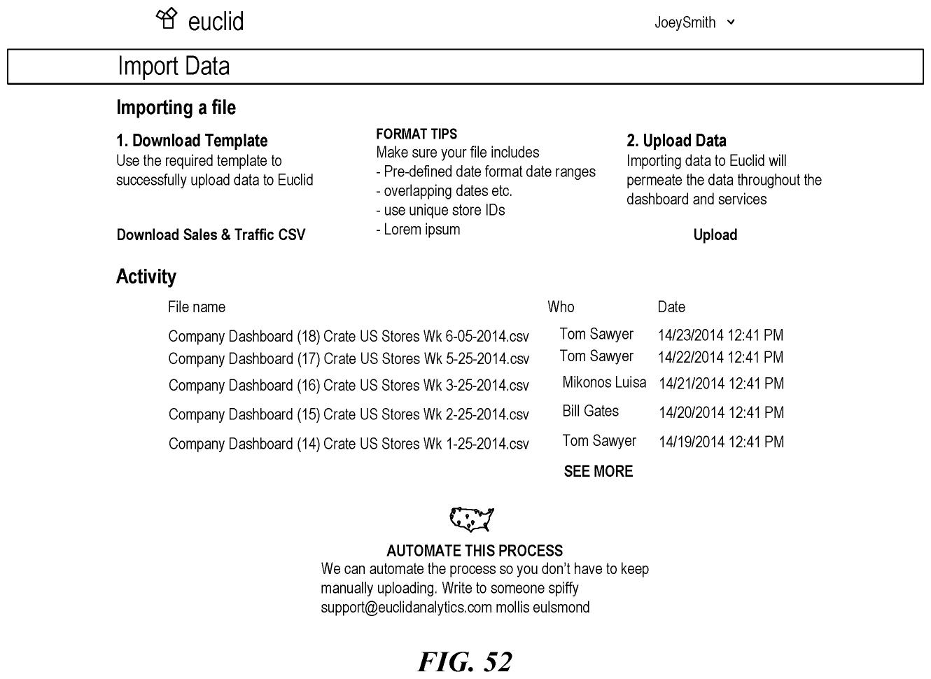

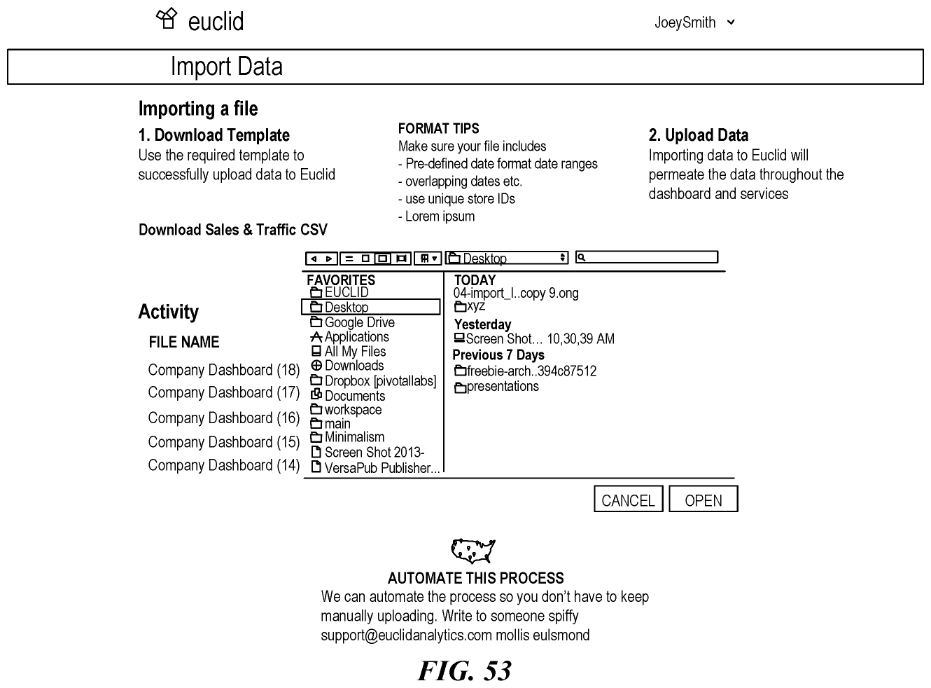

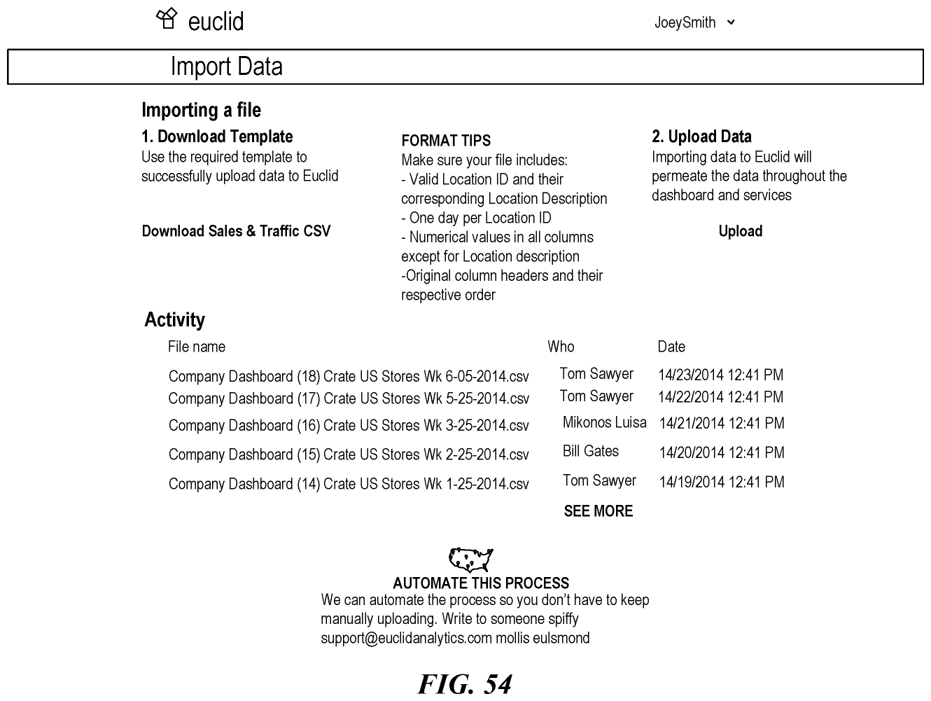

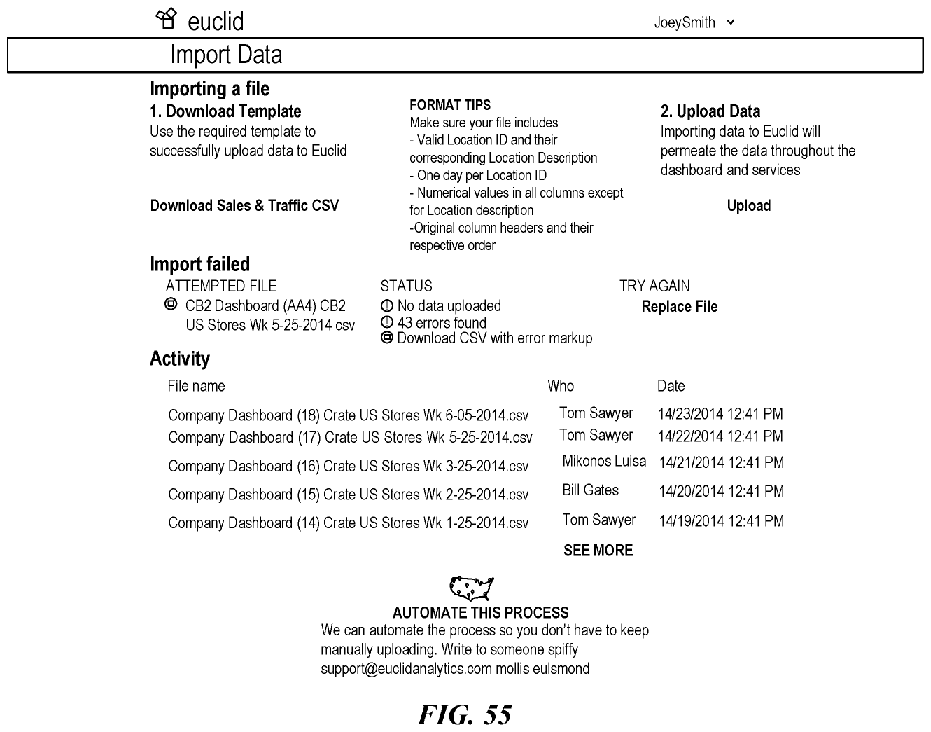

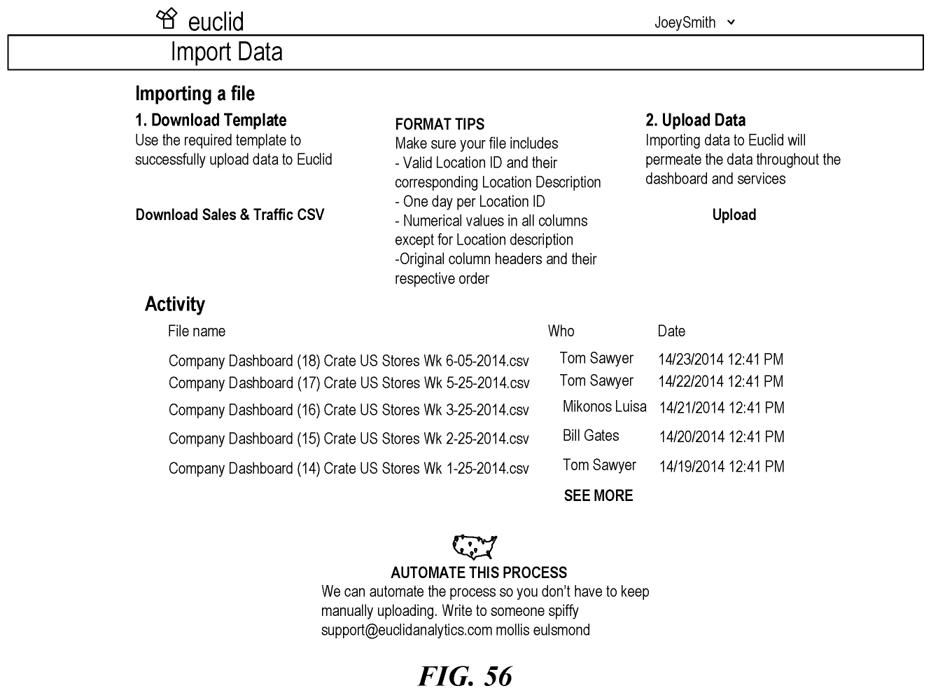

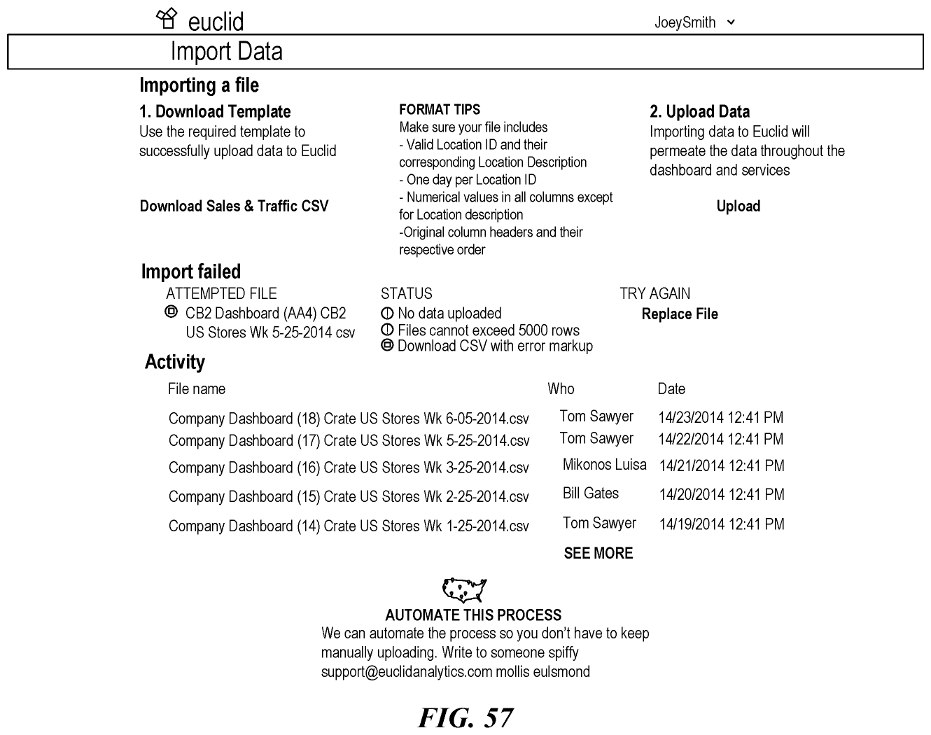

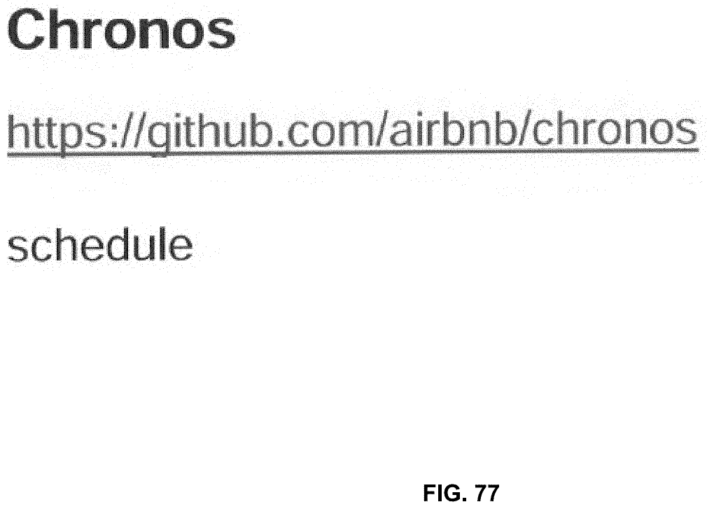

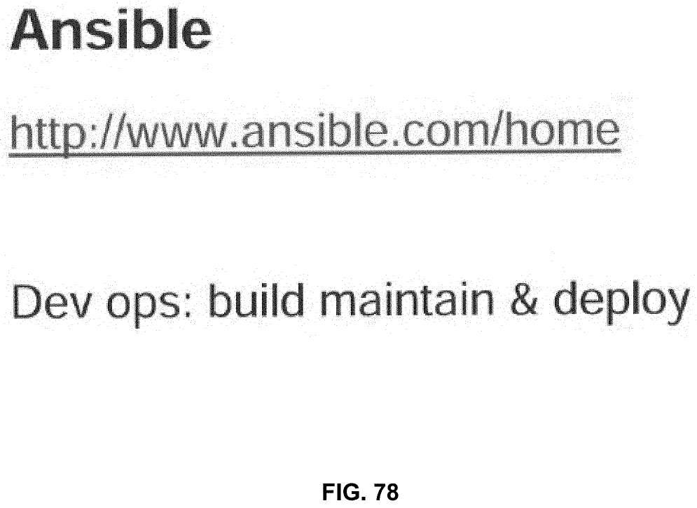

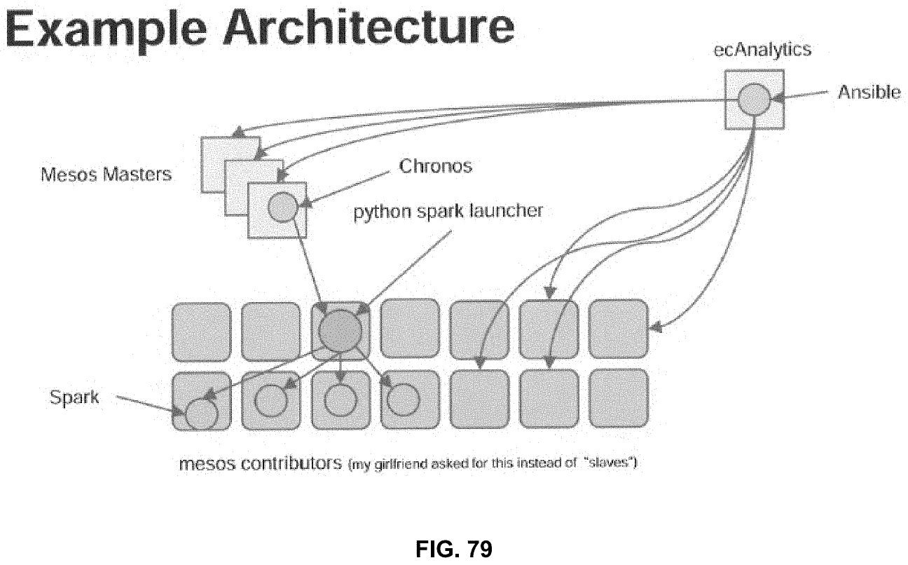

Additional information and embodiments are provided in FIGS. 45-83. Additional information regarding aspects of embodiments of platforms usable in conjunction with techniques described herein are described above, for example, in conjunction with platform 170.

FIG. 45 illustrates an example embodiment of an interface for arranging a dashboard.

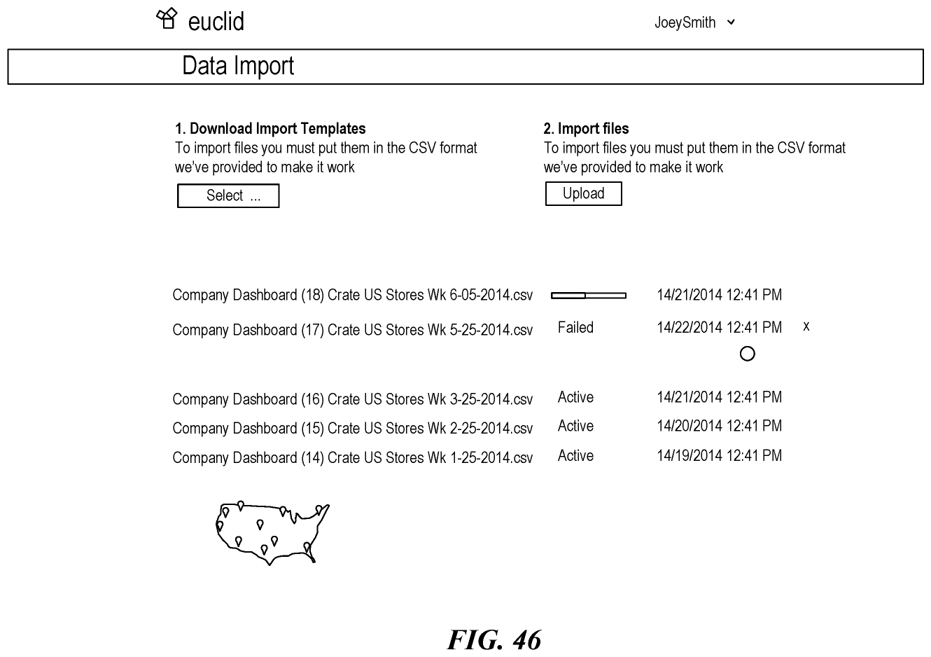

FIG. 46 illustrates an example embodiment of an interface for importing data.

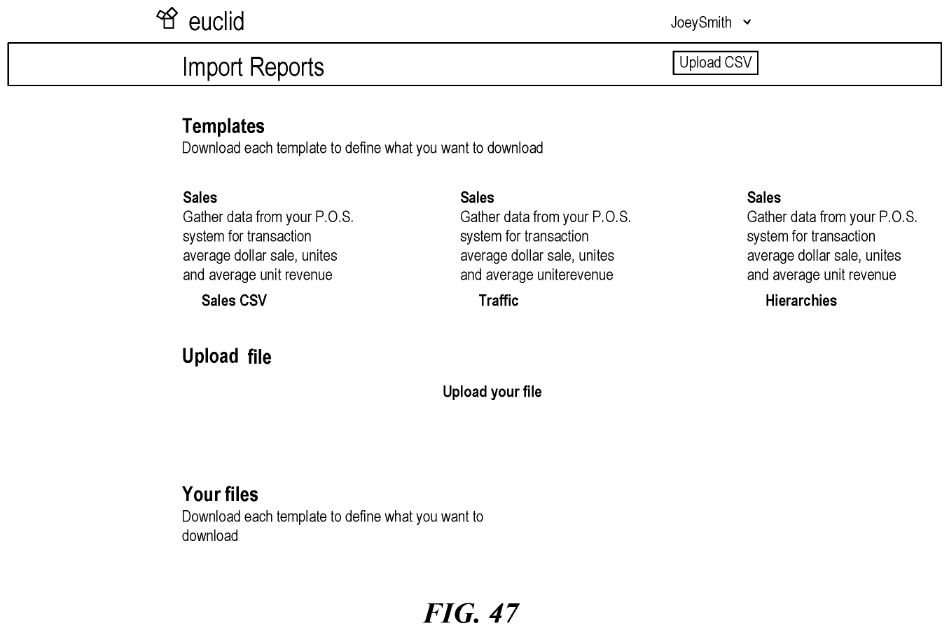

FIG. 47 illustrates an example embodiment of an interface for importing reports.

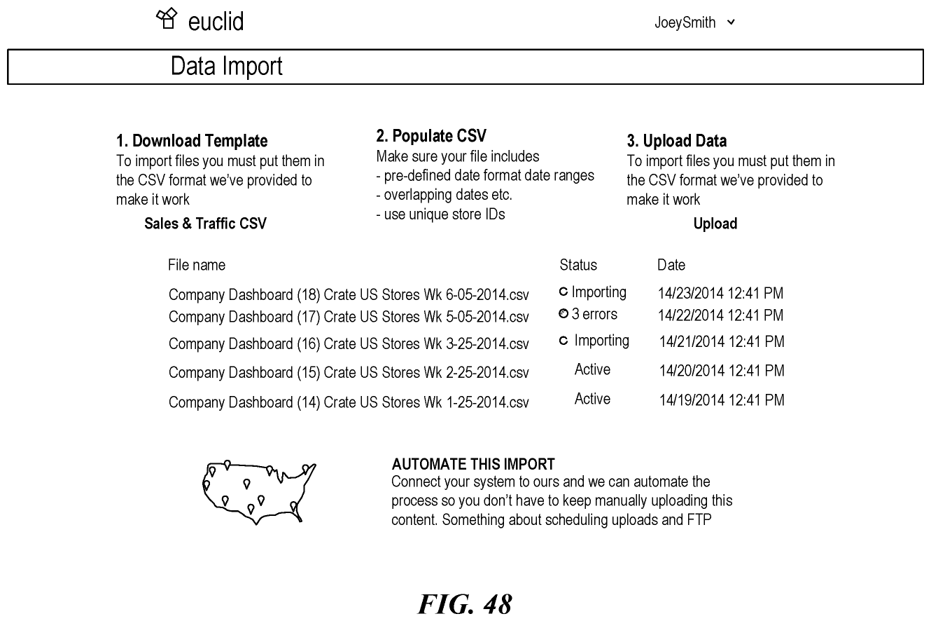

FIGS. 48-57 illustrates example embodiments of interfaces for importing data.

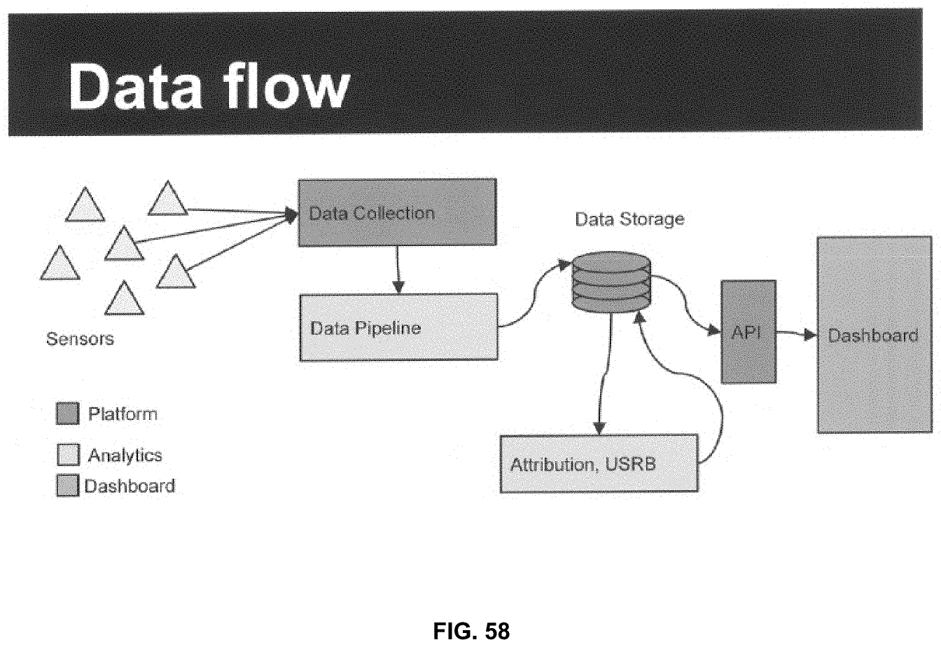

FIG. 58 illustrates an example embodiment of a data flow. Shown in this example is the collection of data from sensors. The collected data is then sent to a data pipeline. The output of the data pipeline is sent to a data storage. The data stored in the data storage can be used in a variety of manners, such as for attribution or for display in a dashboard (e.g., via an API).

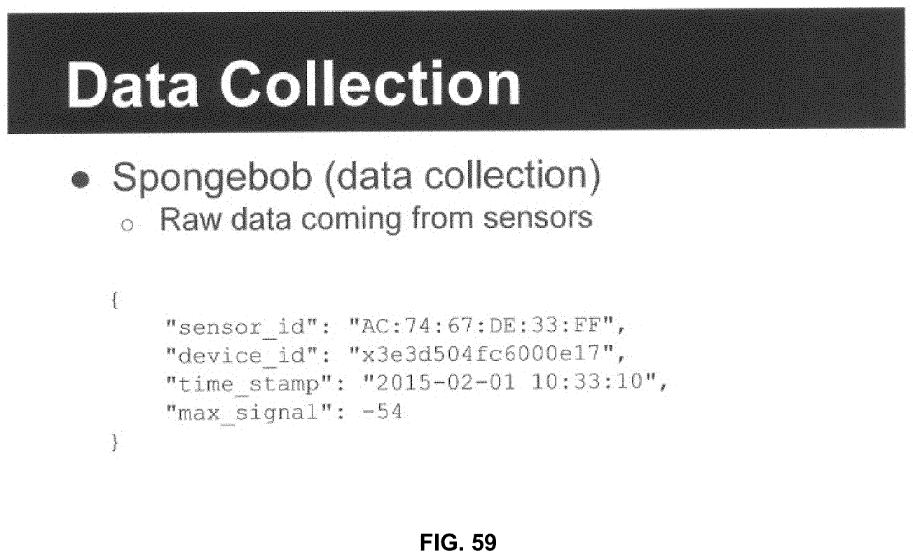

FIG. 59 depicts an example embodiment of raw data collected from sensors.

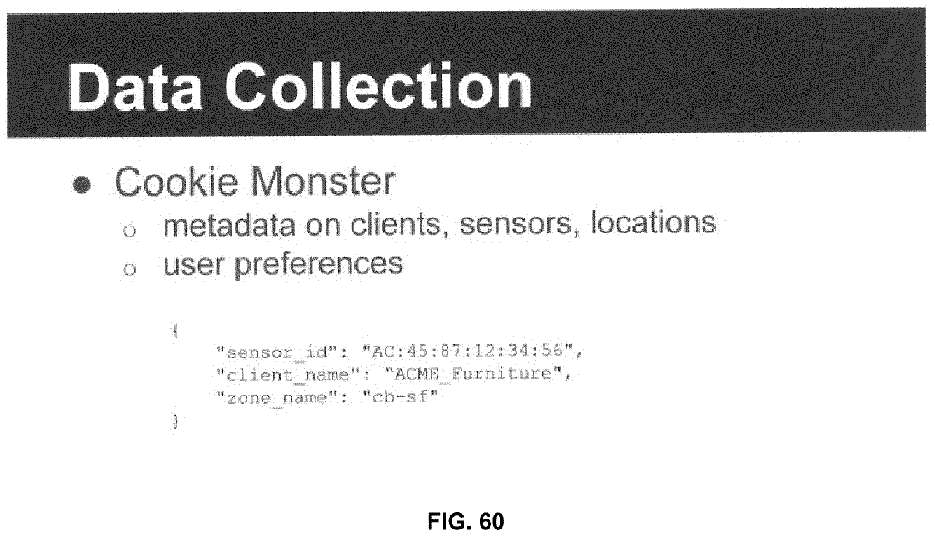

FIG. 60 illustrates an example embodiment of collected data including metadata on clients, sensors, locations, as well as user preferences.

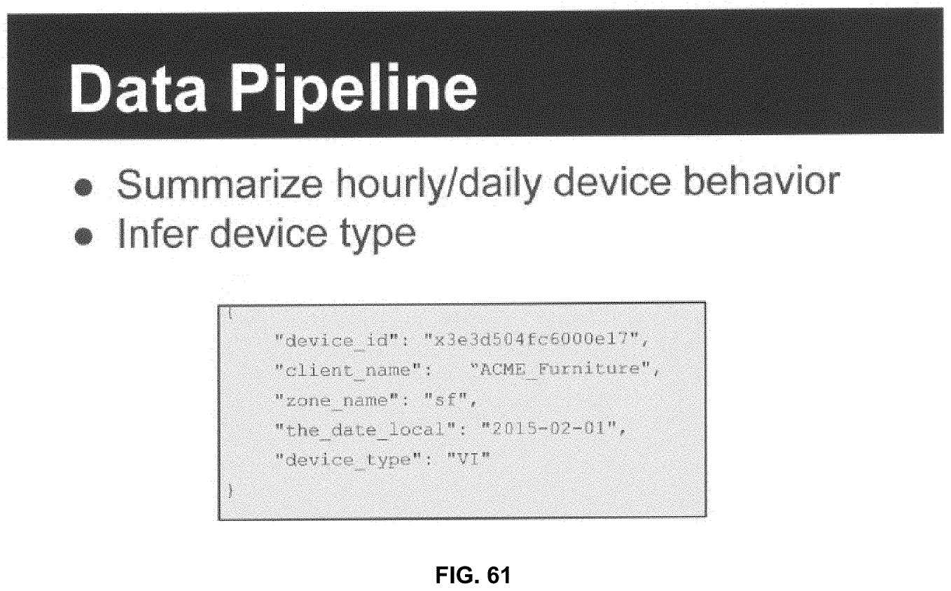

FIG. 61 illustrates an example embodiment of summary data produced by a data pipeline. Shown in this example is a summary of hourly/daily device behavior, as well as inference of device type.

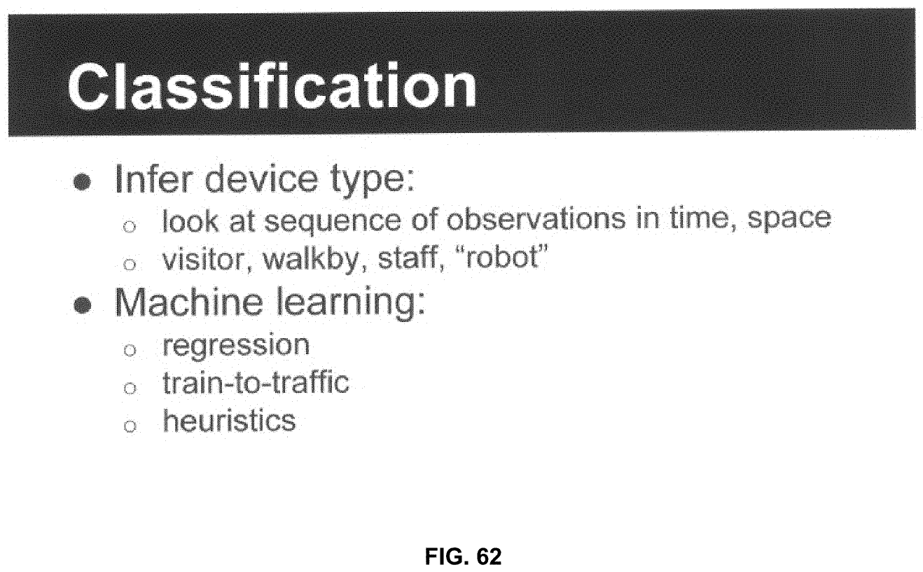

FIG. 62 illustrates an example embodiment of classification. As shown in this example, inference of device type as well as machine learning can be performed.

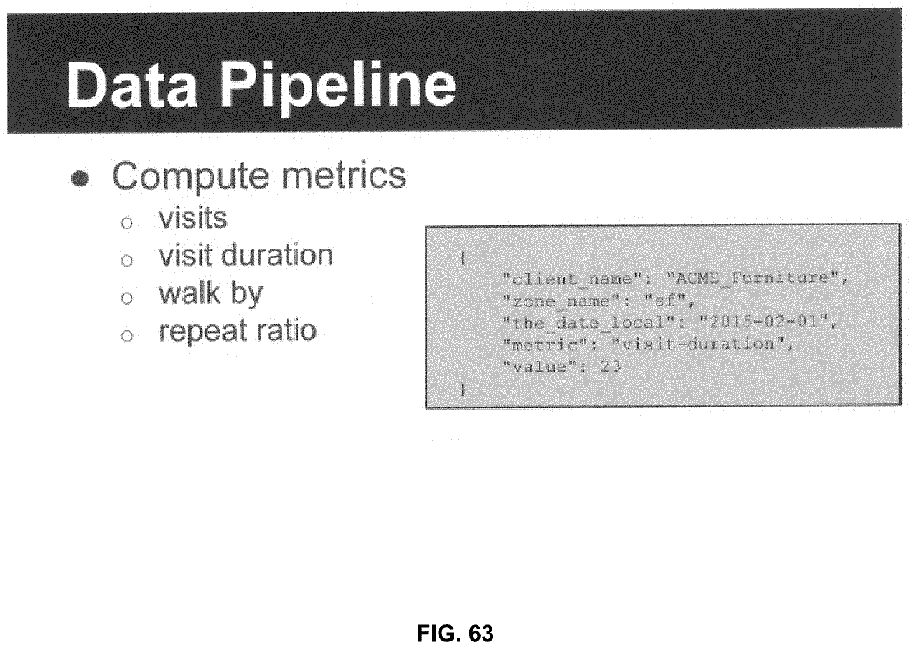

FIG. 63 illustrates an example embodiment of computing metrics using a data pipeline.

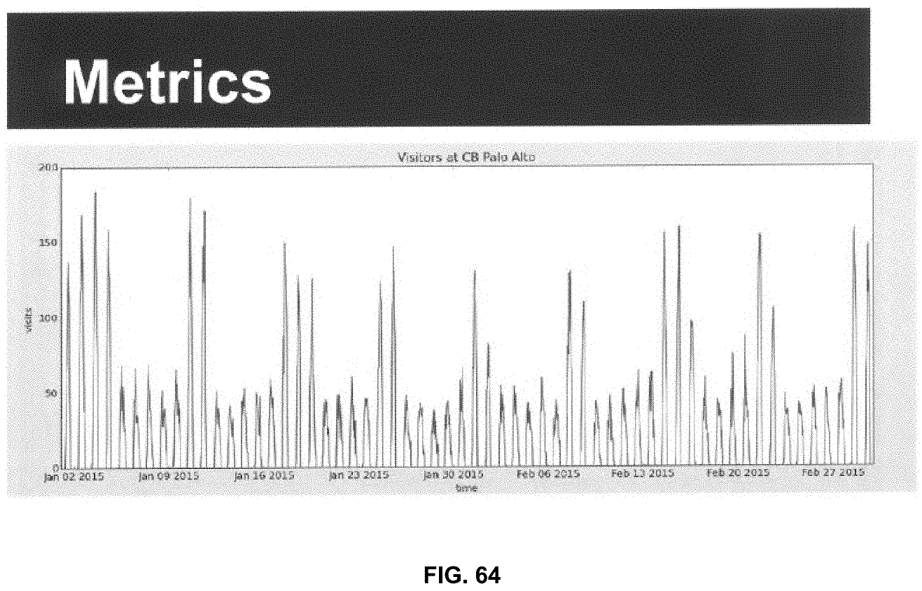

FIG. 64 illustrates an example embodiment of a plot of metrics.

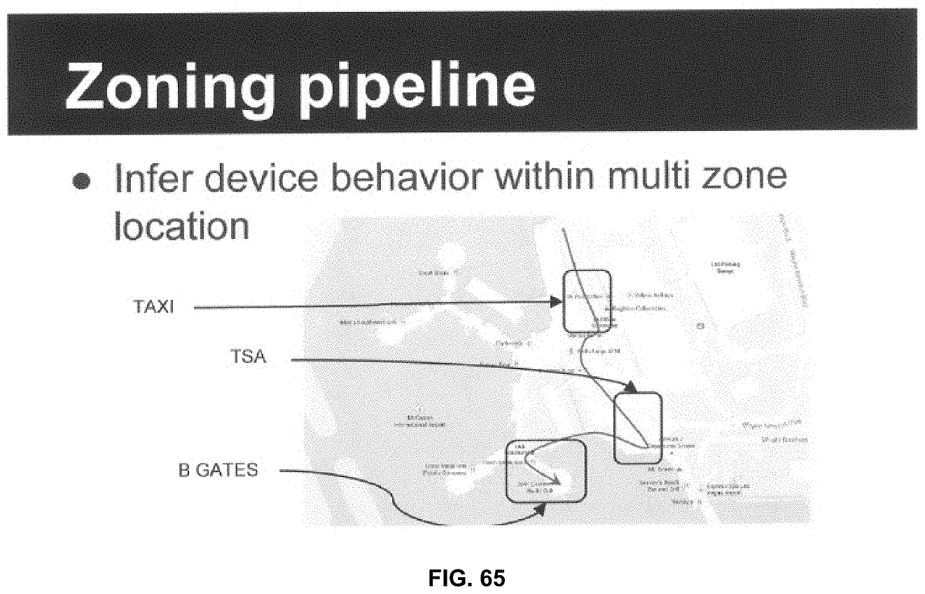

FIG. 65 illustrates an example embodiment of inferring device behavior within multi-zone locations using a zoning pipeline.

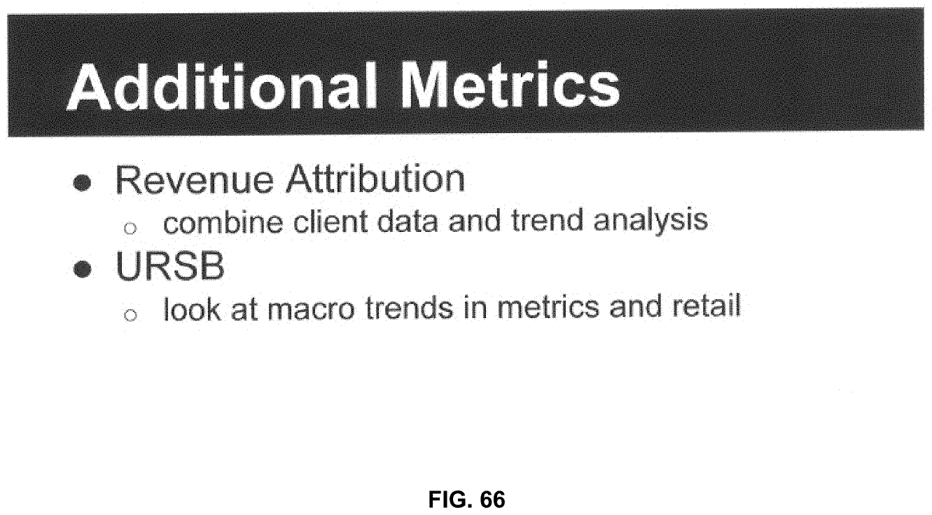

FIG. 66 illustrates an example embodiment of additional metrics including revenue attribution and United States Retail Benchmark (URSB), which provides aggregated traffic metrics across the network facilitated by platform 170.

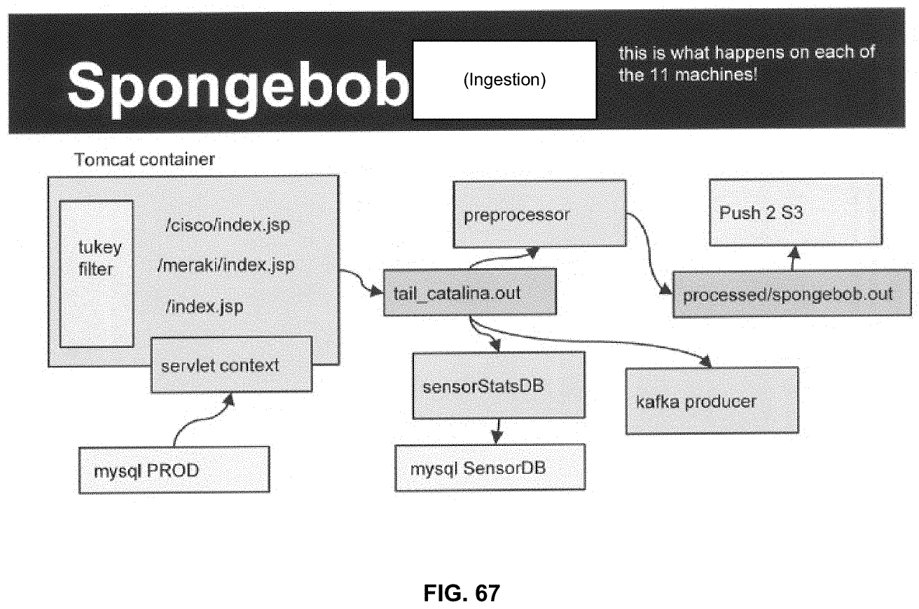

FIG. 67 illustrates an example embodiment a system for data ingestion. In some embodiments, the data ingestion system of FIG. 67 is used to implement ingestors 206-210.

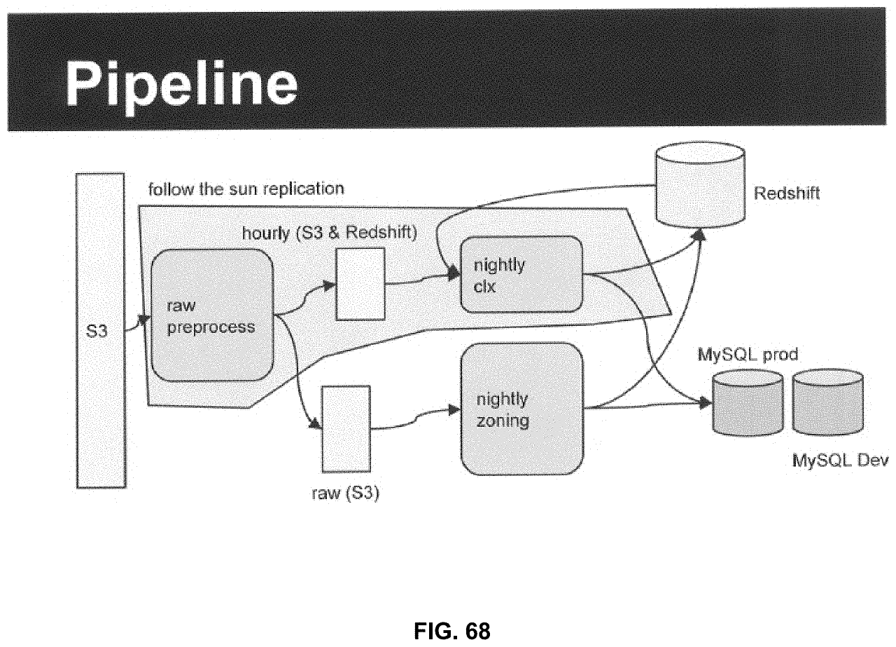

FIG. 68 illustrates an example embodiment of a pipeline.

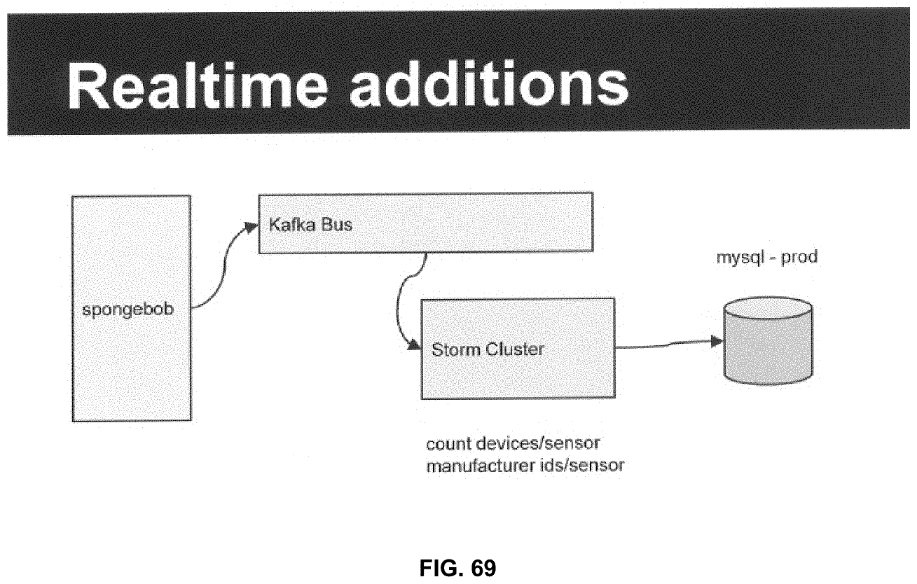

FIG. 69 illustrates an example embodiment of realtime additions.

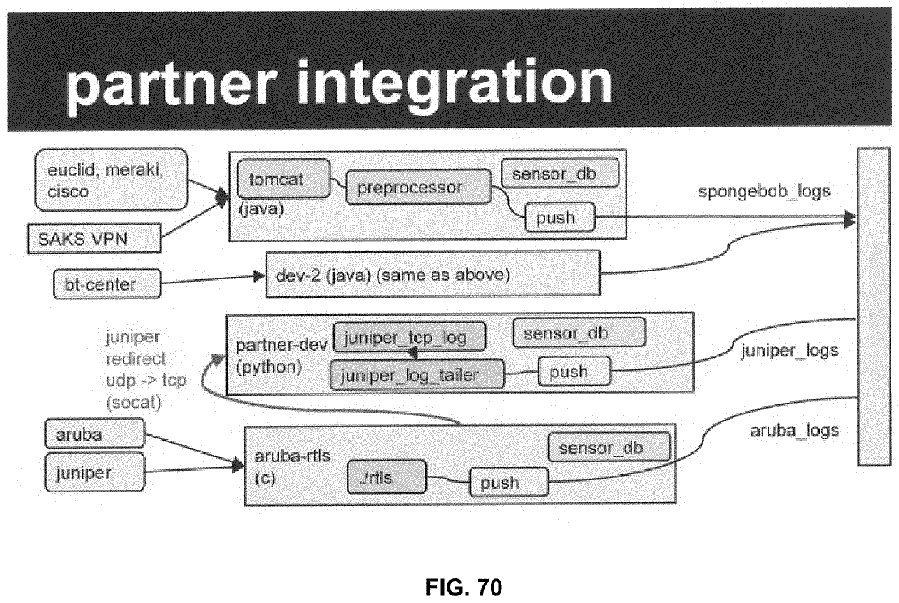

FIG. 70 illustrates an example embodiment of partner integration.

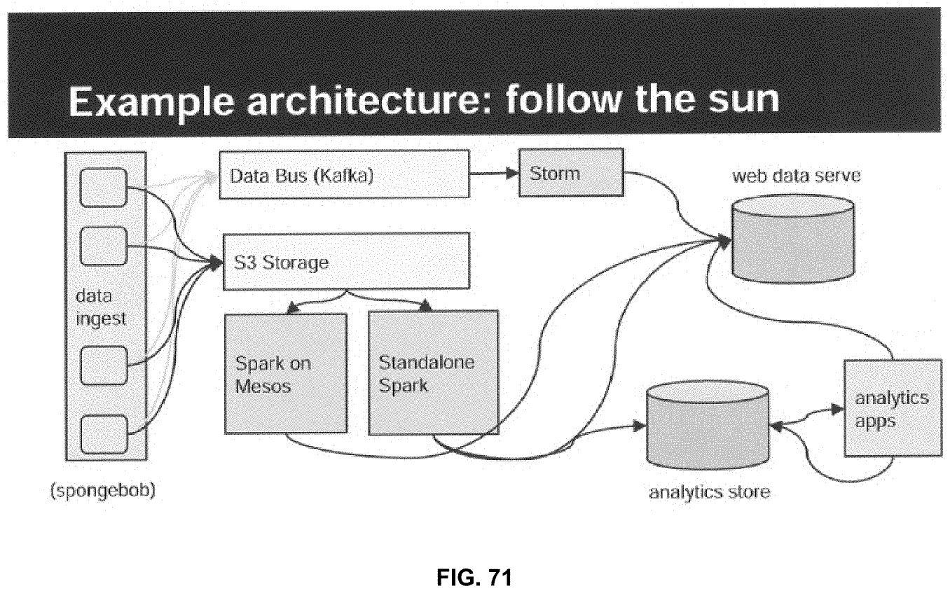

FIG. 71 illustrates an example embodiment of a follow the sun architecture.

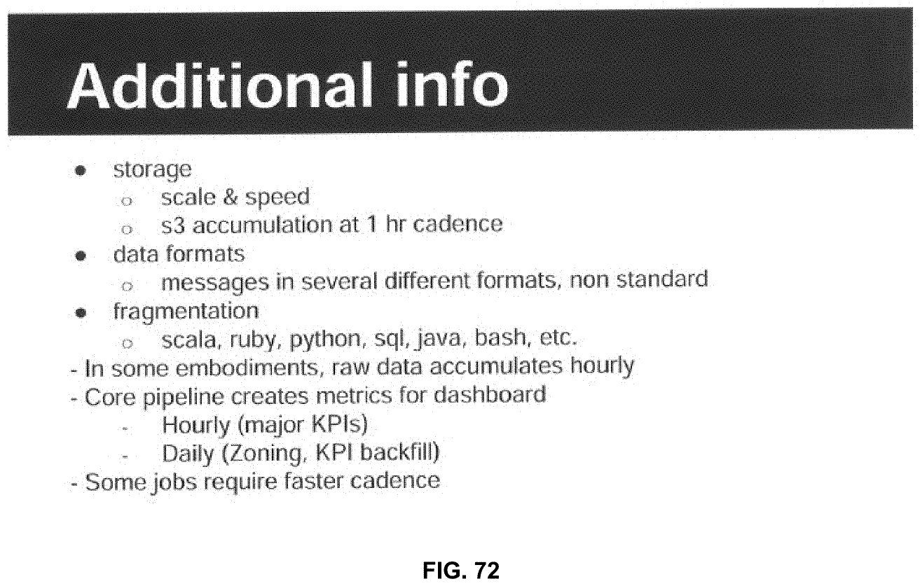

FIG. 72 depicts additional information. The additional information includes information relating to storage, data formats, fragmentation, accumulation of raw data, core pipelines, and cadence.

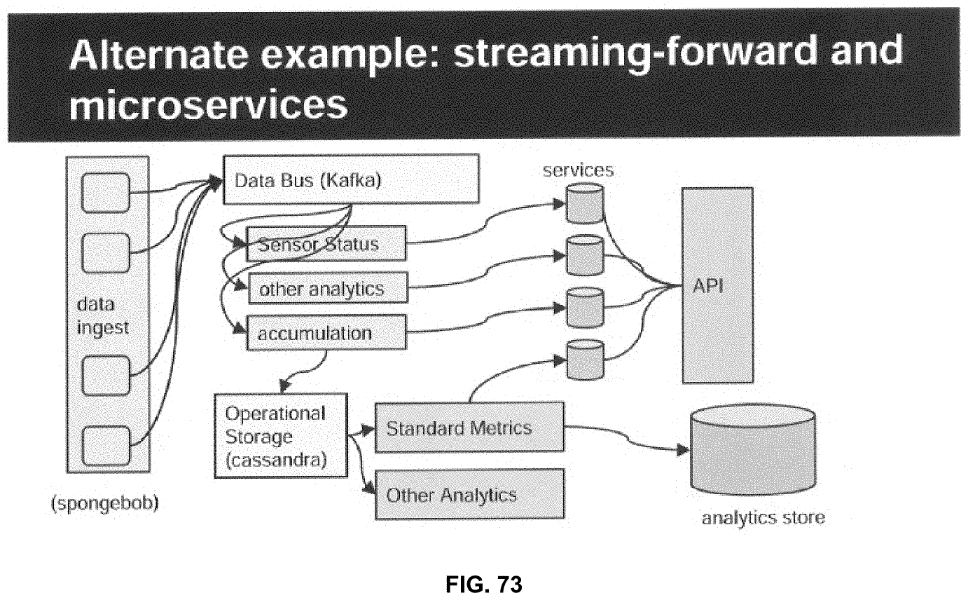

FIG. 73 illustrates an example embodiment of streaming-forward and microservices.

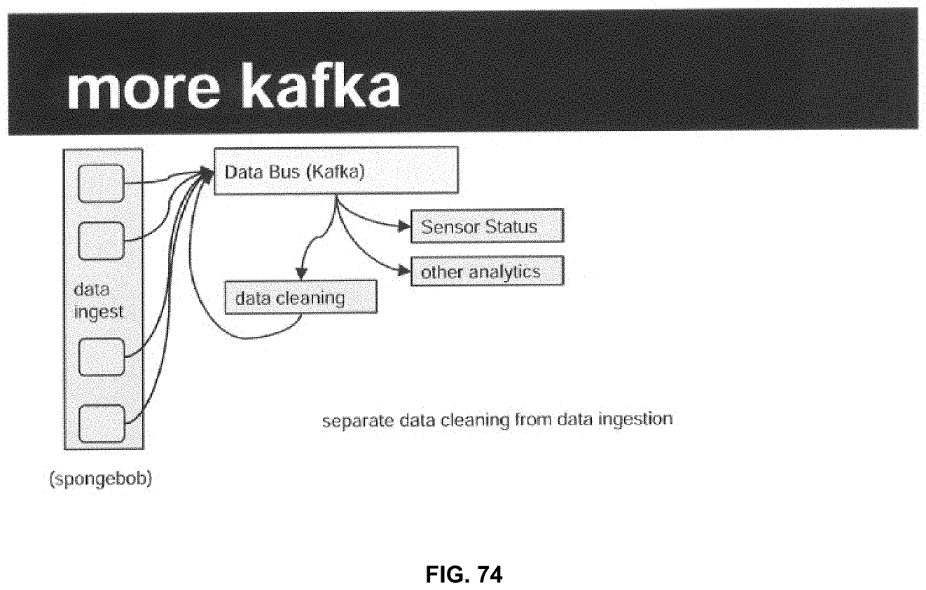

FIG. 74 illustrates an example embodiment of Kafka usage.

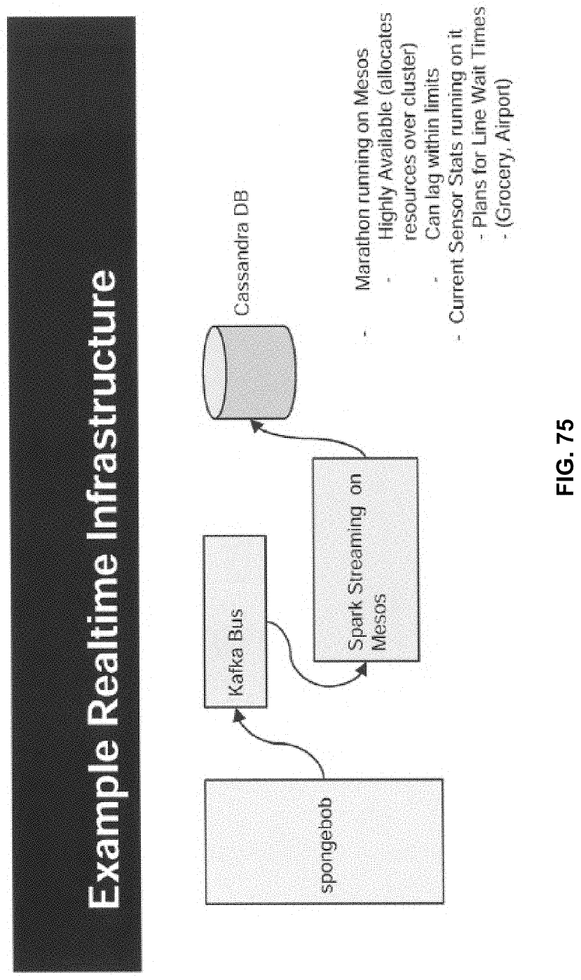

FIG. 75 illustrates an example embodiment of a realtime infrastructure.

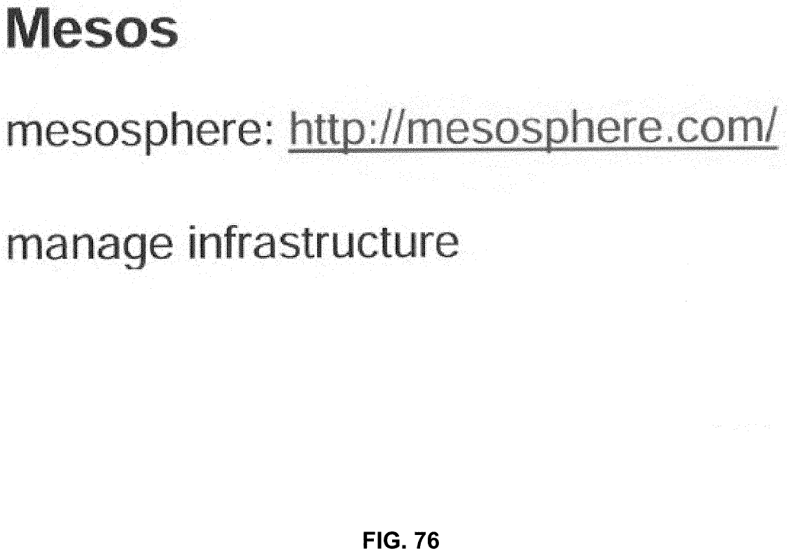

FIGS. 76-79 illustrate components of an example architecture.

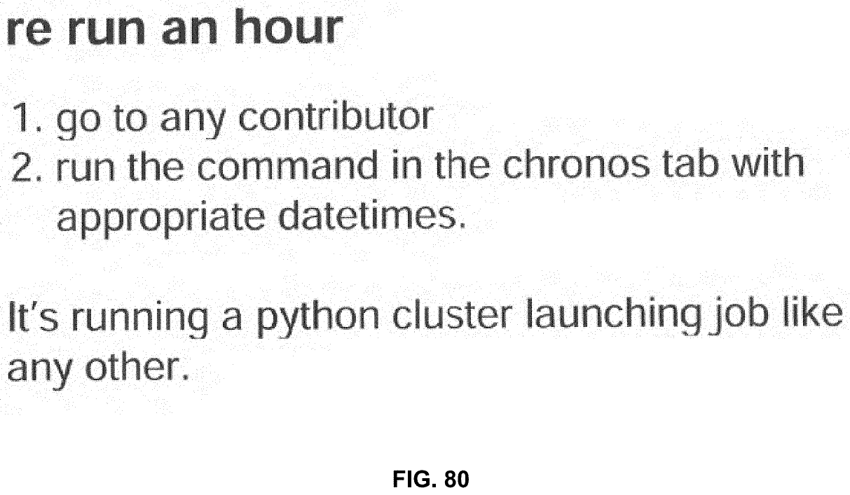

FIG. 80 depicts a process for re running a process.

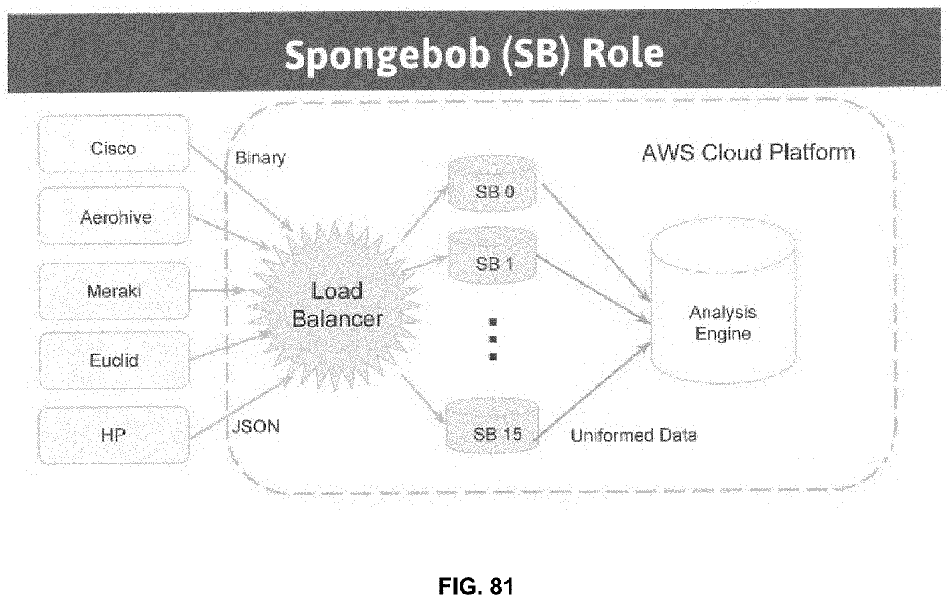

FIG. 81 illustrates an example embodiment of a system for data ingestion.

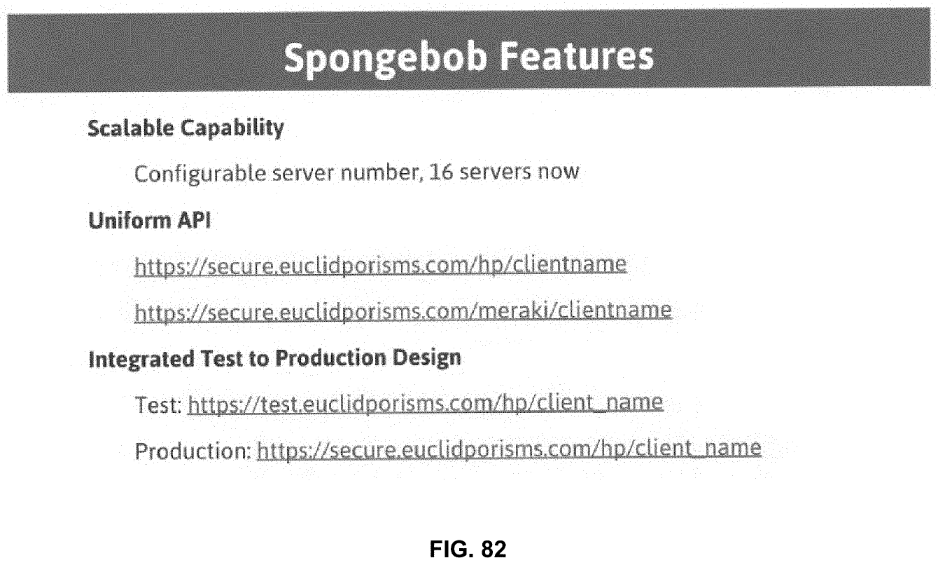

FIG. 82 depicts example features of data ingestion.

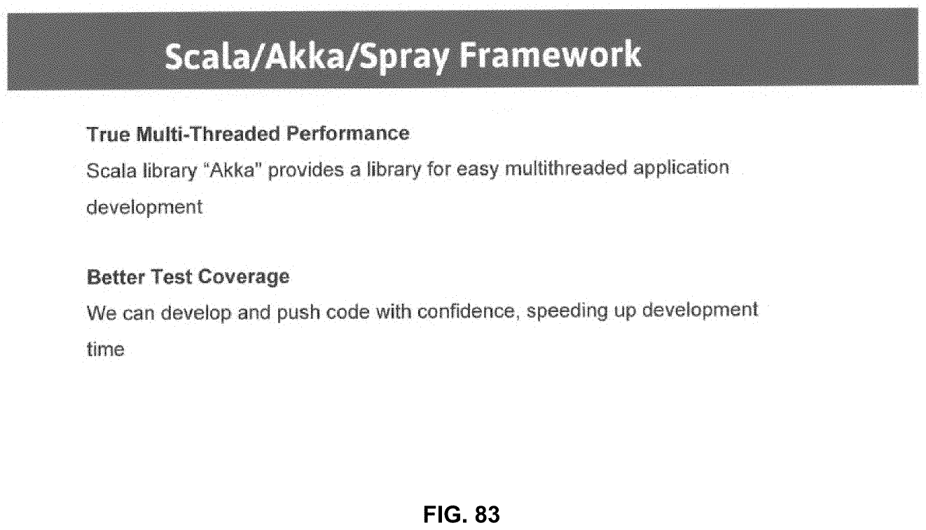

FIG. 83 depicts an example embodiment of a Scala/Akka/Spray framework.

### Mining Data and Segmenting Visit Frequency

With an automated store trainer, an in and out classifier can be trained for zones (as described above). The in and out classifier is configured to classify whether a device is inside or outside of a zone. In some embodiments, to make the training require as little supervision as possible, extra compute cycles and redundancy are built in. For example, training 5 weeks of data may require approximately ¾ to 1 day per zone. This time can be shortened, but accuracy may suffer, as applicable.

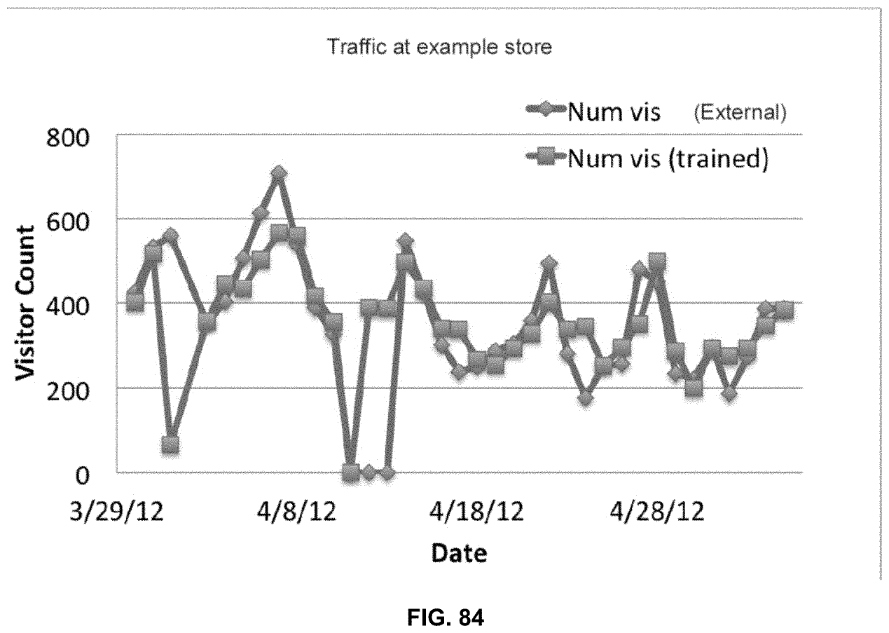

FIG. 84 illustrates an example embodiment of a trained in and out filter for an example store. In this example, the filter was trained in the window from April 16th to April 30th.

### 1 Adding Dwell to Sales Analysis

One question that can be addressed using the techniques described herein is whether or not a measurement of dwell (e.g., duration, or time spent in a space) will add color to a store's sales data. Across several zones, the addition of dwell information can be used to improve the ability to predict sales data, as compared to using traffic counts alone. One way this can be seen is via a metric called “number of visitor minutes.” This metric is the product of the day's visitor count and the median visit duration, and represents the number of useful minutes (or opportunities for sale) a zone had on a given day.

A comparison with external traffic counts can also be made (e.g., external to a platform such as platform 170).

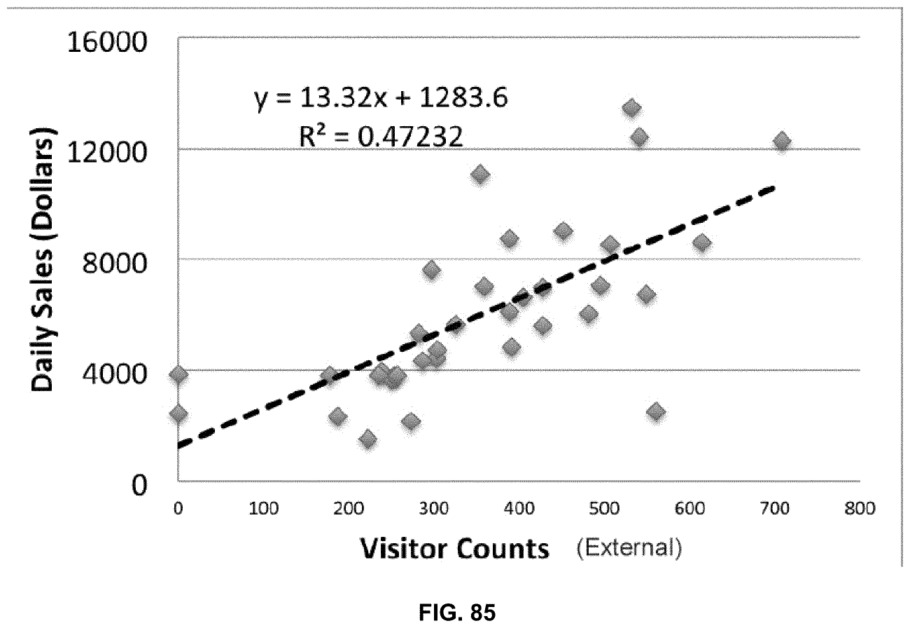

FIG. 85 illustrates an example embodiment of: correlations with sales revenue for external traffic counts (e.g., provided by a customer utilizing the services of platform 170)

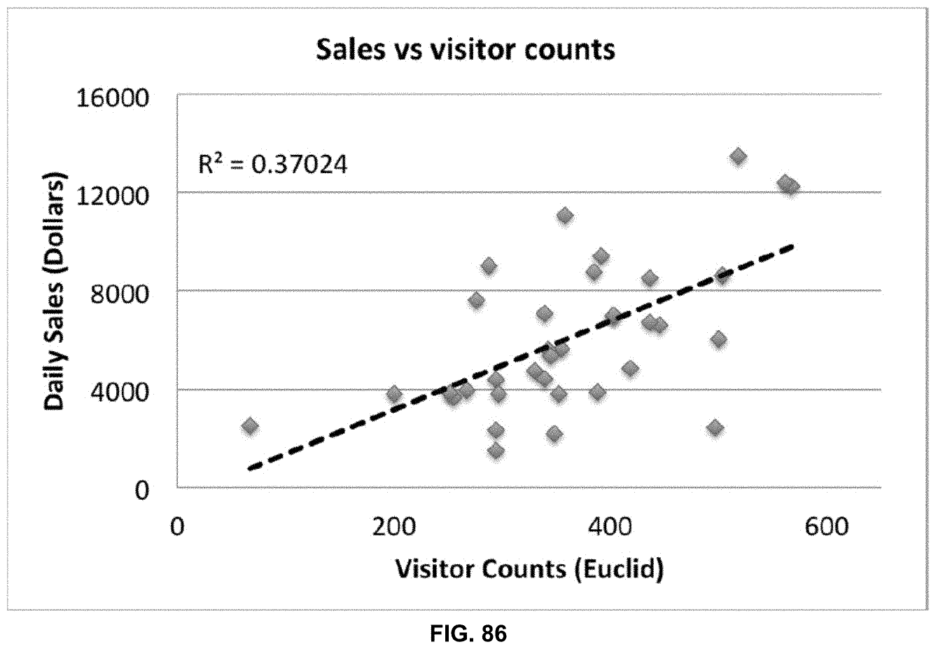

FIG. 86 illustrates an example embodiment of correlations with sales revenue for traffic counts made by a platform such as platform 170

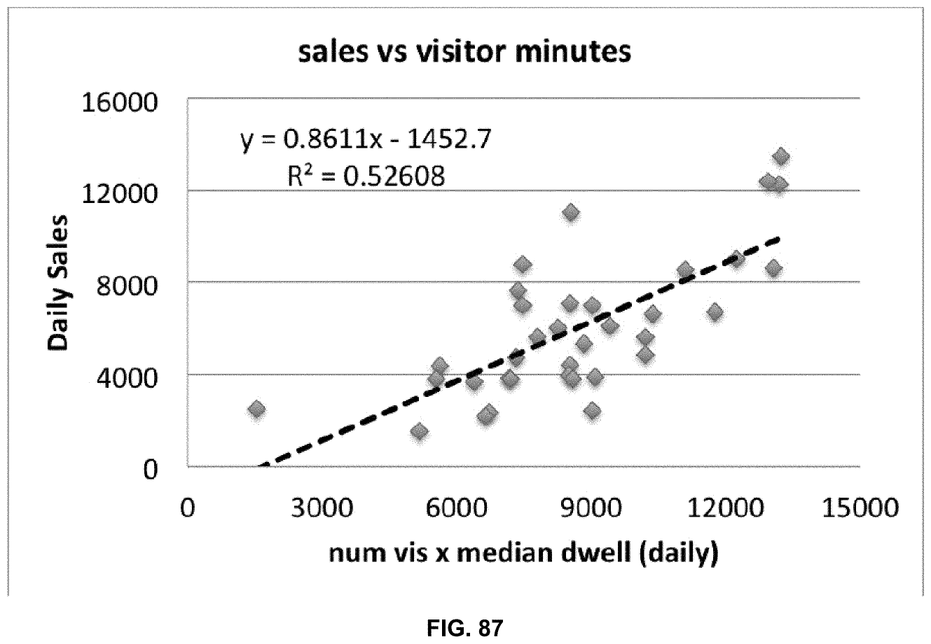

FIG. 87 illustrates an example embodiment of correlations with sales revenue for the composite metric, “number of visitor minutes.” In this example, the R²=0.525 is an improvement over external count current benchmark.

### 2 Visit Recency with Updating

In various embodiments, the population's repeat visit rate can be extracted and how that rate changes with time tracked. Seasonal trends can be determined from this data, which has a good signal to noise ratio. It is possible that absolute numbers associated with recency can be inflated by the assumption of a fixed visit rate, i.e. a person's visit rate does not change with time or with each visit. This may be problematic because when customers stop coming to the store, they can potentially be interpreted as a loyal customer with an extremely long inter-visit period.

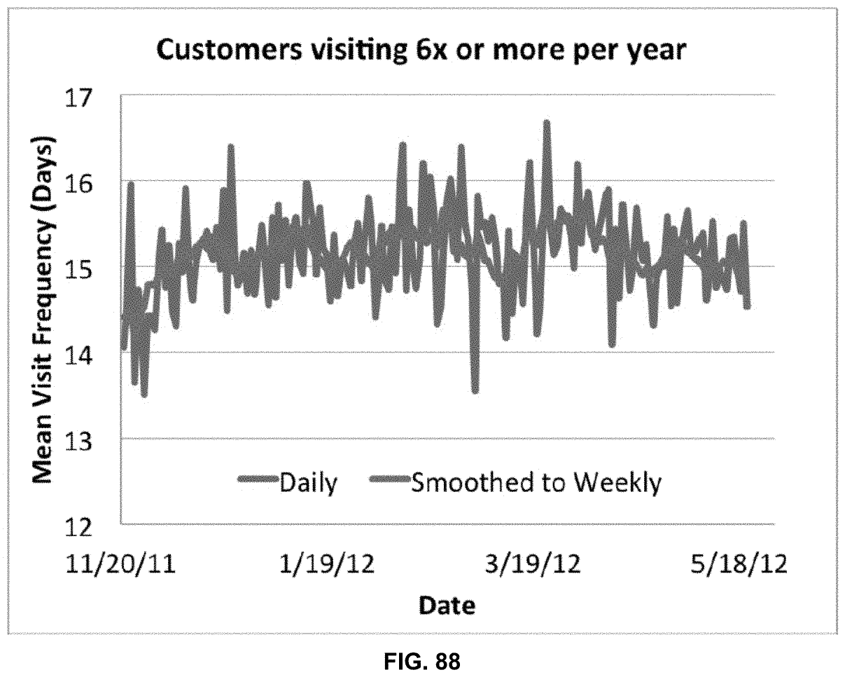

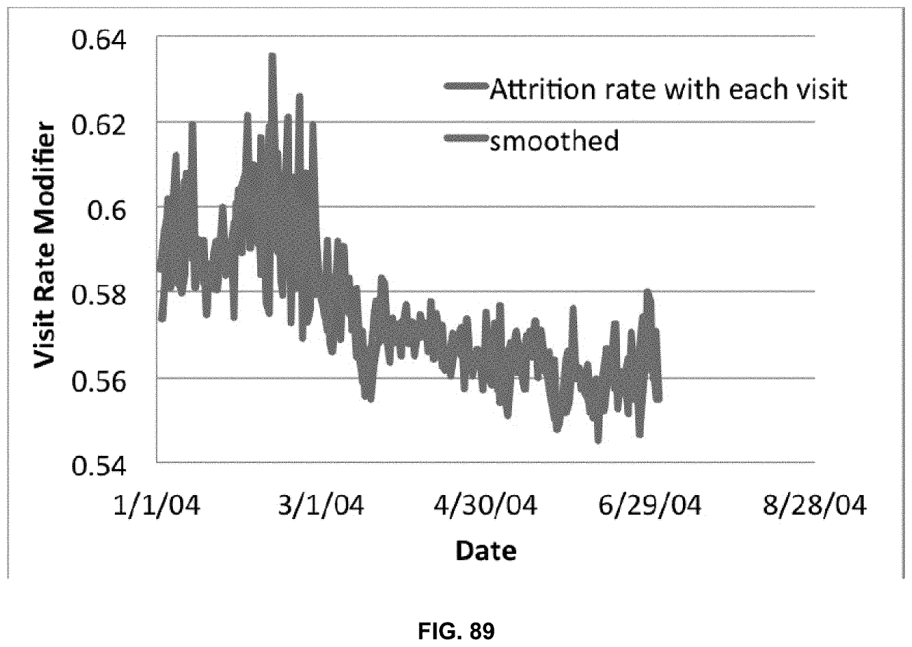

In some embodiments, a frequency updater is added to the model (an example model is provided in W. W. Moe and P. S. Fader, Journal of Interactive Marketing 18, 5 (2004), ISSN 1520-6653, URL). The frequency updater is a parameter which accounts for visitor variability with experience and time. In some embodiments, the repeat rate of each visitor is multiplied by a number chosen from a gamma distribution (2 free parameters):

$$\begin{matrix}{λ}_{j + 1} = {c}_{i , j} * {λ}_{j} & ( 1 ) \\ h ( {c}_{i , j} , s , β ) = \frac{{c}_{i , j}^{s - 1} β {e}^{- β {c}_{i , j}}}{Γ ( s )} & ( 2 )\end{matrix}$$

Where c_{i,j} is the multiplier that updates visit rate upon each repeat visit and h is the gamma distribution that is selected c from for the i^{th} customer. The aggregate model includes four free parameters, two to decide the initial repeat visit rate for each member of the population, and two to describe how that visit rate changes after each visit. By choosing the parameters with the highest likelihood, the attrition rate of repeat customers can be estimated. Results for an example 6 month scan of ACME Store data can be seen in FIG. 88 and FIG. 89.

FIG. 88 illustrates an example of a mean update value for visit recency. Numbers less than one indicate a repeat customer is less likely to return with each visit.

FIG. 89 illustrates an example of a mean update value for visit recency. Numbers less than one indicate a repeat customer is less likely to return with each visit.

Mining Census Data

In some embodiments, a platform such as platform 170 can be used to perform geo fencing of a region of arbitrary size and calculation of likelihoods for key demographic dimensions (e.g., age, gender, and income) of devices visiting stores. The accuracy and reach of this analysis is dependent on sensor networks and the ability to find accurate demographic information on a client's population. Numbers for devices with known age and income are beginning to saturate, whereas number of females is still well below 1% and the number of males is 0. With the addition of stores to networks, additional knowledge can be obtained of known device counts over time. Alternative sources of demographic information can be used to enhance the state of demographic knowledge.

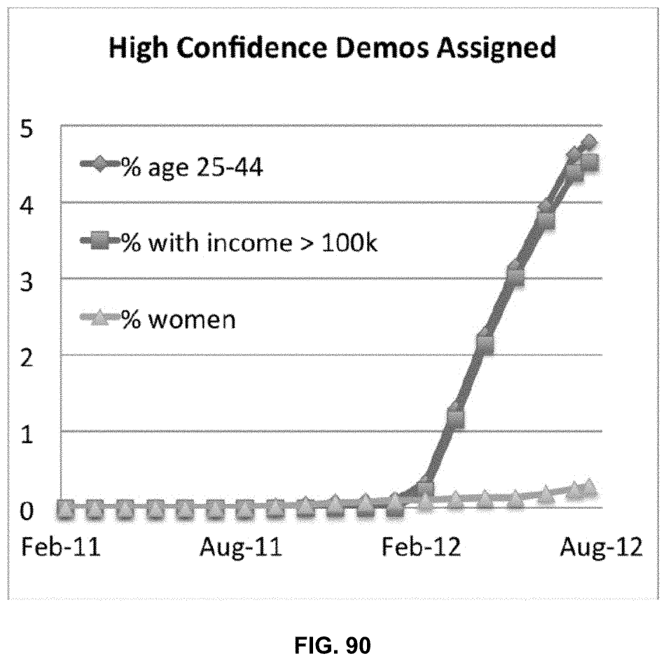

FIG. 90 illustrates an example graph showing growth of known devices along age, gender, and income dimensions as a percentage of total devices that visited stores in the Bay Area. Here, stores in the Bay Area, for which there is demographic information are shown.

In some embodiments, demographic information can be obtained from the most recent US census data, which contains detailed information on gender and age distributions based on place of residence. The walk-by record of the previously geo-fenced region can be mined and assign demographic information based on the time weighted average of locations where an individual is observed. In the above example, prior to running queries, 2010 census data were obtained for every zip code in California. Furthermore, each zone in the Bay Area with known latitude and longitude was assigned to its home zip code. This allows for the determination of what zones a device frequently walks-by. Age and gender information can then be attributed to this record. More weight can be e given to data collected within certain time periods. For example, in order to determine where a person lives (rather than where they vacation or work), more weight can be given to data collected after the 8 pm and before 8 am. Significant demographic knowledge for a large number of devices can be obtained by scraping such census records

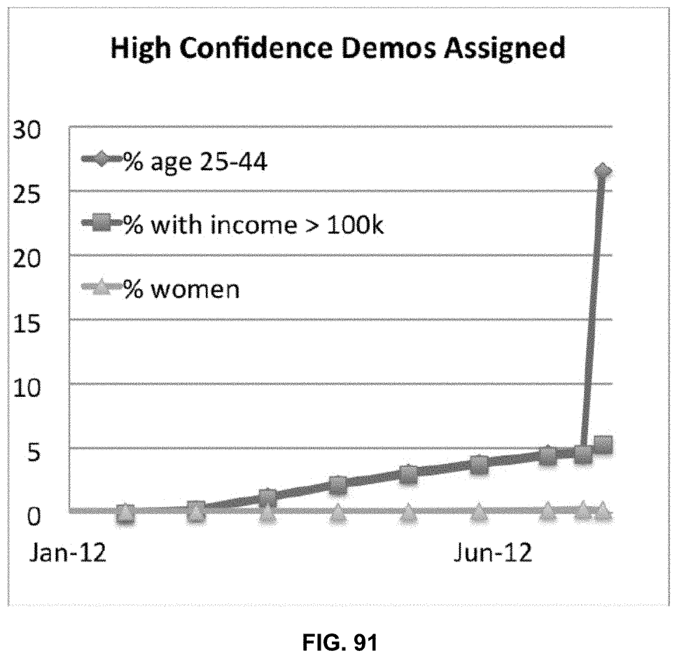

The next step is to apply the demographic information gleaned from the census to existing numbers. In some embodiments, both contributions are equally weighted, though need not be. By using both sets of information, different aspects of a person's behavior can be gleaned. The visit history reflects a person's choice of stores for item purchases, the walk-by record combined with census data reflects where a person spends their weekday evenings. These slices of behavior are independent enough to be considered useful. The results of merging the two data sets can be seen in FIG. 91—T2.

FIG. 91 illustrates an example of a graph showing growth of known devices along age, gender, and income dimensions when including US census data along with a device's store visit record.

Additional Details Regarding Metrics

Bounce Rate

“Bounce rate” can be a challenging metric. One, the quantity itself can be variably defined. What constitutes a bounced customer can mean very different things for different kinds of store (e.g., ACME Store vs. Beta Store). The waters are further muddied by a second issue. To the extent that there is a similarity in conception of bounce rate between spans it has so far been closely tied to a shortened duration of visit. Thus, an action is taken which can be difficult to describe and processing is potentially limited processing to devices with very little signal. An alternate way to consider a bounce rate is as failing to enter a second chamber within a store, the chamber of the engaged customer.

Broadly speaking, not only are the customers which enter the store of interest, but also which fraction of those customers make the transition from simple visitors to engaged visitors. In some embodiments, a bounced customer is one who walked in the doors, but leaves before making a meaningful connection with the store. One way is to categorize such behavior based on time of visit, and ignore other relevant pieces of information. This can be challenging because as stated above, what it means to form a meaningful connection with the store varies from client to client. Even if moving past the idea of a one size fits all duration for bounce, other key pieces of evidence may potentially be overlooked. Rather than thinking of the problem as a way to measure bounce rate, bounce rate can instead be considered as a way to count engaged visitors. This will lead to more robust strategies for measurement, and the same information can still be obtained because the number of bounced visitors is simply the difference between engaged and total visitors.

There are multiple triggers which can be used to signal the transition from simple visitor to an engaged potential customer; examples of which are provided here:
1. Actively browsing the inventory
2. Interacting with a staff member
3. Connecting to the store's wi-fi
4. The individual stops walking and stands still
5. Duration of visit is longer than previous visits

One or multiple key pieces of evidence can be associated with each transition event. Measuring if a device connects to the store's wi-fi can be performed. A spike in a device's measured bandwidth potentially signals that a user is accessing the internet to compare prices or read online reviews, as has been done by 66% of smartphone users (e.g., the device's connection to the store's Wi-Fi can be inferred from an increase in the device's measured bandwidth). The device's current visit can be compared to previous visits in the device's record. This provides a context to measure if the short duration time is significant or not. The variance in measured signal strength can increase by as much as a factor of 2 when a person is walking vs standing still.

With respect to interacting with a staff member: “Staff devices” can be tagged based on visit duration between 2 and 9 hours (or explicitly or probabilistically identified using the techniques described above). The signal strength maps of these devices provides a region of the store the staff frequent. This region is a second fictitious “room” inside the store that refers to the “chamber of engagement” above. A combination of max signal strength and visit duration can be used as evidence. Each minute a person spends inside the staff zone increases the likelihood they have engaged. Signal strength thresholds can be set by staff readings and the increase in engagement with each minute can be determined by training on transaction number. Transaction number correlates well with the number of engaged customers, and better than with the number of total customers. These two evidentiary inputs, staff signal strength and transaction number, are available for many spans and provide important pieces of calibration for each zone. Instead of/in addition to trying to measure bounce rate, transitions to an engaged customer state can be measured.

Repeat Rate

Visit frequency is another metric that can be determined by a platform such as platform 170. In some embodiments, platform 170 allows clients of the platform the ability to select a time window of interest and gain insight into the loyalty of customers who visited during that period. This allows store runners and marketing executives to gain insight into the dynamically changing loyalty of a store's population and creates temporally divided cohorts which can be linked to specific seasons or campaigns. The pairing of these two goals, loyalty measurement and cohort selection, makes this a challenging problem from a data accuracy perspective. One approach is to divide the problems, beginning with solving the issue of how best to measure loyalty alone.

If analysis is limited to the cohort that has returned this month, week, or day, the number of devices available for study is potentially severely limited. This picture can fail to count the number of devices which should have appeared during the time window but failed to do so. An accurate measure of these absent devices can be important for any meaningful measure of the store's loyalty. These devices are the baseline with which the number of repeat devices are compared.

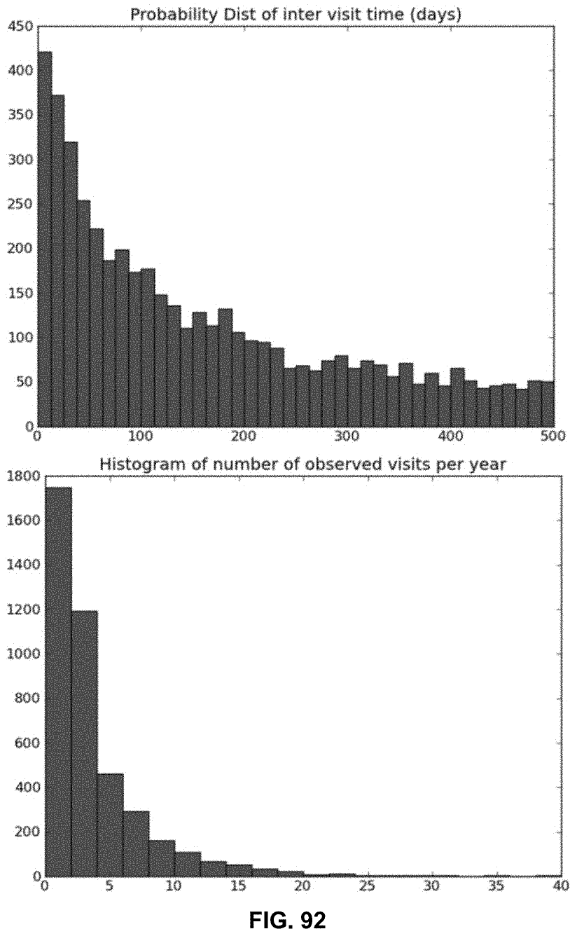

To better understand this point it can be helpful to adopt a model of visitor repeat behavior. One of the simplest pictures that can still capture essential behavior is to assume each person in the visitor population has a fixed probability of returning to visit the store, that this will lead to an exponential distribution in delay between repeat visits, and that this rate of repeat is drawn from a Gamma distribution described by two components, α and β. Roughly speaking the α describes the mean probability that a loyal visitor will return to the store, and β describes the spread in that repeat probability. Resultant distributions of the time between store visits and the number of visits per year per individual can be seen in FIG. 92, showing that the model is not far removed from expected visitor behavior. Fine tuning can be done by adjusting the parameters α and β.

FIG. 92 illustrates an example chart showing growth of known devices along age, gender, and income dimensions as a percentage of total devices that visited stores in the Bay Area. Here, stores in the Bay Area are limited to stores for which there is demographic information.

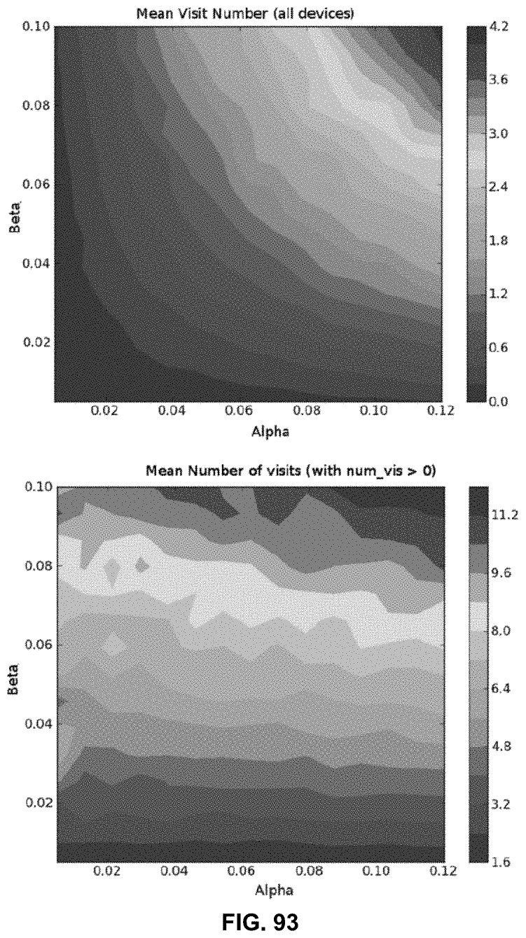

One aspect of this model is that it looks at the entire population and includes a count of the number of individuals with 0 visits during the given time period. As α is increased this bucket drops and the remaining buckets all increase by some factor. For small increases in α the percent increase is the same for all buckets >0 visits. Decreasing β also causes a decrease in the 0 visit bucket and rise in the visits >0 buckets; however, the increase is not uniform in this case and the buckets with higher number of visits grow more quickly. In other embodiments, the devices with 0 visits are ignored and the average of the remaining distribution is computed. This allows for the measurement of changes in β but not changes in α. This can be seen graphically in FIG. 93 where the color contours correspond to constant values of the mean number of visits, first calculated for all devices (a) and then for only devices with number of visits >0 (b).

FIG. 93 illustrates an example plot showing growth of known devices along age, gender, and income dimensions as a percentage of total devices that visited stores in the Bay Area. Here, stores in the Bay Area are limited to stores for which there is demographic information.

These scans reveal the insensitivity to mean number of visits for different a when only looking at devices which showed up in the cohorting time window, and points to the weakness of this number.

An alternate approach is that for each day, week or month of interest the entire historical record is used. This model, or one like it, can then be used to predict the number of repeat visitors expected during that time window. This prediction can then be compared with the number which actually showed up. This provides insight for store runners and marketers as they could see if they were beating expectations or not.

The model described assumes that any device it has ever seen at a store will have some probability of returning, that these devices remain loyal to the store for all time. In some embodiments, this assumption can be accounted for with a four component rather than two component model.

Additional Details Regarding Data Privacy

In some embodiments, crowd blending of collected and processed data is performed, providing relative anonymity to all devices while at the same time allowing for the calculation and reporting of the metrics described above. A finite list of metrics and useful data to keep can be identified, with the remainder discarded. Formal measures of anonymity gained vs. degradation of data accuracy can be calculated. In some embodiments, a combination of crowd-blending and pre-sampling techniques is used to produce a data corpus that is zero knowledge private. Even were data stores compromised, or data subpoenaed it would not be possible to link stored records to a specific individual. One model is to focus on reporting demographics (e.g., obtained by mining census data, as described above) for devices, and health indicators for stores. This would allow the visit record of an individual to be made fuzzy in specific ways to assure privacy. An example list of relevant data and metrics that are consistent with this model is given below.

1. Individual device demographics (age, gender, income)

2. Individual home and work location at zip code level

3. A store's loyalty score—4 parameter rpt model

4. Store traffic counts—inside and outside

5. Store's engagement score—avg dwell

6. Connection strength between stores

A crowd-blending scheme combined with random sampling will impose a minimum uncertainty for privacy with almost no degradation to signal quality. Cohort tracking is an example of one use case with a steeper trade-off between privacy and utility. Certain cohorts based on demographic info, age for instance, or a specific behavior that can occur at any time, commuter tagging, pose little issue. However, any cohort analysis that seeks to time select users based on a specific day or week, or a specific combination of locations (ACME Coffee and Beta Shoes for instance) may pose issues. In general, the resultant information that can be calculated, demos or behavior, is robust under data compression because the specific data of visit or zone of visit is not an issue. This is less the case with cohort tracking around specific marketing campaigns or initiatives at individual stores.

A blender and sampler can be written to quantify the loss of data accuracy for certain level of privacy enhancement. For example, two spans can be taken, ACME and Beta companies for instance, and a few months of data can be duplicated with added privacy built in. The metrics listed above can be compared in both cases and deviations quantified. A process based on genetic evolution algorithms can be used to fuzzy the data. The modified generation of the corpus can include the following. A few fields deemed to add privacy but not degrade data utility can be targeted for mutation; an example could be the exact date or hour of a visit. This piece of information is potentially superfluous to the ability to report useful information. In some embodiments, the modified generation samples its new value for these fields from a list of neighboring devices. The sampling can be equally weighted for any device sufficiently close in behavior space, or it can be a weighted random sampling of any device in the corpus, weighted by the distance in behavior space. Once a quantitative measure of utility lost for privacy gained exists, an informed discussion can be made about which metrics and use cases to prioritize. This allows for control of data privacy.

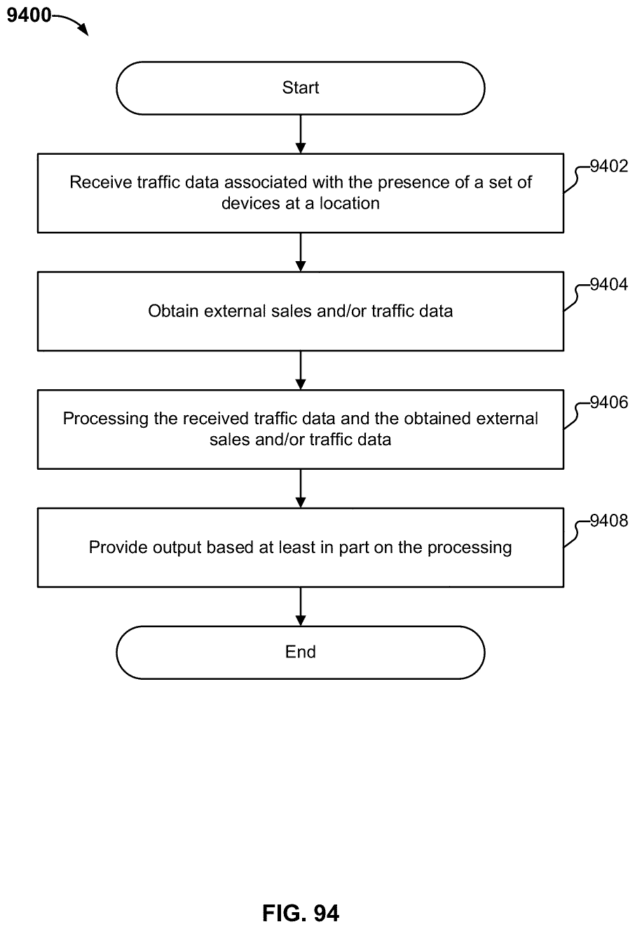

FIG. 94 is a flow diagram illustrating an embodiment of a process for utilizing sales and traffic data. In various embodiments, process 9400 is performed by platform 170. The process begins at 9402 when traffic data associated with a presence of a set of devices at a location is received. As one example, such traffic data is received at 3202 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3202 of the process may be repeated several times (e.g., with data about the observation of device 112 also being received at 3202, whether from sensor 108, or another sensor, and/or from a controller). The received traffic data can be obtained by access points when passively receiving wireless connection requests from devices within range of the access point. In various embodiments, the received traffic data includes timestamps, sensor identifiers (e.g., MAC addresses of access points), device identifiers (e.g., MAC addresses of the devices whose presence has been detected), signal strength information, etc., as described above.

In some embodiments, the received traffic data is used to determine visitor activity. For example, key performance indicators or various measures are determined based on the received traffic data. One example of a key performance indicator is average shop time, which is determined by determining an average amount of time that a device spends at the location (e.g., based on received timestamp information). Another example of a key performance indicator that can be determined is a duration that a device has spent at the location. The duration can also be determined based on received timestamps. In some embodiments, a duration of time that the device spent at a location across a combination of span, zone, and date can be determined for a device by aggregating timestamps over a time period. Another example of a key performance indicator is store front potential.

In some embodiments, determining store front potential includes determining a number of users with WiFi enabled devices detected within and/or without the location. In some embodiments, store front conversion can also be determined using storefront potential, which is a proportion of users detected within and without of the location that entered the location.

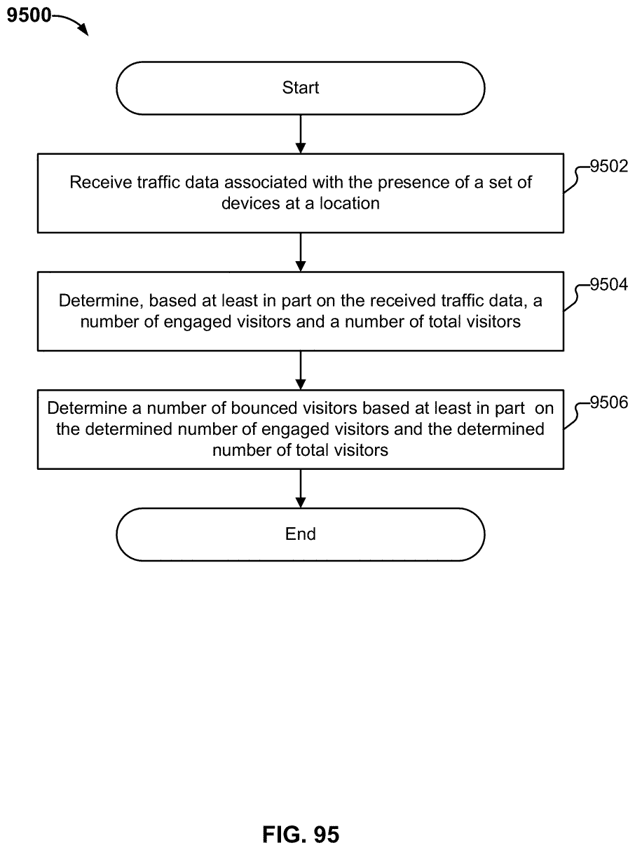

Another example of a key performance indicator is bounce rate. In some embodiments, bounce rate is the percentage or proportion of users with Wi-Fi enabled devices that spent less than threshold amount of time at the location. Another example of calculating bounce rate is described in further detail below in conjunction with FIG. 95.

Another example of a key performance indicator that can be determined is new shoppers. A metric associated with new shoppers can be determined by determining a percentage of visitors to the location who have not been previously detected by a sensor at the location.

Another example of a key performance metric is repeat visitors. In some embodiments, determining a number of repeat of visitors (e.g., repeat shoppers) includes dividing the number of repeat visitors by a total number of visitors (e.g., within a certain time period).

Another example of data that can be determined using the received data include loyalty and engagement (e.g., dwell) scores for the location.

In some embodiments, the traffic data received at 9402 can be used to determine a repeat rate (also referred to as “visit frequency”). In some embodiments, the repeat rate is based on the loyalty of a store's population during a time period (as well as a selection of cohort devices in the time window). In some embodiments, a measure of the loyalty of the location's population can be determined. The loyalty measure can be determined based on an accurate measure of absent devices (e.g., a number of devices which should have appeared during a time window, but failed to do so). These absent devices can be used as a baseline against which the number of repeat devices (determined using the techniques described above) in the time window are compared. Repeat rate can be determined based on a model of visitor repeat behavior. In some embodiments, the repeat rate is determined based on a probability that a loyal visitor will return to a store and the spread in repeat probability (e.g., distribution of delay between repeat visits). The repeat rate (and spread in distribution of delay between repeat visits) for different cohorts (within a time window) of devices can then be modeled. Growth of devices along various dimensions (e.g., segmented based on dimension such as age, gender, income) can be determined. In some embodiments, the modeling can be used to predict the number of repeat visitors expected during a time window.

The traffic data received at 9552 can also be used to determine visit recency. In addition to extracting the population's visit rate, how the repeat visit rate changes with time can also be tracked. This allows, for example, for seasonal trends to be determined from the received traffic data.

For example, the likelihood that a repeat customer is to return to a location may change with each visit. As described above, in some embodiments, the visit rate can be updated over time upon each repeat visit by a visitor (e.g., shopper at the location). Thus, the visit rate can be changed or updated after each visit. The attrition rate of repeat customers can also be determined.

In some embodiments, demographic information (e.g., census) data can be associated with metrics determined from the received traffic data. For example, demographic information such as age and gender can be attributed to records of detected devices. As one example, information on gender and age distributions based on geo-location can be obtained. For example, the zip code of the detected device (e.g., detected based on the zip code of the location or inferred based on an obtained IP address) can be used to mine census data and obtain demographic information from the census data that is associated with the zipcode. As another example, the walk-by record of a previously geo-fenced region can be mined and demographic information based on the time weighted average of locations where an individual is observed can be assigned. Thus, demographic information associated with a user of a device can be determined over time by viewing demographic information (such as gender and age distribution) for locations at which the device is detected.

As described above, privacy can be preserved/maintained by performing techniques such as crowd blending of the collected and processed data as well as random sampling, thereby providing relative anonymity of the devices whose presence have been detected (and associated metadata collected), while allowing for the calculation and reporting of metrics such as those described above.

At 9404, external sales data and/or traffic data is obtained. For example, a representative of the location provides external (e.g., not captured directly by platform 170) sales and traffic data (e.g., that is separate from the traffic data received at 9402, which can be obtained using sensors, as described above) such as point of sales information, payroll hour data, beacon data, etc. Other examples of sales data that can be obtained include sales revenue, transactions, units sold, etc.

In some embodiments, the data obtained at 9404 is uploaded via a template, as described above. In various embodiments, the data obtained at 9404 is obtained via mechanisms such as FTP, email, a REST API, via a dashboard user interface, etc.

In some embodiments, the data obtained at 9404, after being ingested, is parsed. This can be performed to accommodate the different formats in which the external sales and/or traffic data may be in.

In some embodiments, the obtained external sales and/or traffic data is processed. For example the data obtained at 9404 can be aggregated to determine a time series for a portion of the obtained data (e.g., total sales per day or time, or total traffic count (e.g., from door counters) per day or time) can be determined.

In some embodiments, after the ingested external data is parsed, it is made available as output. For example, sales and traffic widgets based on the obtained external data can be presented in a dashboard user interface. The widgets can include time series information. In some embodiments, the widgets are added to an existing dashboard such that key performance indicators and metrics determined using the data received at 9402 can be viewed along with the external sales and/or traffic data obtained at 9404. In some embodiments, the widgets are included in a pre-configured dashboard relevant to the external sales and/or traffic data. In some embodiments, the dashboards are editable, and users can add, remove, or otherwise modify, as desired, the widgets based on the external sales and/or traffic data.

At 9406, the obtained external data and the received traffic data are processed. In some embodiments, the processing includes the ingestion and parsing, as well as other processing (e.g., determination of visitor activity and metrics) described above. In some embodiments, the processing includes evaluating the obtained external data and the received traffic data together. For example, the In some embodiments, the evaluating includes correlating the external sales and/or traffic data with the key performance indicators or measures associated with visitor activity determined based on the traffic data received at 9402. As described above, the correlation can be performed to determine how efforts to attract, engage, and retain customers influence sales. In some embodiments, a sales forecast is predicted using the combined evaluation. Evaluating the external data obtained at 9404 with the traffic data received at 9402 includes monitoring outcomes and attributing return on investment (ROI) to marketing and operations initiatives, as described above.

One example of evaluating the external data obtained at 9404 with the traffic data received at 9402 is adding dwell to sales analysis, as described above. For example, a composite metric “number of visitor minutes” can be determined that is based on a visitor count for the location and a median visit duration (dwell). The new composite metric represents a number of useful minutes (e.g., opportunities for sale) that a zone in the location had on a given day. Sales data can then be predicted using the composite metric.

At 9408, output based at least in part on the processing of the combination of external sales and/or traffic data and received traffic data (e.g., received from sensors at the location) is provided. For example, reports including the results of the evaluation can be presented. This allows a combined analysis and viewing of sales and traffic data (e.g., the ability to view external sales and traffic data with determined visitor activity). Various examples of interfaces and reports are described above.

FIG. 95 is a flow diagram illustrating an embodiment of a process for determining bounce rate. In various embodiments, process 9500 is performed by platform 170. The process begins at 9502, when traffic data associated with the presence of a set of devices at a location is received. As one example, such traffic data is received at 3202 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3202 of the process may be repeated several times (e.g., with data about the observation of device 112 also being received at 3202, whether from sensor 108, or another sensor, and/or from a controller). The received traffic data can be obtained by access points when passively receiving wireless connection requests from devices within range of the access point. In various embodiments, the received traffic data includes timestamps, sensor identifiers (e.g., MAC addresses of access points), device identifiers (e.g., MAC addresses of the devices whose presence has been detected), signal strength information, etc., as described above.

At 9504, based at least in part on the traffic data received at 9502, a number of engaged visitors and a number of total visitors is determined. A visitor to the location can be determined to have transitioned into an engaged visitor based on one or more triggers or transition events (i.e., transition to an engaged customer state). One example of a trigger, transitions event, or signal used to determine the transition from a simple visitor to an engaged visitor (and potential customers) include detecting that a visitor is actively browsing inventory.

Another example signal that a visitor is an engaged visitor includes detecting that the visitor is interacting with a staff member. As one example, the interaction with staff is determined at least in part by detecting that a device is within a staff zone. The detection can be based on max signal strength and visit duration (both of which can be collected or determined from the traffic data received at 9502, and as described above). In some embodiments, the detection of the staff interaction is based on a transaction number.

Another example transition signal is detecting that a visitor's device is connecting the location's WiFi. The device's connection to the location's WiFi can be inferred based on a detected increase in the device's measured bandwidth.

Another example signal is detecting that the individual stops walking and stands still. Another example signal is detecting that the visitor's duration of a current visit is longer than the duration of previously recorded visits.

At 9506, a number of bounced visitors is determined based on the determined number of engaged visitors and the determined number of total visitors. For example, the number of bounced visitors is determined as the different between the determined number of engaged visitors and the determined number of total visitors.

Additional Details Regarding Sensor Network Hierarchies

As described above, additional hierarchical information associated with a network of sensors can be provided during onboarding. As one example, chainwide and/or sub- chainwide hierarches can be created using the techniques described herein.

Chainwide, and sub-chainwide analysis of customer behavior provides for fast insight for critical questions regarding the performance across and up and down the hierarchy of a chain of stores, or any network of sensors.

Using the chain-wide hierarchies described herein, questions such as the following can be answered: are new shoppers being converted and more frequent loyal shopper cycles being driven? How successfully do promotions engage shoppers in stores? Are customers being retained post-promotion? How does performance vary from region to region, store to store? Where are the top and bottom performing regions and stores?

Custom Hierarchies

Using the techniques described herein, administrator users associated with an organization using the services of traffic insight platform 170 can create (e.g., during onboarding, as described above) a hierarchy mirroring the hierarchy of their organization. As will be described in further detail below, the flexible hierarchy infrastructure described herein can be used by organizations to query their reports in ways that most accurately reflect their organization, and how their data is organized. Administrator users can specify, for example, the names of their hierarchical levels {hierarchy_1_name, hierarchy_2_name, etc., as shown below in conjunction with Table 1}. For example, a retailer can specify the tiers of their hierarchy as “ALL”, “region”, “district”, etc. In some embodiments, an assumption is made that the node, a physical location containing APs, last level belongs to the last specified level and in our database is referred to as store. For instance in Table 1 below Stores belong to Areas. For example, in table 1, below “hierarchy_3_name” are single locations (e.g., not aggregated to a hierarchy level).

TABLE 1

| Name | description | hierarchy_1_name | hierarchy_2_name | hierarchy_3_name |
|---|---|---|---|---|
| national_retailer | CleanBeauty | All | Region | Area |

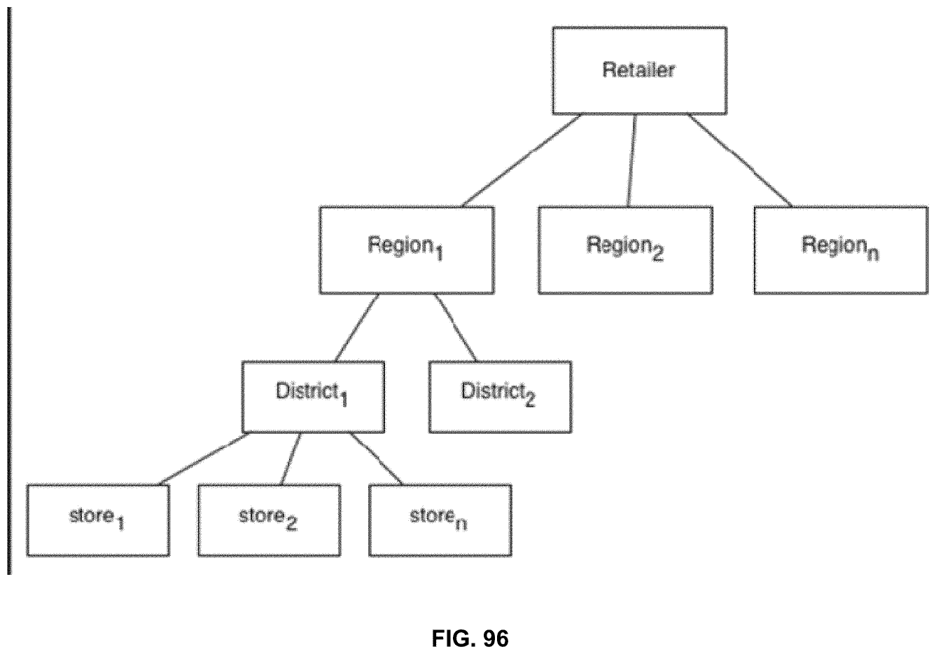

FIG. 96 illustrates an example embodiment of a chain-wide hierarchy detailing a Retailer with Region, District and Stores.

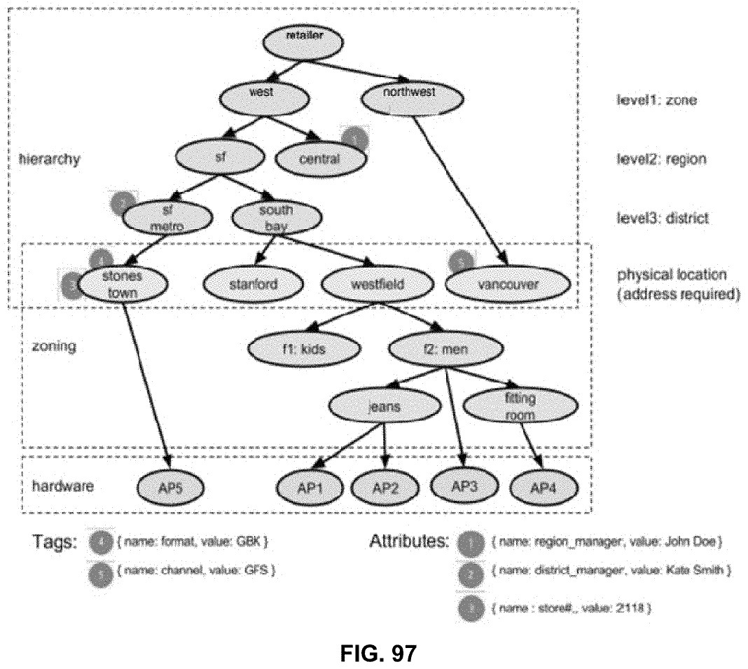

FIG. 97 illustrates an example embodiment of a chain-wide hierarchy detailing a Retailer, zone, region, district, physical location, then zones, and within the zones hardware (APs).

In some embodiments, once hierarchy levels are specified, a user can then upload a file(s) containing the members of the lowest level in the hierarchy, specifying each of the levels of the hierarchy up to the hierarchy, usually a member spanning the entire hierarchy (e.g., in Table 2 below this is ALL). For example, each location is tagged with different levels of the hierarchy.

TABLE 2

| client_name | Name | description | hierarchy_1 | hierarchy_2 | hierarchy_3 |
|---|---|---|---|---|---|
| national_retailer | nr-sf | Union Square | All | West | Northern California |
| national_retailer | nr2-sf | nr2, Union Square | All | West | Northern California |

In some embodiments, Tables 1 and 2 described above are examples of assets tables.

In some embodiments, access points are associated with Stores (or the lowest node in the hierarchy, as applicable) by an additional file upload that contains the mac_address (or any other appropriate device identifier) of the sensor, the store name, client name.

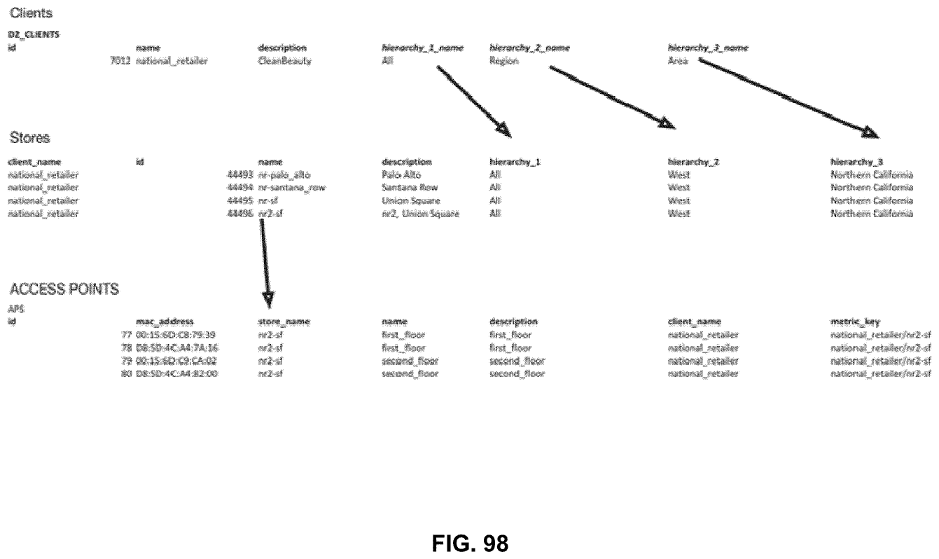

FIG. 98 illustrates an example embodiment of a mapping of clients to stores to access points, which summarizes a chainwide hierarchy from client (e.g., business organization) to access point.

The Clients Table shown in the example of FIG. 3 contains the hierarchy fields needed to be specified by the end-user: hieararchy_1_name, hieararchy_2_name, hiearchy_n_name . . . ,

The Stores Table shown in the example of FIG. 3 contains the elements that need to specified to complete specify the location of the store in the hierarchy (the hieararchy_1, hierarchy_2).

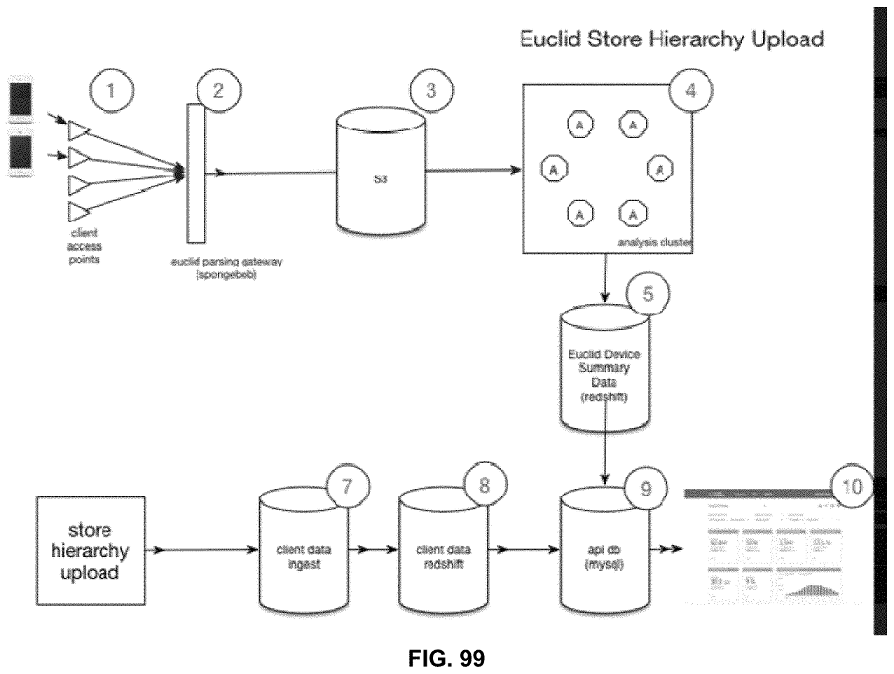

In some embodiments, data is collected and analyzed on a per AP basis (e.g., using metrics pipeline 230 of platform 170). An example of such data collection and analysis is shown in the example of FIG. 99. FIG. 99 illustrates an example embodiment of a schematic diagram detailing the flow of data from sensors through a Data Analysis Pipeline. Also, shown in the example embodiment of FIG. 99 is a hierarchy upload flow.

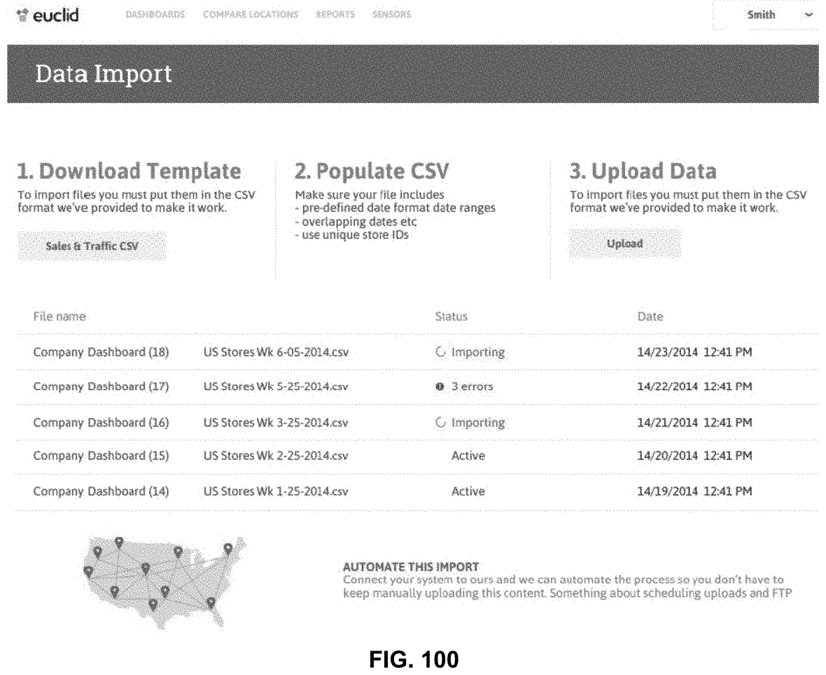

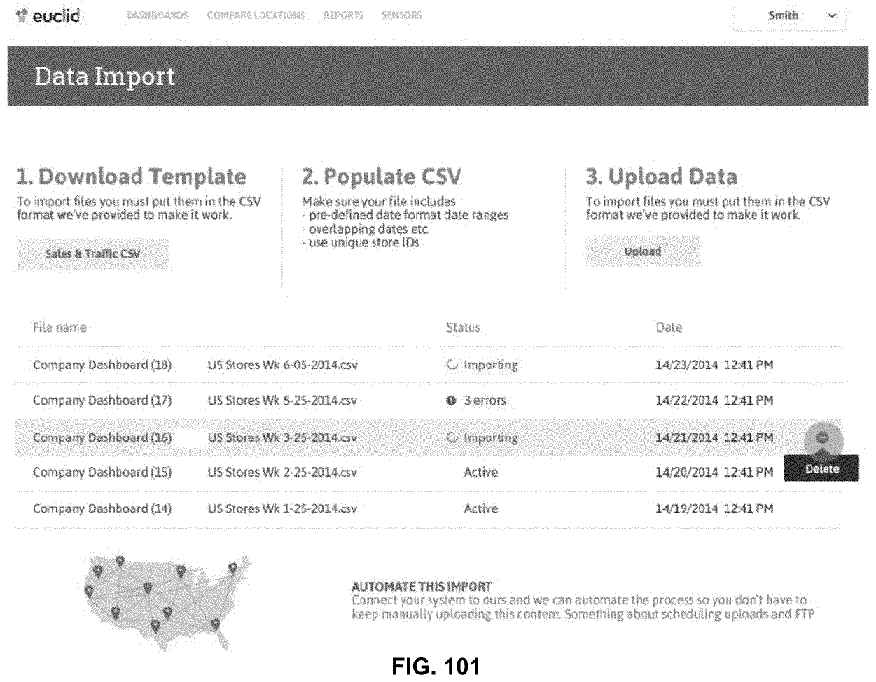

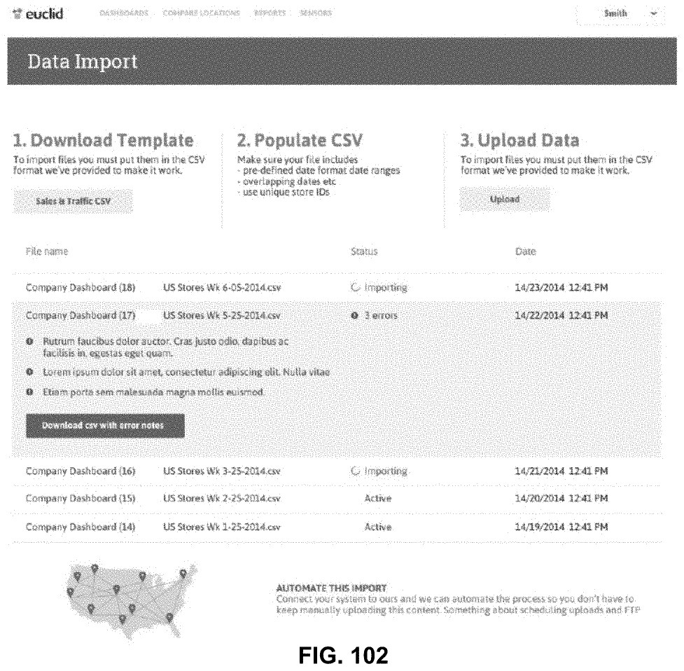

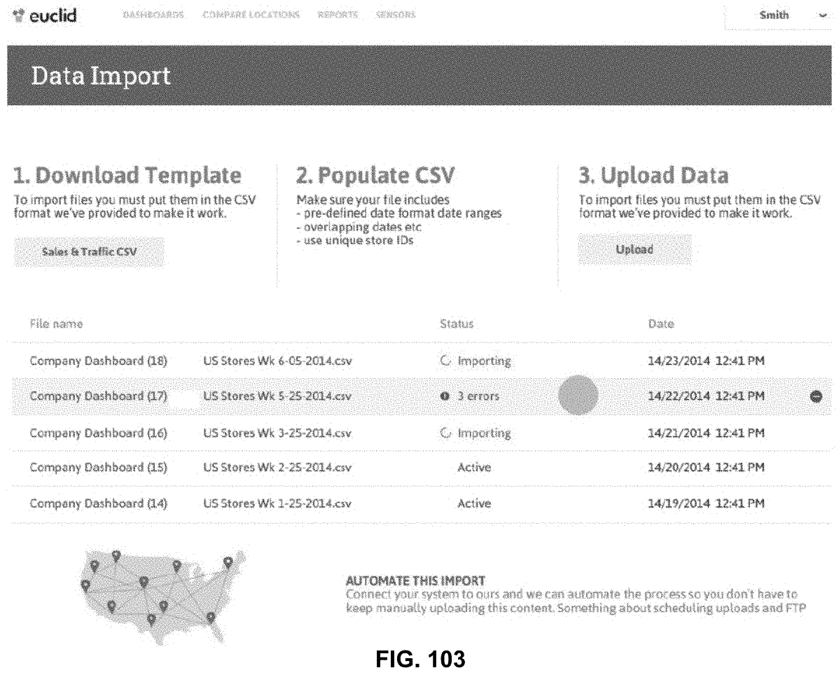

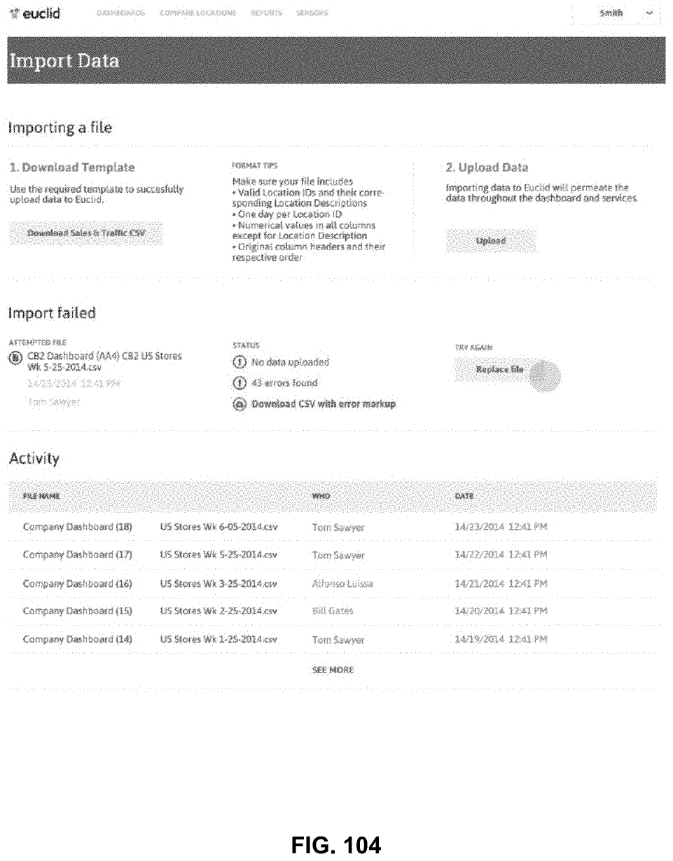

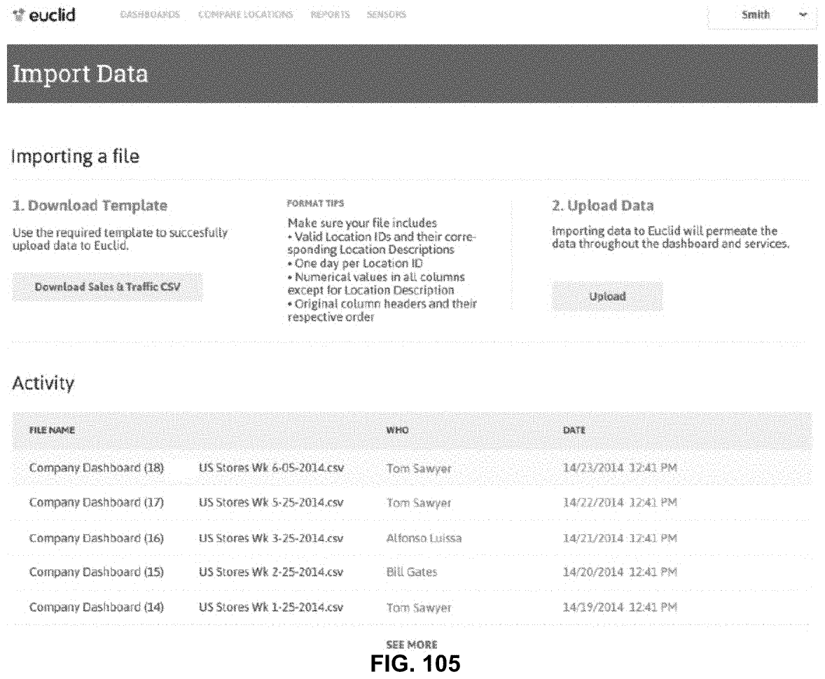

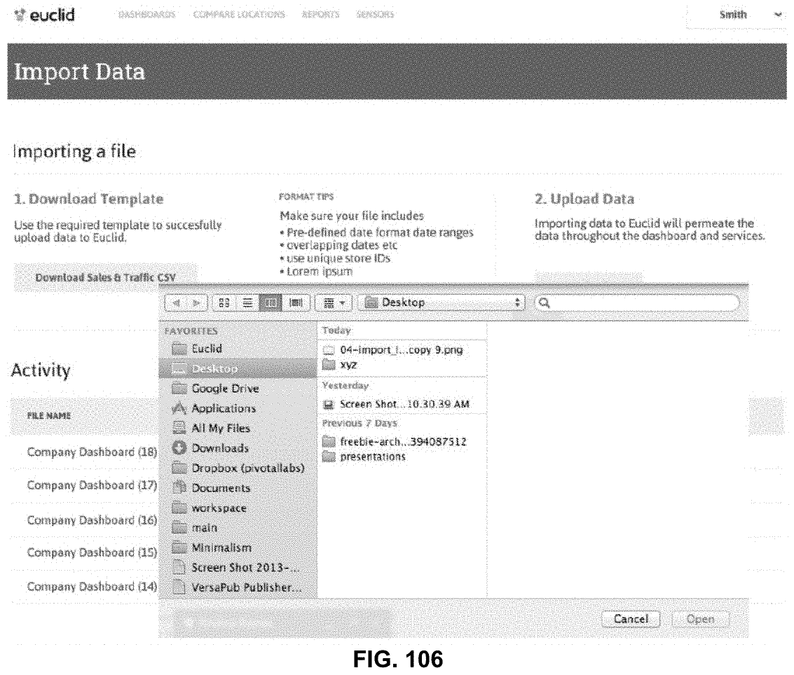

In some embodiments, the values for a Hierarchy tag is/are a rollup of the values of all the stores beneath it. Rollups can be a sum, average, or other value(s), depending on the metric. In some embodiments, rollups are performed at query time. Queries on a specific hierarchy tag are available in the API and via a user interface. With the hierarchy in place users can begin to understand their clients behavior and performance of their entire chain at any level in their hierarchy. FIGS. 100-106 illustrate example embodiments of interfaces for uploading hierarchies.

Investigating the Performance of the Chainwide Hierarchy

In various embodiments, users can view the ranking of their hierarchy via a map, a table, or drillable bar chart. Examples of interfaces and reports through which the performance of chain-wide hierarchies can be viewed are described in further detail below.

In some embodiments, chainwide ranking of stores according to key performance indicators (KPIs) {e.g., storefront potential, average shop time, storefront conversion, walk-bys, traffic-count} is available at all levels of the hierarchy over a specified window of time, and can be compared to a previous period of time.

Which metrics have the greatest impact on sales performance for a particular location can also be identified by identifying which Sales Driver (Euclid's KPIs correlated with client contributed Sales Data) is driving sales on a per location basis.

In addition to examining the aggregate performance of levels of the hierarchy, users can compare KPIs at the same level in the hierarchy using a comparison tool, described in more detail below.

Example User Scenarios

### Investigating Performance on a Regional Basis

Dwight, a regional manager at ACMERetail learned that ACMERetail will be adopting the services of traffic insight platform 170 across the ACMERetail chain in order to gain insights on their business. His boss, Bill, has asked him to monitor traffic data for his region, and be able to speak to key trends during their weekly meeting. Logging into platform 170 for the first time, Dwight sees a default dashboard, which shows some interesting metrics, including average shop time, bounce rate, new and repeat shoppers across all stores.

Since Dwight is mainly concerned with his region (Western Region), he changes the dashboard to show how his region performed. Since he will likely be checking this more often in the coming weeks, he decides he wants to customize the dashboard to show his region's performance whenever he logs in.

He creates a custom dashboard that shows only metrics for his region, and also adds Sales, Traffic, Conversion, and Avg Dollar Sales to the dashboard along with other metrics on the standard dashboard and saves it so that he can easily find it the next time he needs to speak to this in a weekly meeting.

As Dwight is preparing for the weekly meeting, he can also compare this week's data versus the last week's data in order to highlight trends.

If something stands out as out of the ordinary, Dwight can also dive deeper and look at individual stores within the region to understand what is driving the anomaly.

### It was a Dark and Stormy Weekend:

The northeast has been hit with a big winter storm and all sales numbers for all the stores in the region are down. Unfortunately, this storm has coincided with a special event that Agatha, the marketing manager at ClothingStore ran that was targeted at bringing in loyal customers of the makeup department for makeovers. She is preparing for a weekly status call, and would like to be able to explain the impact of the storm on her campaign in the northeast.

She believes that since the promotion would have caused customers to stay longer on average, that even though traffic was down, she might be able to point to the campaign as a success if she can show that the average duration of shoppers was higher in the stores where the campaign ran.

Pulling up her account with platform 170, she quickly sees something that shows stores that ran the campaign (#'s 203-212) and compares them against the Northeast regional average, and the chainwide average.

Despite traffic being down, she can see that people are spending more 15 minutes longer in the stores where the campaign ran than the average in the Northeast region and 20 minutes longer than the chain as a whole.

As she dials into the meeting, she feels confident that she'll be able to point to the success of the campaign and justify her spend on similar programs in the future.

### Adopting Best Practices

Bill, the VP of store operations for BizACME, has just done a study that ties the time a customer spends in-store with larger purchases at checkout. He believes that this is a key metric that the stores should be tracking and measured against—and since he has just signed up with Euclid, he is now able to track this information.

As an initial cut, he would like to see how each of the regions compare so that he can measure how his direct reports, the regional managers are performing on store duration.

He goes into his Euclid account and can see how each of the regions perform on store duration. The Northeast region is doing especially well against the other regions—customers stay in-store about 15% longer than the next highest region.

He approaches the regional manager to understand what he is doing to increase duration, so they can transfer best practices across other regions.

Contextualizing Under Performance—Operations Analyst Use Case

John, an operations analysts at CCorp, is tasked by the regional manager of the Mid West to explain why his region (35 stores) performed so poorly last week (−25% below sales forecasts).

John starts by identifying which stores in the midwest underperformed by the largest margin. Once he has identified what was driving the aggregate sales lower, he will need to answer why these troubled stores performed so poorly.

One option for John is to look across a spreadsheet at different sales KPIs that were up or down over the week and pulls in anecdotal evidence from local sales managers.

With Euclid he can do some initial discovery by comparing this information on one chart.

Layering in Euclid data he will be able to provide contextualized performance based on how leaders performed vs. laggers

Contextualizing Under Performance—Marketing Manager/Director Use Case
Lindsey, a director of marketing at KBIZ, receives the weekly review of a campaign's performance from her analyst broken down by region (Northeast, South, Midwest, West, and Southwest)
She notices that on the aggregate, sales performed below expectations during the campaign period, down 4% vs last year and 2% vs plan—with the Northeast being the only region to underperform expectations down 13% vs last year and 10% vs plan
She has a hypothesis that the Northeast shopping weekend was influenced by the unexpected arctic blast
In the regional view she plots Storefront Potential on the x axis and sales on the Y and sees that the Northeast saw 20% less Storefront Potential when compared to last year, while the other regions were all flat
She notes this and is now prepared to defend the campaign she ra—not just that weather was bad in the Northeast but she now can quantify the 20% drop and display sales vs. storefront potential
She forwards her a screenshot to her analyst and asks her to produce a slide that shows this data.

Find Trends Use Case

Identifying a leading cause in recent store performance—Operations Managers
Sami, the operations manager at DCorp is curious about store 114 in the West that has seen a 7% increase in sales performance vs last year over the past three weeks
The sales staff at the store just went through a pilot training program teaching them more effective ways to interact with customers
Sami, who was tasked with implementing and summarizing this training effort, hypothesizes that this has led to an increase in engaged shoppers and thus increased conversion.
She opens Euclid to quickly test her hypothesis, she plots sales, conversion, and engagement—she sees that all three metrics have trended higher by greater than 5% over the past three weeks
She then calls in her analyst John and explains that she is going to need two slides 1. Explaining the details of the training program 2. The results showing the increase in the three

### Example Interfaces and Reports

The following are examples of interfaces and reports through which the performance of chain-wide hierarchies can be viewed. In some embodiments, the reports and interfaces described below are examples of reports 232 provided by platform 170.

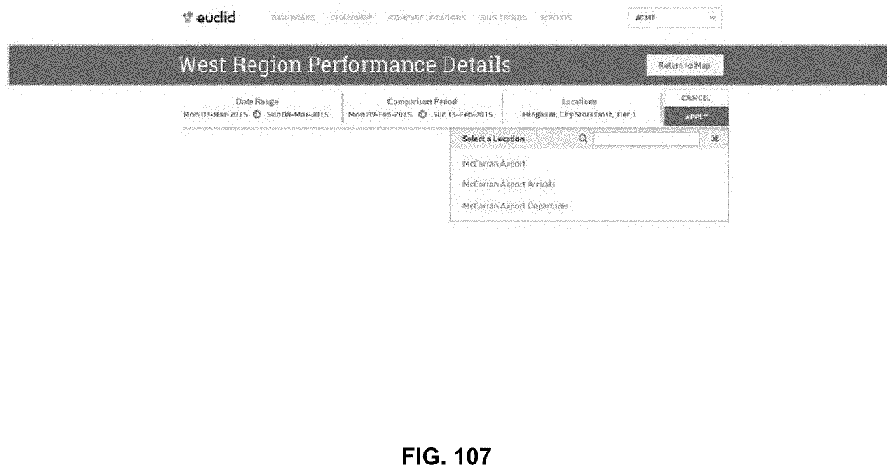

FIG. 107 illustrates an example embodiment of a user interface showing West Region Performance Details. In the example shown, the regional performance for a specific date range, comparison period, and a specific location is examined.

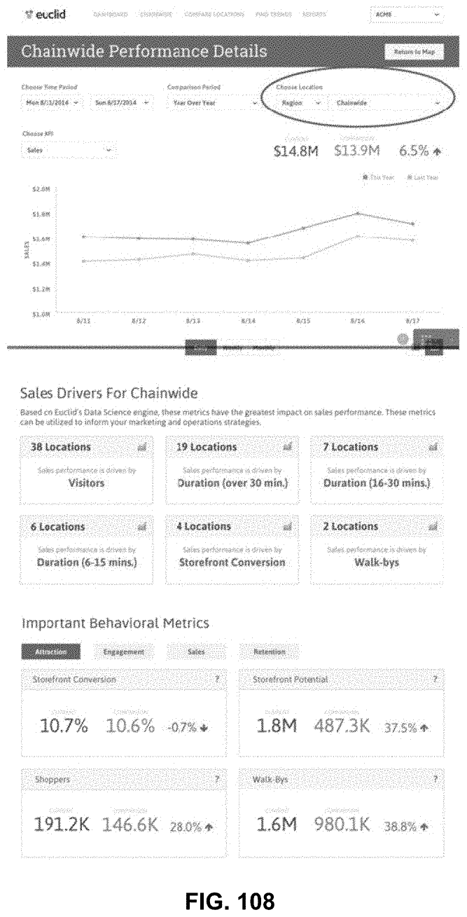

FIG. 108 illustrates an example embodiment of Chain-Wide Performance Details. In the example shown, the regional performance for a specific date range, comparison period, and a specific location is examined. Details for certain KPIs are also shown.

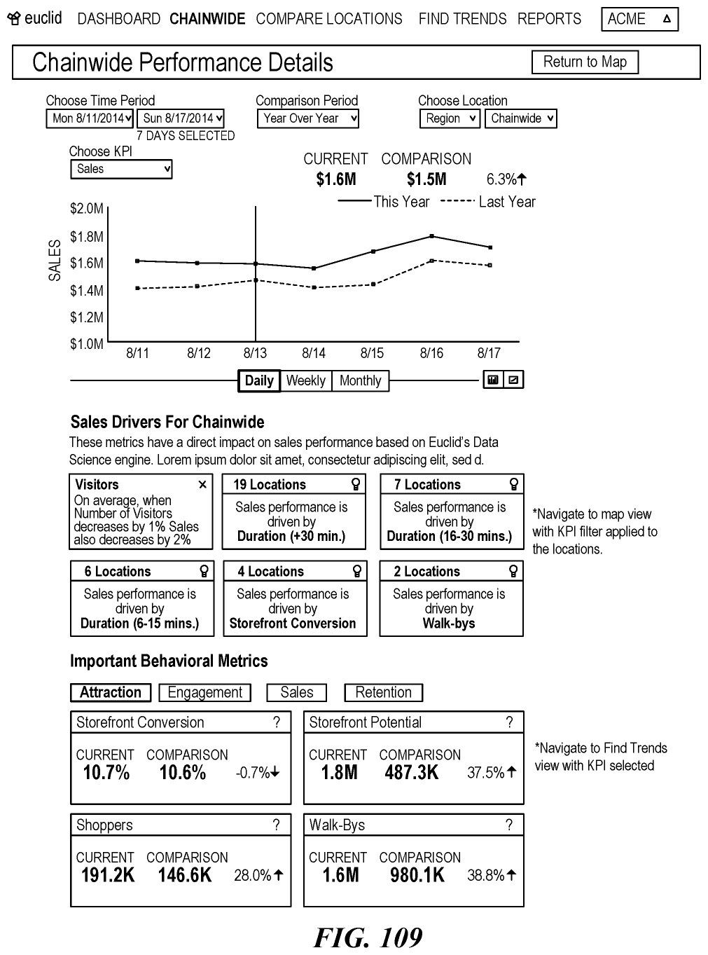

FIG. 109 illustrates an example embodiment of ChainWide Performance Details. In the example shown, the regional performance for a specific date range, comparison period, and a specific location is examined. Also shown are details for particular KPIs.

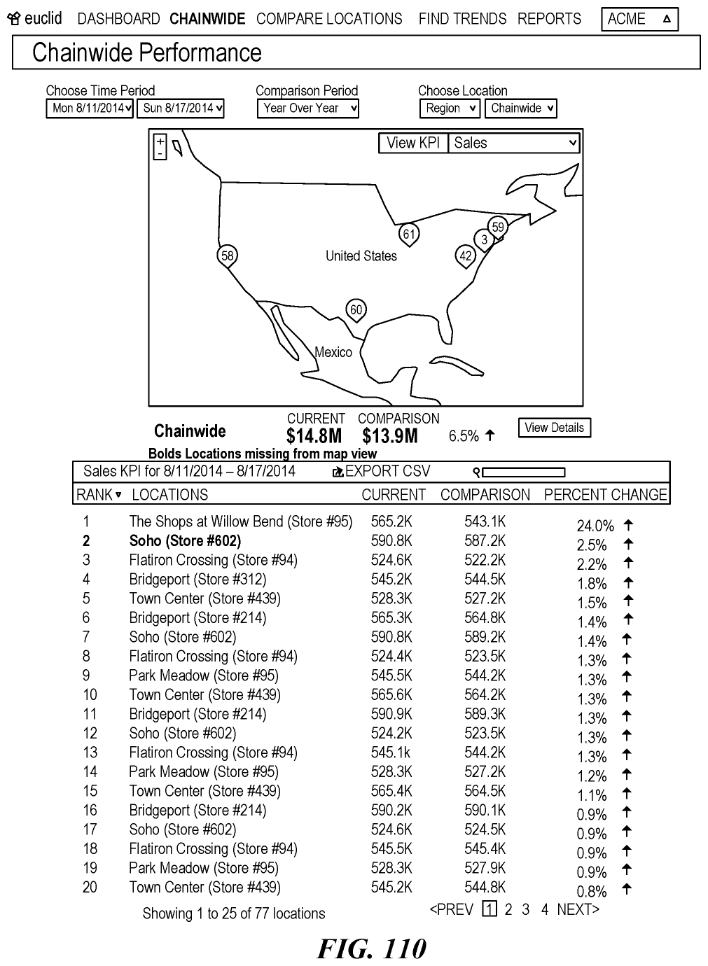

FIG. 110 illustrates an example of chainwide performance with Map and Tabular Data detailing top and bottom performers.

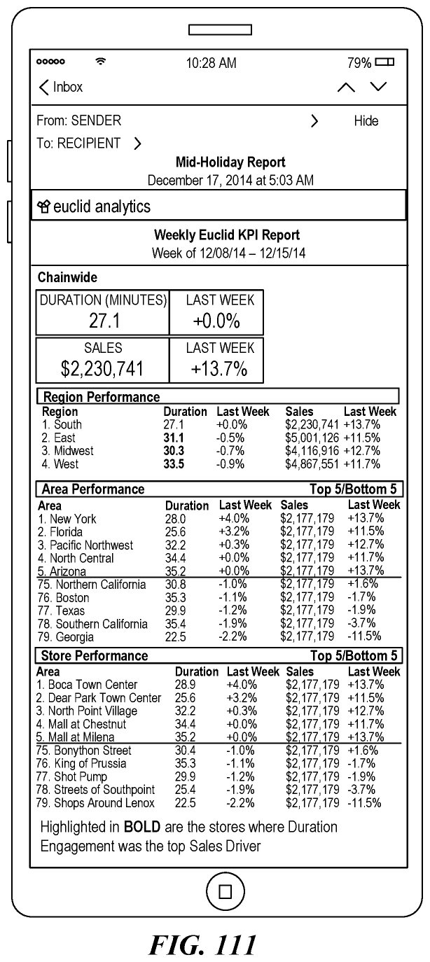

FIG. 111 illustrates an example embodiment of a weekly KPI Report Email detailing regional performance of chain, Top and Bottom Regional Performers, Top and Bottom Store Performers.

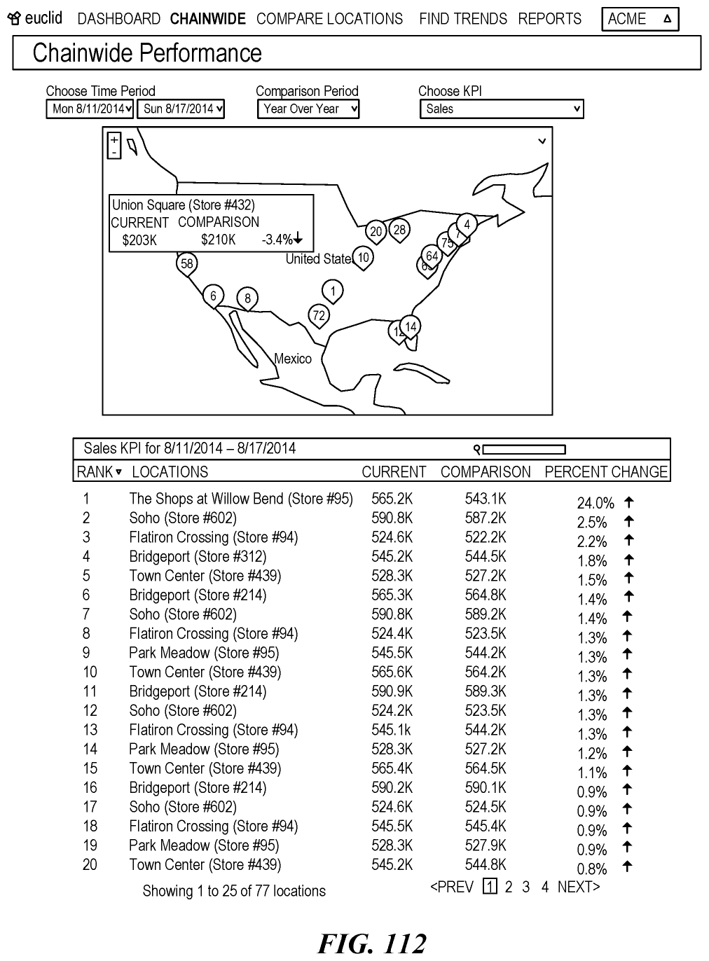

FIG. 112 illustrates an example embodiment of ChainWide Performance Details. In the example shown, the regional performance for a specific date range, comparison period, and a specific location is examined. Also shown are details for particular KPIs. Hover detail of a particular store is also shown.

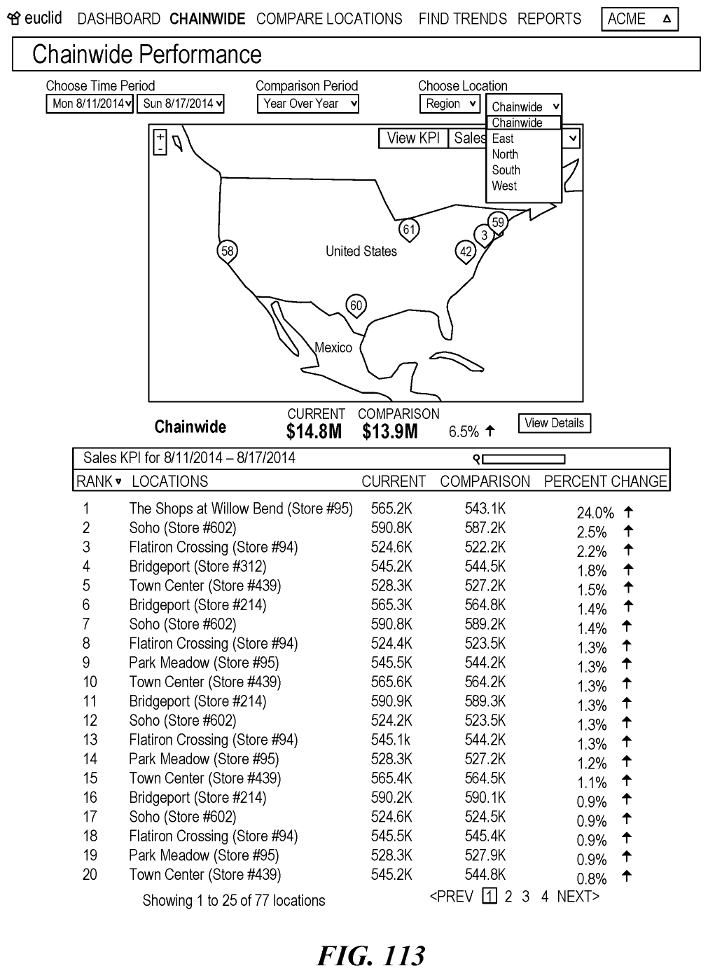

FIG. 113 illustrates an example embodiment of ChainWide Performance Details. In the example shown, the regional performance for a specific date range, comparison period, and a specific location is examined. Also shown are details for particular KPIs. Also shown is a hierarchy element selector.

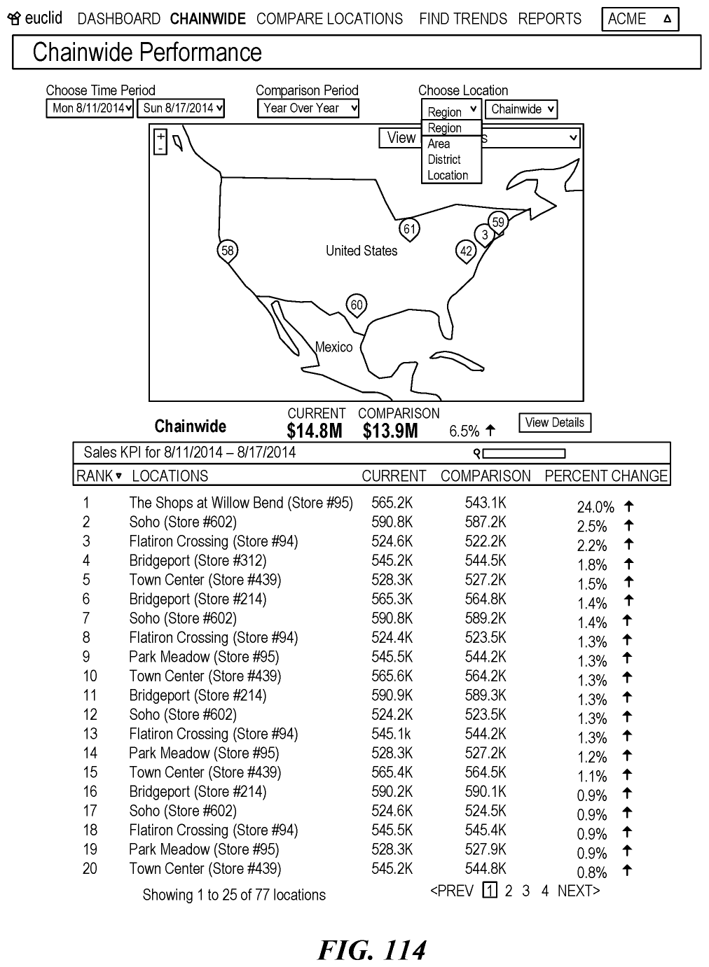

FIG. 114 illustrate an example embodiment of ChainWide Performance Details. In the example shown, the regional performance for a specific date range, comparison period, and a specific location is examined. Also shown are details for particular KPIs. Also shown is a hierarchy level selector.

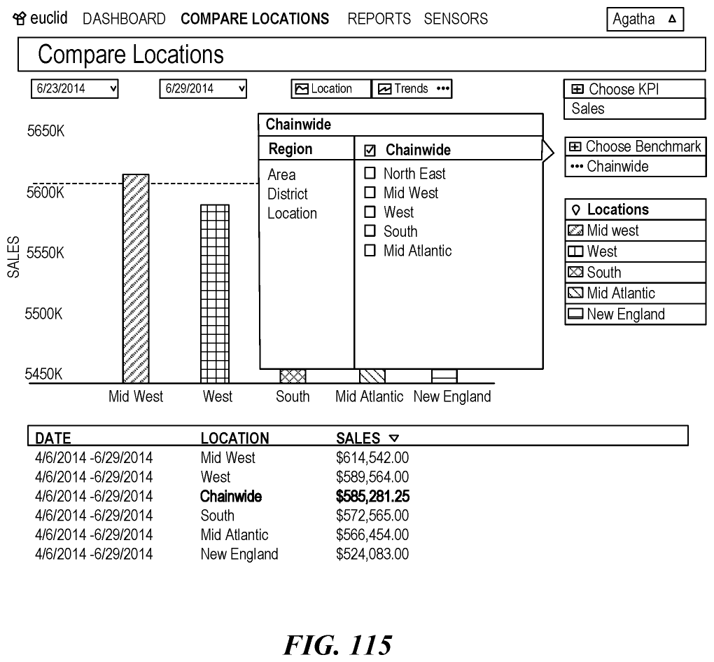

FIG. 115 illustrates an example embodiment of an interface for comparing Location Details. Comparing KPIs on a regional basis is shown in this example.

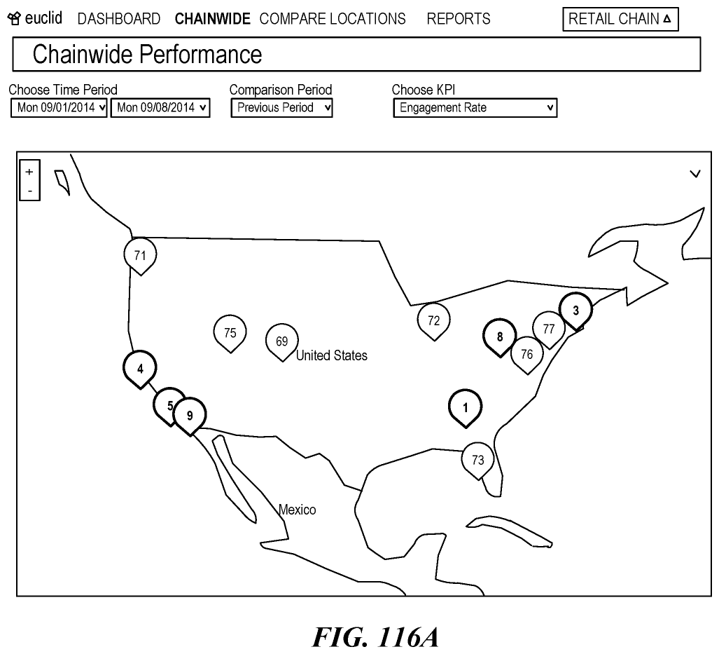

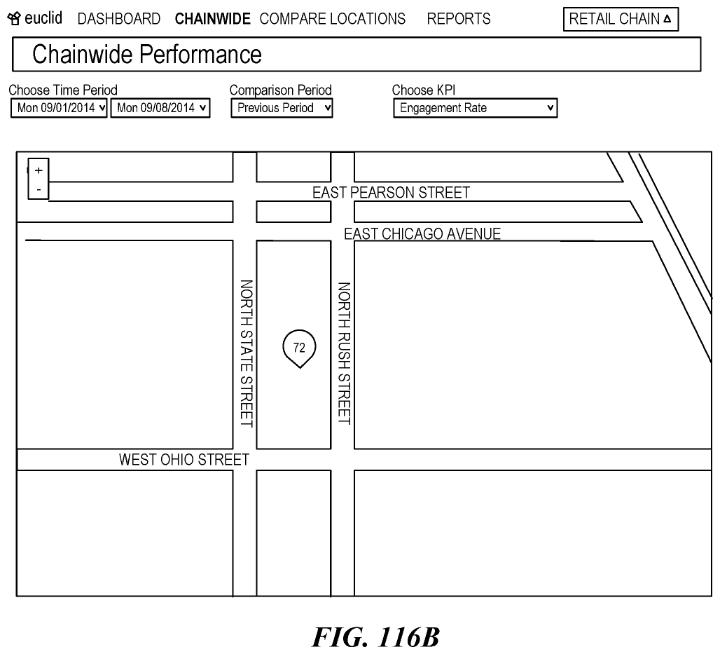

The Chainwide Performance feature provides the user with a map view of their stores across their chain and a way to easily identify top and bottom performing locations based on a selected KPI. (See, e.g., FIGS. 116A and 116B.)

FIGS. 116A-116B illustrate example embodiments of Chainwide Performance Maps.

Example Functionality:
Date Range Selector: Set a start and end date
Comparison Period Selector: Select the dates or index to compare to the current data range—Previous Period, Previous 4 Period Average, Year over Year (if available), Industry Benchmark (if available)
Choose KPI: Select 1 KPI from drop down. All KPIs that are available in the edit/create dashboard pages will be available in this drop down
Zoom: Users can focus on certain areas or regions by using the zoom functionality
Flags vs. Numbers vs. Dots: Flags represent the top and bottom performing stores in a chain, numbers are their rankings, and the dots are stores that do not rank in the top or bottom 10 of a chain
Hover State: Mouse over a store to see the store name/number, current period value and the percent change vs. comparison period

Example Scenario: The Head of Stores at ACME Retail Furniture Co. can use this tool to get a quick view of performance across her chain, identify the stores that under or over performed and identify any regional trends associated with this performance. The feature is particularly helpful to large chains, providing a compelling executive level view, and serving as the launching off point for a revenue attribution driven stores page.

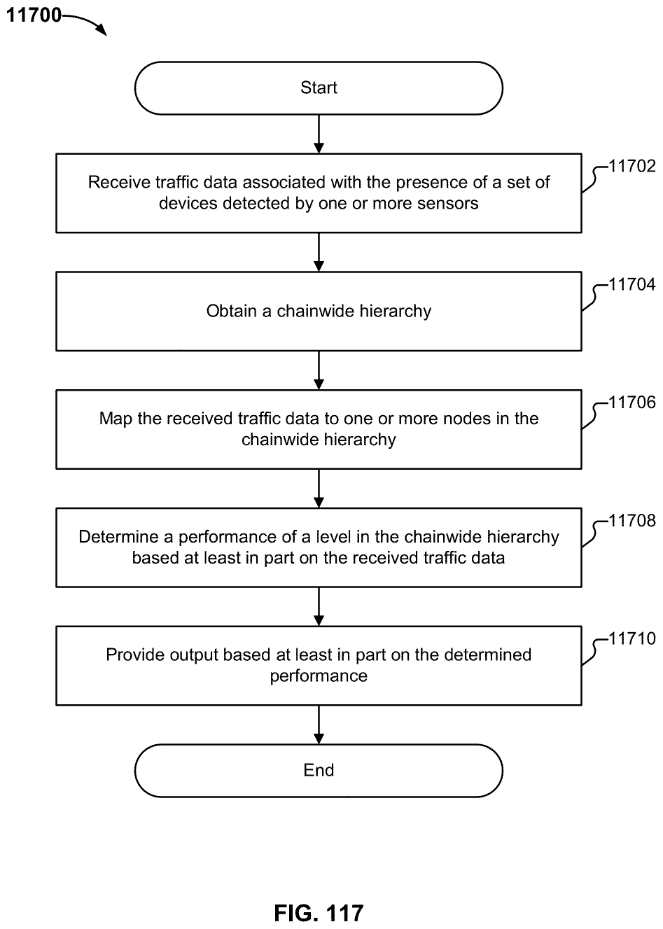

FIG. 117 is a flow diagram illustrating an embodiment of a process for utilizing sensor network hierarchies. In various embodiments, process 11700 is performed by platform 170. The process begins at 11702, when traffic data associated with the presence of a set of devices detected by one or more sensors is received. As one example, such traffic data is received at 3202 when a sensor, such as sensor 108 transmits log data (e.g., indicating that it has observed device 110) to platform 170 via one or more networks (collectively depicted in FIG. 1A as Internet cloud 102), and that data is provided (e.g., by ELB 204) to an ingestor (e.g., ingestor 206). Portion 3202 of the process may be repeated several times (e.g., with data about the observation of device 112 also being received at 3202, whether from sensor 108, or another sensor, and/or from a controller). In some embodiments, the presence of the devices is detected without the devices being associated (e.g., connected to) an access point. In some embodiments, the received data is collected and analyzed on a per sensor basis (e.g., per access point basis). At 11704, a chainwide hierarchy is obtained. In some embodiments, as described above, the chainwide hierarchy is uploaded. In some embodiments, the hierarchy comprises a representation of an organiziation. At 11706, the received traffic data is mapped to one or more nodes in the obtained chainwide hierarchy. For example, the traffic data is mapped to an access point at the location. At 11708, a performance of a level in the chainwide hierarchy is determined based at least in part on the received traffic data. In various embodiments, determining a performance of a level in the hierarchy includes key performance indicators such as storefront potential, average shop time, storefront conversion, walk-bys, traffic-count, etc. At 11710, the output based at least in part on the determined performance is provided. As described above, reports can be provided that allow for users to view details of chain-wide performance. For example, aggregate performance of levels of the hierarchy can be determined and provided. As another example, a user can select a hierarchy level of interest and perform a comparison of key performance indicators at a same level in the hierarchy (e.g., comparison of the performance of one region of the chainwide hierarchy against the performance of another region of the chainwide hierarchy). In some embodiments, the performance of the chainwide hierarchy can also be correlated with sales data. This can be done, for example, to determine which metrics have the greatest impact on sales performance for a particular location in the chainwide hierarchy. Examples of reports include maps, tables, drillable bar charts, etc., as described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
receive traffic data associated with the presence of a set of devices at a location;
obtain external sales data;
process the received traffic data and the obtained external sales data; and
provide output based at least in part on the processing of the received traffic data and the obtained external sales data; and
a memory coupled to the processor and configured to provide the processor with instructions.

2. The system of claim 1 wherein the received traffic data includes at least one of a timestamp, MAC address of an access point, MAC address of a device, and signal strength.

3. The system of claim 1 wherein the processor is further configured to determine an average amount of time that a device spent at the location.

4. The system of claim 1 wherein the processor is further configured to determine a duration that has spent at the location.

5. The system of claim 4 wherein the duration is determined based at least in part on timestamps included in the received traffic data.

6. The system of claim 5 wherein the duration is determined across a combination of span, zone, and date at least in part by aggregating the timestamps over a time period.

7. The system of claim 1 wherein the processor is configured to determine a number of devices in and out of the location.

8. The system of claim 1 wherein the processor is configured to determine a proportion of users that spent less than a threshold amount of time at the location.

9. The system of claim 1 wherein the processor is configured to determine a number of visitors that have not been previously detected by a sensor at the location.

10. The system of claim 1 wherein the external sales data is obtained via at least one of a template, FTP, email, a REST API, and a dashboard user interface.

11. The system of claim 1 wherein the processor is further configured to provide a sales widget in a dashboard based at least in part on the obtained external sales data.

12. The system of claim 1 wherein the processing includes correlating the received traffic data and the obtained external sales data.

13. The system of claim 1 wherein the processing includes ingesting and parsing the received traffic data and the obtained external sales data.

14. The system of claim 1 wherein the provided output includes a combined view of at least a portion of the received traffic data and obtained external data.

15. The system of claim 14 wherein the combined view includes time series information.

16. A system, comprising:
a processor configured to:
receive traffic data associated with the presence of a set of devices detected by one or more sensors;
obtain a hierarchy;
is map the received traffic data to one or more nodes in the hierarchy;
determine a performance of a level in the hierarchy based at least in part on the received traffic data; and
provide output based at least in part on the determination; and
a memory coupled to the processor and configured to provide the processor with instructions.

17. The system of claim 16 wherein the received traffic data is associated with an access point in the hierarchy.

18. The system of claim 16 wherein determining the performance of a level in the hierarchy includes performing an aggregation of values associated with nodes in the hierarchy beneath the level.

19. The system of claim 16 wherein the provided output includes a comparison of performance at the level in the hierarchy.

20. A system, comprising:
a processor configured to:
receive traffic data associated with the presence of a set of devices at a location;
determine, based at least in part on the received traffic data, a number of engaged visitors and a number of total visitors; and
determine a number of bounced visitors based at least in part on the determined number of engaged visitors and the determined number of total visitors; and
a memory coupled to the processor and configured to provide the processor with instructions.
